(19) United States
(12) Patent Application Publication
(10) Pub. No.: US 2026/0355968 A1
(43) Pub. Date: Nov. 12, 2026

(54) HUMANOID ROBOT DATA COLLECTION SYSTEM CONFIGURED TO MAP HUMAN DATA TO HUMANOID ROBOT CONTROL DATA

(71) Applicant: Figure AI Inc., San Jose, CA (US)

(72) Inventors: Victor Ragusila, San Jose, CA (US); Patrick Varin, San Jose, CA (US); Moritz Alexander Graule, San Jose, CA (US); Samuel Jacob Baker, San Jose, CA (US); Ali Fuet Ozhan, San Jose, CA (US)

(21) Appl. No.: 19/671,220

(22) Filed: May 7, 2026

Related U.S. Application Data
(60) Provisional application No. 63/801,451, filed on May 7, 2025.

(51) Int. Cl. B25J 9/16; B25J 13/08; B25J 19/02; G06F 3/01

(52) U.S. Cl. CPC B25J 9/1689; B25J 9/161; B25J 9/163; B25J 13/085; B25J 13/089; B25J 19/023; G06F 3/014

(57) ABSTRACT

A humanoid robot teleoperation system includes a wearable apparatus worn by a human operator and a humanoid robot, each equipped with inertial and rotational position sensors selected to exhibit corresponding noise and quantization characteristics. Paired operator-side and robot-side measurements captured during teleoperation sessions are thereby drawn from corresponding statistical distributions, rendering them interchangeable as training examples for a machine-learning control policy. The robot further carries a stereo camera pair mounted in a head structure with a capture baseline non-parallel to the horizontally-oriented disparity axis of a stereoscopic display viewed by the operator. Image processing circuitry reprojects the captured images from the capture baseline onto the display disparity axis—optionally compensating for head pitch relative to gravity, accommodating operator interpupillary distance, and inpainting disocclusions—permitting a narrower robot head while preserving conventional horizontal binocular feedback. Display images and contemporaneous operator command inputs are recorded as training data.

### CROSS-REFERENCE TO RELATED APPLICATIONS

This application claims the benefit of and priority to U.S. Provisional Patent Application Nos. 63/801,451, filed on May 7, 2025, which is fully incorporated herein by reference.

### TECHNICAL FIELD

The present disclosure relates to a humanoid robot data collection system for mapping human data associated with human teleoperators to humanoid robot control data, wherein said mapping enables the human teleoperator to cause the robot to mirror the human teleoperator's movements.

### BACKGROUND

The rapid growth of the robotics industry, particularly in the field of humanoid robots, has created a demand for more sophisticated and intuitive control systems. As humanoid robots become increasingly complex and capable, there is a need for control interfaces that can effectively translate human movements into robot actions. This demand stems from various sectors, including manufacturing, healthcare, and service industries, where human-like robots are being deployed to perform tasks that require dexterity and adaptability. Existing control systems for humanoid robots often struggle to accurately map human movements to robot actions due to differences in physical structure, joint configurations, and range of motion between humans and robots. These discrepancies can lead to imprecise or unnatural robot movements, limiting the effectiveness of human-robot collaboration in various applications.

The market for humanoid robots is expanding, with projections indicating substantial growth in the coming years. This expansion has highlighted gaps in current technologies, particularly in the area of intuitive control interfaces. Many available systems lack the ability to seamlessly translate complex human motions into corresponding robot actions, especially when dealing with tasks that require fine motor skills or dynamic movements. Furthermore, there is an increasing need for control systems that can adapt to different users and tasks without extensive recalibration. Current solutions often require time-consuming setup procedures or are limited in their ability to accommodate variations in human physiology and movement patterns. This limitation restricts the widespread adoption of humanoid robots in diverse environments where flexibility and ease of use are paramount. Another challenge in the field is the real-time processing of human motion data and its translation into robot control signals. Existing systems may introduce noticeable latency or lack precision. The growing interest in human-robot interaction has also highlighted the importance of providing operators with appropriate feedback. Many current systems lack effective means of conveying the robot's state or environmental information back to the human operator, potentially leading to reduced situational awareness and operational efficiency. As the capabilities of humanoid robots continue to advance, there is a clear opportunity for innovative control systems that can bridge the gap between human intent and robot action.

### SUMMARY

The present disclosure relates to systems and methods for teleoperating humanoid robots and for mapping human operator motion data to humanoid robot control data. In broad terms, the disclosure addresses (i) capture of operator motion using a wearable apparatus and retargeting of that motion into robot control signals, (ii) training of machine-learning models that predict robot control data from operator motion data, (iii) hierarchical prioritization of which body parts are mapped, (iv) hybrid and optimization-based retargeting employing cost functions and constraints, (v) task-space retargeting employing inverse kinematics, (vi) teleoperation architectures in which operator-side and robot-side sensors are selected so that their outputs occupy corresponding statistical distributions and may be used as interchangeable machine-learning training examples, and (vii) stereoscopic visual feedback arrangements in which the camera capture baseline of the robot is non-parallel to the display disparity axis viewed by the operator. The aspects described herein may be practiced individually or in any combination.

In one aspect, a system for mapping human operator data to humanoid robot control data comprises a wearable apparatus configured to capture human motion data from a human operator, a humanoid robot having a plurality of joints, and a computer system communicatively coupled to the wearable apparatus and the humanoid robot. The computer system is configured to receive the human motion data from the wearable apparatus, apply a retargeting method to the human motion data to generate robot movement data, generate robot control signals based on the robot movement data, and transmit the robot control signals to the humanoid robot to cause the humanoid robot to mirror movements of the human operator. The retargeting method is selected from the group consisting of joint-space retargeting, task-space retargeting, hybrid and optimization-based retargeting, and learning-based retargeting.

In some embodiments, the wearable apparatus comprises a plurality of inertial measurement units (IMUs) configured to capture joint angle data of the human operator, and may further comprise a headset configured to capture head movement data of the human operator. The computer system may be further configured to preprocess the human motion data by filtering and normalizing the joint angle data and head movement data, apply a mapping prioritization scheme to the preprocessed human motion data to determine priority levels for mapping different body parts of the human operator to corresponding parts of the humanoid robot, and generate the robot movement data based on the applied mapping prioritization scheme.

In a corresponding method aspect, capturing the human motion data comprises capturing joint angle data using a plurality of IMUs and capturing head movement data using a headset worn by the human operator. The method may further comprise preprocessing the human motion data by filtering and normalizing the joint angle data and head movement data, applying a mapping prioritization scheme to determine priority levels for mapping different body parts to corresponding parts of the humanoid robot, and generating the robot movement data based on the applied mapping prioritization scheme. Applying the retargeting method may comprise defining a cost function that quantifies a quality of potential robot control data based on multiple objectives including task-space error, joint-space error, posture similarity, and regularization; establishing constraints that define bounds within which the humanoid robot must operate, including robot physical limits, collision avoidance, balance and stability, and contact constraints; and executing an optimization framework based on the cost function and constraints to compute optimal robot joint positions, velocities, or accelerations.

In a further aspect, a system and corresponding method for training a model to map human operator data to humanoid robot control data are provided. The system comprises a wearable apparatus configured to capture human motion data, a humanoid robot having a plurality of joints, and a computer system configured to receive paired sensor data comprising human motion data and corresponding robot control data; select a learning approach from supervised learning, unsupervised learning, and reinforcement learning; train a machine learning model using the paired sensor data and the selected learning approach; and generate a trained model configured to predict robot control data from real-time human motion data.

The computer system may be further configured to preprocess the paired sensor data by filtering and normalizing the human motion data, define input features comprising operator joint angles and velocities, and define target output features comprising robot joint angles and velocities. The machine learning model may comprise a neural network selected from the group consisting of a multi-layer perceptron (MLP) for static mapping, a recurrent neural network (RNN) for sequential data, and a transformer network for capturing long-range dependencies in motion sequences. The computer system may be further configured to perform model validation using unseen human motion data, iteratively refine the machine learning model based on validation results, and incorporate a feedback mechanism to further adapt the trained model during runtime based on sensor data from the humanoid robot. Method aspects mirror these system features.

In another aspect, a system and corresponding method for prioritized mapping of human operator data to humanoid robot control data are provided. The computer system is configured to receive the human motion data from the wearable apparatus, apply a mapping prioritization scheme to the human motion data, generate robot control signals based on the prioritized mapping, and transmit the robot control signals to the humanoid robot to cause the humanoid robot to mirror movements of the human operator according to the mapping prioritization scheme. The mapping prioritization scheme defines a hierarchical order for mapping different body parts.

In particular embodiments, the hierarchical order is defined as: (a) arm movements having highest priority; (b) wrist movements having second highest priority; (c) hand movements having third highest priority; (d) finger movements having fourth highest priority; (e) elbow movements having fifth highest priority; and (f) shoulder movements having sixth highest priority. The computer system may further preprocess the human motion data by filtering and normalizing joint angle data and head movement data captured by the wearable apparatus, apply the mapping prioritization scheme to the preprocessed human motion data, and generate the robot control signals accordingly. The computer system may also dynamically adjust the mapping prioritization scheme based on a detected task context or operator intent, apply the adjusted mapping prioritization scheme to subsequent human motion data, and generate updated robot control signals to adapt the humanoid robot's movements according to the task context or operator intent.

In a further aspect, a system and corresponding method for hybrid and optimization-based retargeting of human operator data to humanoid robot control data are provided. The computer system is configured to receive the human motion data from the wearable apparatus; define a cost function comprising multiple objectives for quantifying quality of robot motion; establish constraints defining bounds for robot operation; determine an optimization framework based on the cost function and constraints; execute the optimization framework to compute optimal robot joint positions, velocities, or accelerations; generate robot control signals based on the computed optimal robot joint data; and transmit the robot control signals to the humanoid robot.

The cost function may comprise a task-space error term penalizing deviations of the humanoid robot's end-effector pose from a desired target pose derived from the human motion data; a joint-space error term encouraging similarity between the humanoid robot's joint configuration and a reference configuration derived from the human motion data; a posture similarity term comparing distributions of key points on the humanoid robot's body to corresponding distributions derived from the human motion data; and a regularization term promoting smoothness by penalizing high joint velocities, accelerations, and jerk.

The constraints may comprise robot physical limits including joint position, velocity, acceleration, and torque limits; collision avoidance constraints preventing self-collisions between robot links and collisions with the environment; balance and stability constraints for maintaining dynamic stability, including Zero Moment Point (ZMP) constraints requiring the ZMP to remain within a support polygon; and contact constraints modeling the humanoid robot's interaction with the environment, including equality constraints for fixed contacts and force constraints ensuring contact forces remain within friction cones.

In a further aspect, a system and corresponding method for task-space retargeting of human operator data to humanoid robot control data are provided. The computer system is configured to receive the human motion data from the wearable apparatus; transform the human motion data into a robot coordinate frame; scale and offset the transformed human motion data; define a Cartesian target pose for a robot end-effector based on the scaled and offset human motion data; apply an inverse kinematics solver to determine a set of robot joint angles that result in the robot end-effector reaching the Cartesian target pose; generate robot control signals based on the determined set of robot joint angles; and transmit the robot control signals to the humanoid robot.

The computer system may apply translational scaling to the transformed human motion data by calculating translational movement relative to a reference point and applying one or more scaling factors to match the humanoid robot's workspace dimensions, and apply rotational mapping to the transformed human motion data by mapping the human operator's orientation to a corresponding robot orientation, wherein only specific axes of rotation are mapped based on task requirements. The computer system may further smooth the scaled and offset human motion data using a Kalman filter to reduce noise and sudden movements, and define the Cartesian target pose for the robot end-effector as a homogeneous transformation matrix comprising a position vector and a rotation matrix.

In a further aspect, a humanoid robot teleoperation system comprises a wearable apparatus configured to be worn by a human operator, the wearable apparatus including at least one operator-side inertial sensor and at least one operator-side rotational position sensor; a humanoid robot comprising a plurality of actuators, at least one robot-side inertial sensor, and at least one robot-side rotational position sensor; and one or more processors in data communication with the wearable apparatus and the humanoid robot. The one or more processors are configured to derive, from signals received from the wearable apparatus during a teleoperation session, control information for one or more of the plurality of actuators of the humanoid robot, and to store paired data records associating contemporaneous operator-side and robot-side sensor measurements obtained during the teleoperation session.

The at least one operator-side inertial sensor and the at least one robot-side inertial sensor are selected such that signals output thereby exhibit corresponding noise and quantization characteristics, and the at least one operator-side rotational position sensor and the at least one robot-side rotational position sensor are similarly selected such that signals output thereby exhibit corresponding noise and quantization characteristics. By virtue of this sensor matching, the operator-side measurements and the robot-side measurements within the paired data records are drawn from corresponding statistical distributions and are usable as interchangeable training examples for a machine-learning control policy of the humanoid robot.

In some embodiments, the operator-side and robot-side inertial sensors comprise inertial measurement units of the same make and model, and the operator-side and robot-side rotational position sensors comprise rotational position sensors of the same make and model. Signals output by the operator-side and robot-side inertial sensors may be sampled at a common sampling rate, and signals output by the operator-side and robot-side rotational position sensors may be sampled at a common sampling rate. The wearable apparatus may include a kinematic linkage defining a plurality of operator joints arranged to correspond to a plurality of actuated joints of the humanoid robot, with a respective rotational position sensor disposed at each of the plurality of operator joints.

The system may further comprise at least one operator-side force or torque sensor and at least one robot-side force or torque sensor selected such that signals output thereby exhibit corresponding noise and quantization characteristics, wherein the paired data records further include force or torque measurements drawn from corresponding statistical distributions. In some embodiments, the wearable apparatus comprises a glove configured to be worn on a hand of the operator and including a plurality of operator-side finger position sensors, and the humanoid robot comprises a robotic hand including a plurality of robot-side finger position sensors selected such that the operator-side and robot-side finger position sensor signals exhibit corresponding noise and quantization characteristics.

The paired data records may be stored in a data format configured for use as training examples for a machine-learning policy, the operator-side measurements and the robot-side measurements being interchangeable inputs to the policy by virtue of being drawn from corresponding statistical distributions. The system may further comprise a machine-learning training subsystem configured to train a control policy for the humanoid robot using both the operator-side measurements and the robot-side measurements as training examples.

In a further aspect, a humanoid robot teleoperation system comprises a humanoid robot configured to be controlled by a human operator during a teleoperation session, the humanoid robot having a head structure and carrying a stereo camera pair mounted in the head structure, the stereo camera pair comprising a first camera and a second camera; a stereoscopic display system configured to be viewed by the operator during the teleoperation session and comprising a first display element and a second display element laterally separated to present a horizontally-oriented binocular view to the operator along a display disparity axis; and image processing circuitry communicatively coupled between the stereo camera pair and the stereoscopic display system. The image processing circuitry is configured to derive, from a first image captured by the first camera and a second image captured by the second camera, a first display image and a second display image arranged for stereoscopic display along the display disparity axis, and to output the first display image and the second display image to the first display element and the second display element so as to provide visual feedback to the operator while the operator controls the humanoid robot. A capture baseline extending between the first camera and the second camera is non-parallel to the display disparity axis.

In some embodiments, a width of the head structure in a lateral direction is less than a separation, along the display disparity axis, between the first display element and the second display element, allowing the head structure to be made narrower than the operator's interocular separation while still providing stereoscopic feedback aligned with the operator's eyes. When the humanoid robot is in a reference posture, the capture baseline may be oriented vertically relative to a gravity vector and the display disparity axis may be oriented horizontally relative to the gravity vector.

The image processing circuitry may be configured to perform a coordinate transform that maps disparity along the capture baseline to disparity along the display disparity axis. In some embodiments, the image processing circuitry computes a depth map from the first image and the second image based on the capture baseline and synthesizes the first display image and the second display image as virtual views having a synthetic baseline aligned with the display disparity axis. The capture baseline may be physically fixed, and all stereo adjustments giving rise to disparity along the display disparity axis may be performed digitally by the image processing circuitry. The image processing circuitry may adjust a synthetic baseline aligned with the display disparity axis used to derive the first display image and the second display image based on an interpupillary distance associated with the operator. The image processing circuitry may also inpaint regions of the first display image and the second display image corresponding to disocclusions introduced by reprojecting from the capture baseline to the display disparity axis.

In a corresponding method aspect, a method of teleoperating a humanoid robot comprises obtaining, during a teleoperation session in which a human operator controls a humanoid robot, a first image and a second image captured by a stereo camera pair mounted in a head structure of the humanoid robot, the capture baseline extending between the first camera and the second camera being non-parallel to a horizontally-oriented disparity axis of a stereoscopic display viewable by the operator; deriving, by one or more processors, from the first image and the second image, a first display image and a second display image arranged for stereoscopic display along the horizontally-oriented disparity axis; presenting the first display image to one eye of the operator and the second display image to the other eye of the operator on the stereoscopic display so as to provide visual feedback to the operator while the operator controls the humanoid robot during the teleoperation session; and recording the first display image and the second display image, together with one or more contemporaneous command inputs from the operator, in a data store as training data for a humanoid robot control policy.

In some embodiments, the first image and the second image are obtained while the stereo camera pair is positioned within an aperture having a lateral width less than would accommodate a horizontally-baselined stereo camera pair of equivalent baseline magnitude. When the humanoid robot is in a reference posture, the capture baseline may be oriented vertically relative to a gravity vector and the horizontally-oriented disparity axis may be oriented horizontally relative to the gravity vector. Deriving the first display image and the second display image may comprise performing a coordinate transform that maps disparity along the capture baseline to disparity along the horizontally-oriented disparity axis, and may further comprise computing a depth map from the first image and the second image based on the capture baseline and synthesizing the first display image and the second display image as virtual views having a synthetic baseline aligned with the horizontally-oriented disparity axis. The method may further comprise determining a pitch attitude of a head of the humanoid robot relative to a gravity vector and rotating a reprojection plane used during the deriving step to compensate for the pitch attitude; inpainting regions of at least one of the first display image and the second display image corresponding to disocclusions arising from a difference between the capture baseline and the horizontally-oriented disparity axis; and adjusting a synthetic baseline aligned with the horizontally-oriented disparity axis based on an interpupillary distance associated with the operator.

The method may further comprise recording, contemporaneously with the first display image and the second display image, paired data records associating measurements from one or more operator-side sensors worn by the operator with measurements from one or more robot-side sensors of the humanoid robot, the operator-side sensors and the robot-side sensors being selected such that paired operator-side and robot-side measurements within said paired data records are drawn from corresponding statistical distributions and are usable as interchangeable training examples for the humanoid robot control policy.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIGS. 1-3B;

FIG. 9 is a schematic diagram of a humanoid robot data collection system including: (i) a humanoid robot, (ii) a wearable training apparatus, (iii) data storage, (iv) a secondary computer, (v) a display, and (vi) an optional clutch;

FIG. 10A is a diagram showing an embodiment of a head of the humanoid robot of FIGS. 1-3B;

FIG. 10B is a diagram showing an external set of cameras affixed to the robot head of FIG. 10A;

FIGS. 11-13 illustrate a first embodiment of a wearable training apparatus and the humanoid robot of FIGS. 1-3B;

FIGS. 14-16 illustrate a second embodiment of a wearable training apparatus and the humanoid robot of FIGS. 1-3B;

FIGS. 17A and 17B illustrate a wearable magnetic field-generating apparatus that can be used with the wearable training apparatus of FIGS. 14-16;

FIG. 18 illustrates an example mapping for prioritizing the transformation of operator motions to robot joint movements;

FIG. 19 is a flowchart of a process for mapping (e.g., transforming) human data to robot control data;

FIG. 20 is an illustrative example of different types of retargeting methods that can be used to map the human data to the robot control data in the process of FIG. 19;

FIG. 21 is an illustrative example of task-space retargeting and joint-space retargeting, either of which may be used with the disclosed techniques to map the human data to the robot control data in the process of FIG. 19;

FIG. 22 is a flowchart of a process for joint-space retargeting to map human data to robot control data;

FIG. 23 is a flowchart of a process for task-space (e.g., cartesian) retargeting to map human data to robot control data;

FIGS. 24A and 24B is a flowchart of a process for hybrid and optimization-based space retargeting to map human data to robot control data;

FIG. 25 is a flowchart of a process for training a model to perform learning-based retargeting; and

FIG. 26 is a flowchart of a process for learning-based retargeting to map human data to robot control data using the model that was trained according to the process in FIG. 25.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

General-purpose humanoid robots emulate human form and functionality with two legs, two arms, and a face-like screen. With the general-purpose humanoid robot's emulation of the human body, arises the necessity for torso and arm assemblies that can closely replicate human movements, capabilities, and structural nuances. The need for the torso and arm assemblies to be capable of mimicking human structure and functions extends far beyond cosmetic resemblance. For example, it is also desirable that the torso and arm assemblies enable the end effector of the robot to be able to seamlessly interact with and physically manipulate diverse objects in complex environments while performing in a durable, cost-effective, and controllable manner using the robot's limited resources, including its battery power resources.

To enable the humanoid robot to seamlessly interact with and physically manipulate diverse objects in complex environments, training data needs to be collected to train the artificial intelligence-based models that are running on the computer that are either local to the robot, remote to the robot, and/or a combination of both. To collect the above described training data, a robot data collection system can be used that includes a wearable training apparatus configured to be worn by a human user and is designed to generate sensor data from human data, and wherein said sensor data can be mapped to robot control data in order to accurately and effectively control the humanoid robot. Accordingly, the disclosed technology provides for systems and techniques that map human data to robot control data. The disclosed technology can be used for remapping human data to the robot in static positions. This can include accounting for discrepancies in physical proportions between the human operator and the robot, such as a mismatch between the shoulder-to-elbow length of the human and that of the robot. Such static poses can therefore be aligned while maintaining joint integrity.

In some implementations, a wearable training apparatus (e.g., a teleoperation suit) can be used to map the wrist's position and orientation in 6 degrees of freedom (DoF)—three for position and three for rotation. To translate this into robot control data, an inverse kinematics (IK) problem can be solved that determines the necessary joint angles to position the robot's final wrist actuator (J7) at the specified location. This IK solution sometimes may a joint configuration without considering factors such as energy efficiency or the robot's current arm posture. While this approach is sufficient for mapping a single point, such as the wrist, it may not be preferred for more complex motion replication. Accordingly, the disclosed techniques can be used to map multiple human joints to the robot. This introduces and addresses challenges stemming from physical differences between the human operator and the robot, as mapping multiple joints creates redundancy and potential mismatch. Thus, the disclosed techniques provide advanced mapping strategies to accurately and efficiently retarget human motion to robotic motion, accounting for these physical and kinematic disparities.

Although the disclosure describes static positions, said positions are merely illustrative examples, not intended to be limiting examples. Static positions do not refer solely to a neutral or rest pose; rather, these positions can include any arbitrary position in space. For example, the human's arm can be in position W and the robot can be in position Y. The human then moves their arm to position Z at a given time A. The disclosed technology can calculate the delta between W and Z, and this delta is then applied to the robot to cause the robot to move from position Y to a new position B. While this delta approach works well for single joints, complications arise when multiple joints are involved, such as the elbow and wrist, since their individual deltas may not be simultaneously achievable due to robot constraints. In such cases, a prioritization strategy described herein can be used. For example, the wrist's movement can be prioritized over the elbow's. The robot can then replicate the wrist movement exactly, while adjusting the elbow as closely as possible without disturbing the wrist's final pose. This illustrates the complexity and importance of intelligent retargeting in human-to-robot mapping as described herein.

The disclosed technology provides improvements over existing systems with respect to hardware utilization, processing efficiency, network bandwidth, and retargeting (e.g., mapping) algorithms themselves. For example, the disclosed technology provides improvements over existing hardware by maximizing use of robotic capabilities. Advanced retargeting techniques described herein, particularly those addressing kinematic mismatches (e.g., different ranges of motion or limb proportions), enable the robot to fully exploit their mechanical capabilities rather than being limited by the human operator's constraints. For example, learning-based and optimization-driven retargeting techniques can allow the robot to map a limited human wrist range into a broader robot wrist range effectively, thereby allowing the robot to perform new and improved motions and actions. The disclosed techniques also provide hardware-agnostic control. In other words, the described retargeting techniques can abstract the human data in a way that allows control across a variety of robot models and morphologies. Joint-space and task-space techniques, for example, provide foundational compatibility, while hybrid and learning-based methods offer adaptability for diverse platforms and uses.

As another example, the disclosed techniques provide processing efficiencies and use of available compute resources. The disclosed techniques provide simplified IK solutions in task-space and joint-space retargeting (especially in static positions), which reduces computational overhead. These techniques can be optimized to run in real-time without requiring complex solvers or full-body dynamics simulations. Additionally, the disclosed technology provides priority-based delta mapping, where deltas in position are calculated and prioritized (e.g., favoring wrist over elbow). Such an approach provides a lean, rule-based computation model that significantly cuts down processing needs as compared to full-body inverse dynamics or machine learning inference pipelines. Moreover, learning-based techniques described herein can be deployed on edge hardware (e.g., onboard GPU and/or TPU modules) to enable efficient and scalable deployment for continuous teleoperation.

The disclosed technology can improve network bandwidth usage, availability, and performance. For example, rather than transmitting full joint states or raw sensor streams, delta-based retargeting techniques described herein may transmit only the changes (deltas) in joint configurations. This greatly reduces the volume of data that requires transmission and is more resilient to variable network conditions. Similarly, sending sparse high-level commands like wrist position/orientation (e.g., in a task-space technique) rather than full joint angles can offload computations to the robot's onboard processor. This can therefore reduce network dependency and enhance fault tolerance in lower-bandwidth environments and use cases. Moreover, predictive models in learning-based retargeting techniques can help anticipate motion and compensate for network latency, thereby improving smoothness and responsiveness even in limited or unreliable network conditions.

Further, the disclosed technology provides advancements over existing retargeting techniques, models, and/or algorithms. Traditional retargeting techniques often rely on heuristic rules or fixed mappings that do not generalize well across operators or robot types. In contrast, the disclosed technology provides optimization-based and learning-based techniques that adapt dynamically to offer more precise and context-aware control. Existing systems also struggle when physical proportions or range-of-motion constraints differ between the human operator and the robot. The disclosed techniques, on the other hand, leverage various different techniques such as optimization and learning-based techniques to intelligently prioritize joint mappings, resolve redundancy, and interpolate solutions for robot movement. Similarly, the disclosed techniques improve fidelity and naturalness of robot movements in comparison to the existing systems. By using task-space retargeting for pose fidelity and learning-based models for motion dynamics, for example, the disclosed technology can provide natural and fluid robot motions that better reflect human operator intent, thereby enhancing usability and telepresence in comparison to the existing systems.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

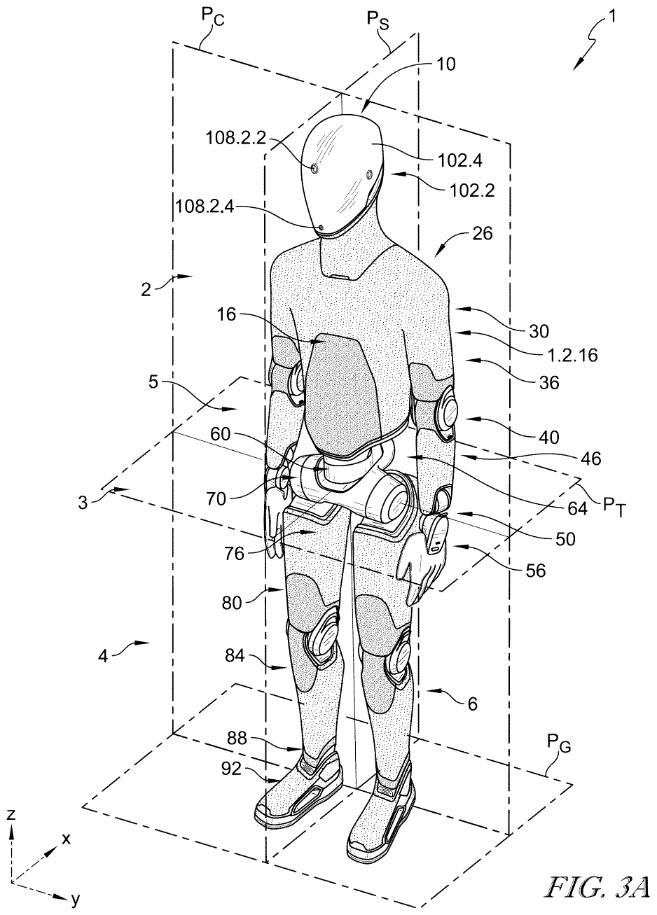

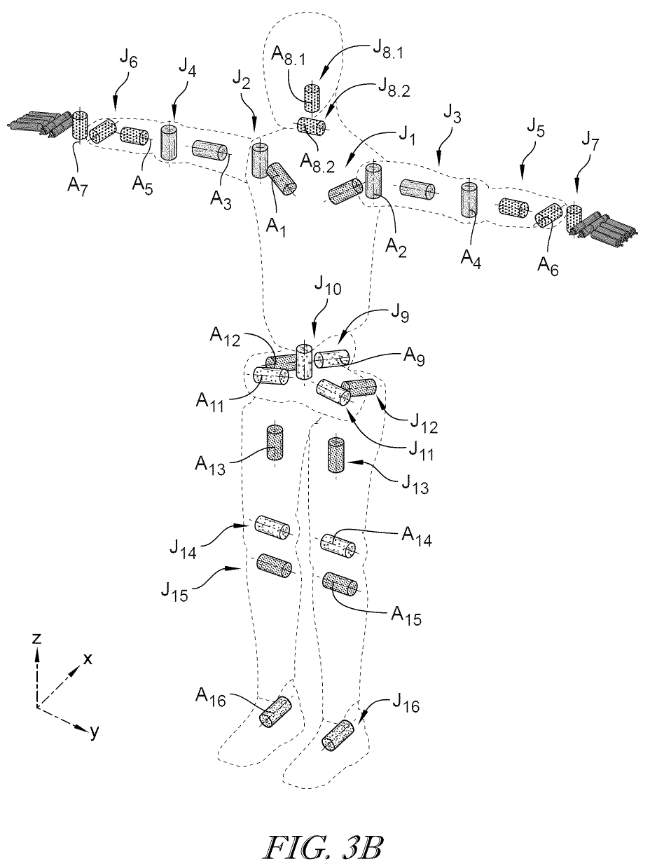

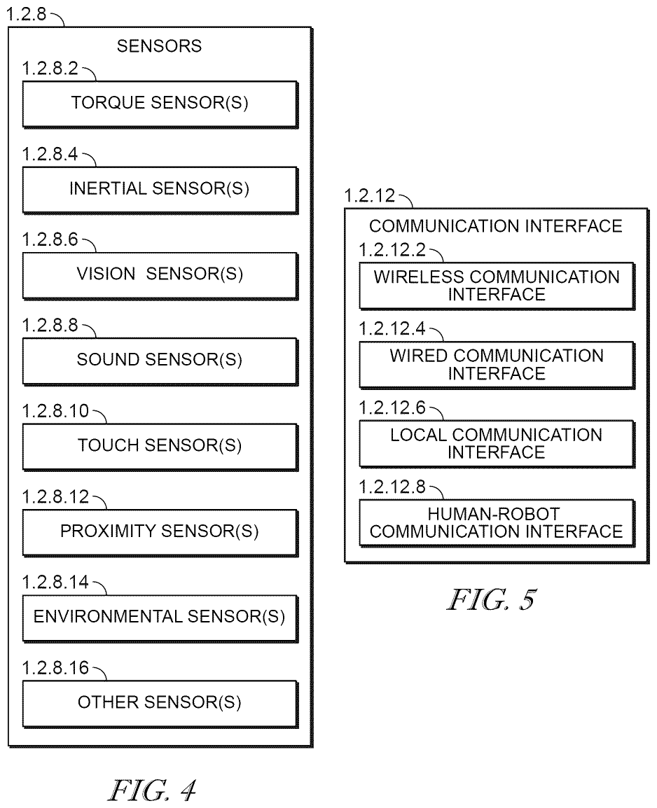

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOT(S) AND ENVIRONMENT

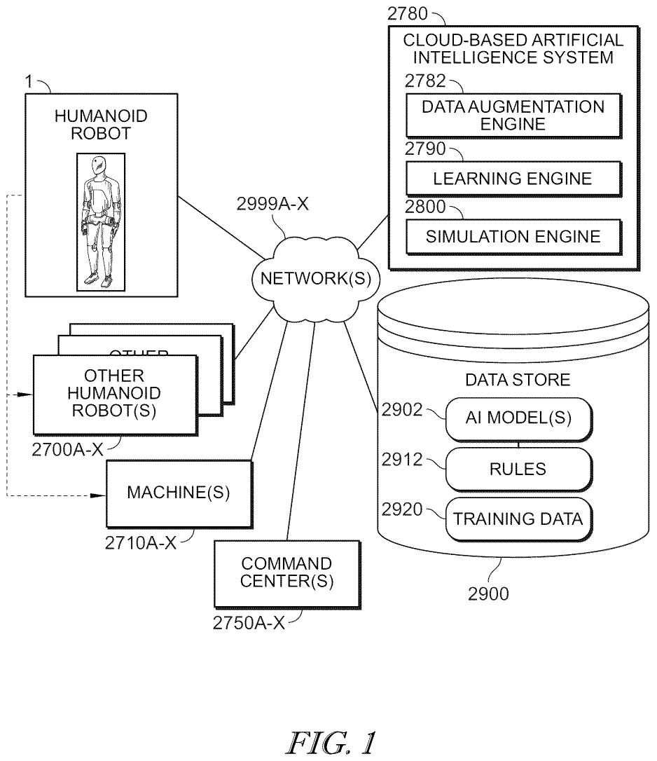

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

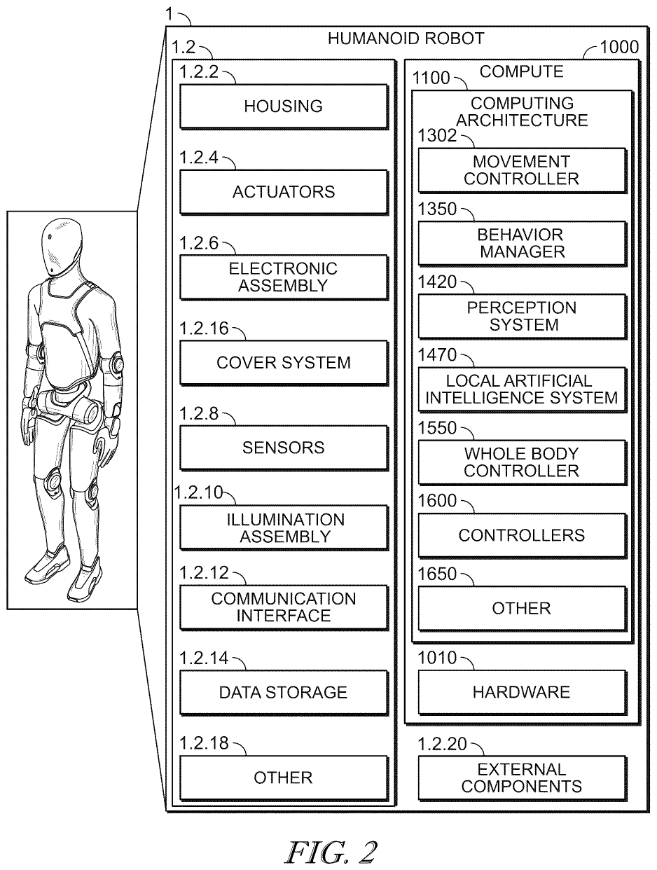

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane (P_{S}) but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane (P_{S}). This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 2

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUS) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

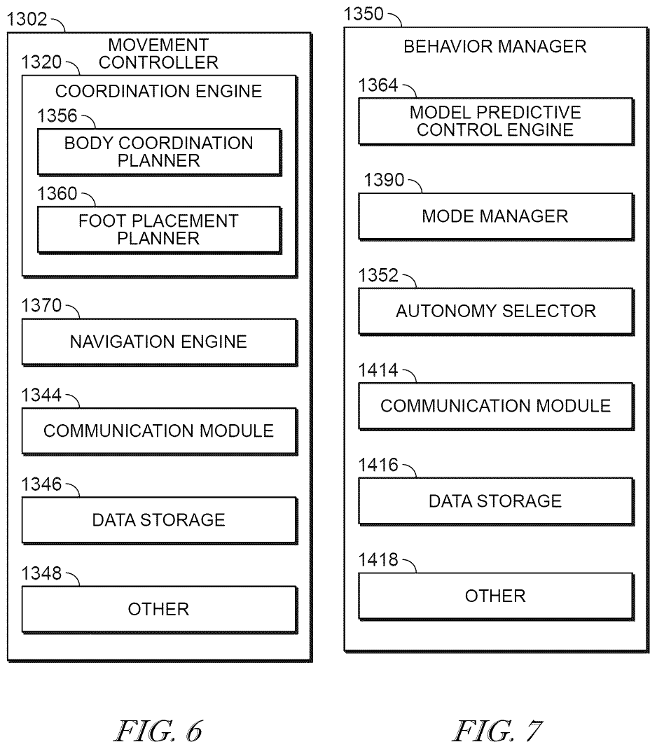

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

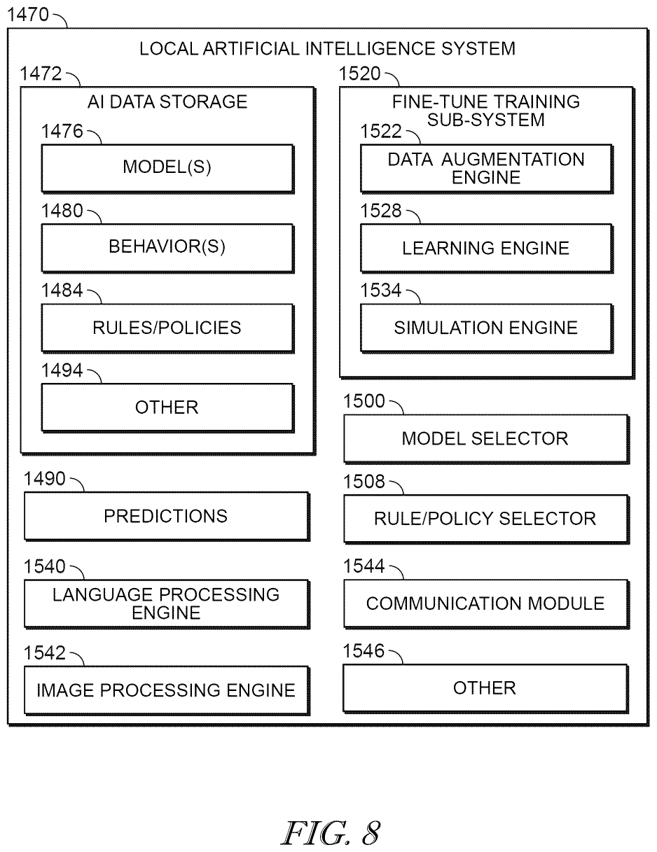

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

### 4. Local AI System

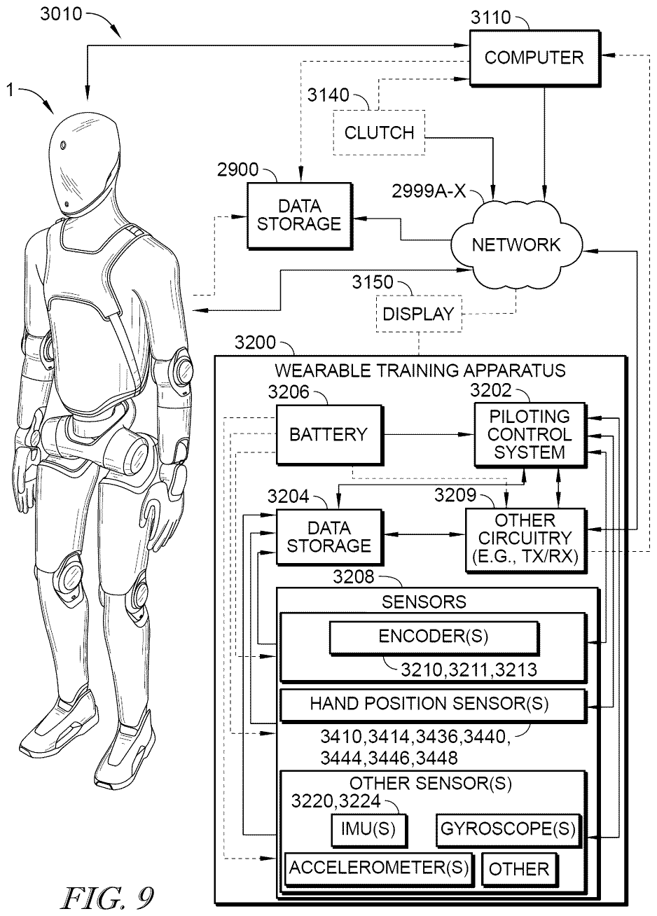

The local AI system 1470 may be embodied as any combination of hardware, software, or circuitry to drive semi- to fully-autonomous perception, learning, and behavior by the humanoid robot 1. The local AI system 1470 may: (i) include modes or architectures that are run on the disclosed local AI system 1470 only, (ii) include models or architectures where a portion of the model or architecture is run on the local AI system 1470 and another portion of the model or architecture is run on the remote AI system 2780, and (iii) include modes or architectures that are run on the disclosed remote AI system 2780 only. The local AI system 1470 is described in further detail relative to FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including vision, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that critical processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The image processing engine 1542 may be embodied as any combination of hardware, software, or circuitry for performing object detection, image classification, segmentation, object tracking, facial recognition, scene understanding, depth estimation, anomaly detection, or reinforcement learning on input vision data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., RL trained models) that are contained within the local AI system 1470.

### 5. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices.

### E. HUMANOID ROBOT DATA COLLECTION SYSTEM

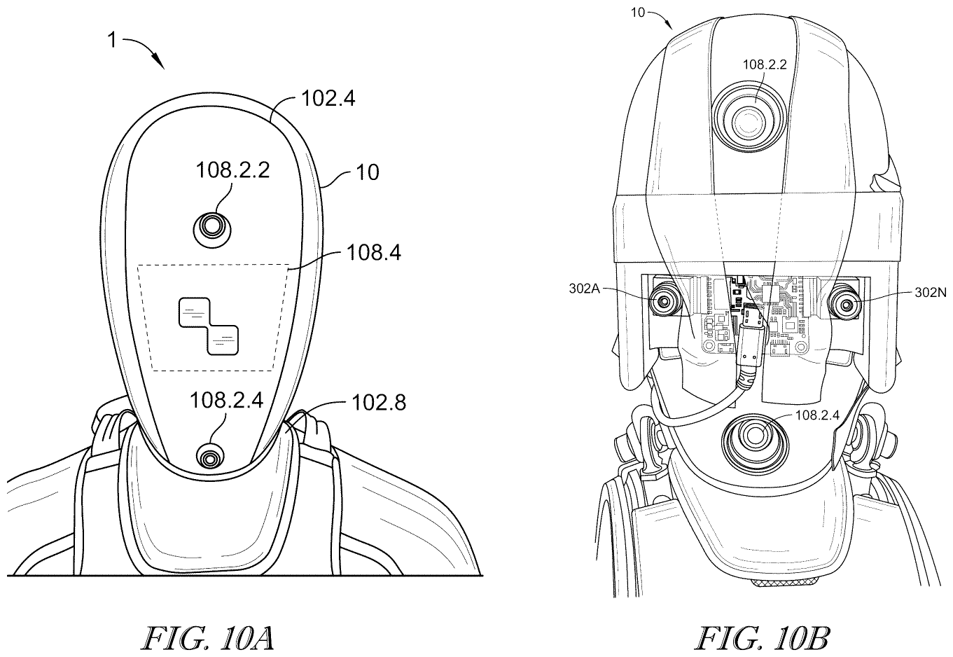

As best illustrated in FIG. 9, the humanoid robot data collection system 3010 may include: (i) a mobile data collection apparatus (also referred to herein as the wearable training apparatus) 3200, (ii) a computer 3110, (iii) a data storage database 2900, (iv) a clutch 3140, (v) a display 3150, which may be a headset device, and/or (vi) the humanoid robot 1 in data communication via a network 2999A-X. The mobile data collection apparatus 3200 is configured to be worn by an operator (also referred to herein as a pilot, user, teleoperator, data collector, apparatus wearer, or human operator) to collect pilot movement data associated with the operator's movements. This pilot movement data may be utilized by the humanoid robot 1 for training models and executing teleoperation tasks. The pilot movement data may be stored locally within data storage 3204 on the apparatus 3200, stored remotely in the data storage database 2900, and/or transmitted in real-time to the humanoid robot 1 through the network 2999A-X. This data may be incorporated into training data of the humanoid robot 1 to be utilized to perform tasks in the operational environment, including manipulation tasks, locomotion patterns, and complex multi-step procedures.

The data collection system 3010 is designed to collect data derived from the movements of the operator while performing various tasks and activities. Specifically, while wearing the apparatus 3200, the operator generates pilot movement data that may include or relate to: (i) the position and/or movement of the operator in space while performing a task, including translational and rotational components in three-dimensional space, (ii) the relative spatial locations of anatomical joint centers of rotation, including shoulder, hip, elbow, knee, wrist, ankle, and/or finger joints, (iii) the velocity and acceleration profiles of each tracked body segment, and/or (iv) any other data about the operator that is relevant to the control and training process (e.g., grip force patterns, hand orientation trajectories, or movement timing sequences). The pilot movement data may be captured at sampling rates ranging from 1 Hz to 10 kHz, with higher sampling rates providing finer temporal resolution for rapid movements. In some embodiments, the sampling rate may be dynamically adjusted based on the detected movement velocity or task complexity to optimize data quality while managing storage and bandwidth constraints.

This pilot movement data may encompass: (a) the position and movement of the operator's torso, including actions such as twisting or bending at the waist with angular measurements in roll, pitch, and yaw axes, and the operator's location within a training environment tracked through both relative and absolute positioning methods, (b) the position and movement of the arms of the operator, where such tracking may detail the operator's shoulder motion, elbow flexion and extension, wrist pose (defined by both position and orientation) in six degrees of freedom, and hand or finger gestures, which can be captured via gloves 3400 coupled to the mobile data collection apparatus 3200 or other sensors with sufficient resolution to distinguish individual finger movements (e.g., each joint) of the operator, and/or (c) the position and movement of the legs of the operator, where such tracking may detail the operator's hip motion, knee flexion and extension, ankle pose (defined by both position and orientation) in six degrees of freedom. In alternative embodiments, the pilot movement data may also include head position and orientation data captured through sensors integrated into the display 3150 or through separate head-mounted sensors. The tracking of leg movements may enable full-body teleoperation scenarios where the humanoid robot 1 replicates both upper and lower body motions of the operator. In further embodiments, the pilot movement data may be expressed in a coordinate frame anchored at the operator's torso such that finger pose, wrist pose, and arm-segment pose are reported relative to a single proximal reference, by which configuration the kinematic chain from torso to fingertip resolves to a single coherent pose using operator-borne sensors.

The pilot movement data can be captured by the mobile data collection apparatus 3200 as sensor data, which may then be transferred to another component for further processing or storage through various communication protocols. This recipient component may be: (i) a remote computer (e.g., a command center 2750) connected via wireless or wired networks, (ii) the computer 3110 integrated with or separate from the apparatus 3200, or (iii) another computing system or architecture, such as the whole body controller (WBC) 1550 operating on compute 1000 of the humanoid robot 1. This data transfer enables the execution of instructions to generate robot control data or log data for training purposes, such as training the humanoid robot 1 itself through supervised learning methods, or training models like Bipedal Action Models (BAMs) for use in controlling the humanoid robot 1. The data transfer may occur at various rates depending on the application requirements, ranging from batch transfers for offline training to real-time streaming for teleoperation. In some embodiments, the data transfer may employ data compression algorithms to reduce bandwidth requirements while preserving data fidelity for time-sensitive teleoperation applications.

The disclosed data collection system 3010 is a cost-effective solution that may not require an overly complex mechanical design to achieve robust human data capture while maintaining high fidelity in motion tracking. This type of data collection system 3010 simplifies the overall data collection process when compared to some alternatives and may not require a substantial number of additional external sensors or environmental detection devices, such as the external cameras often utilized for tracking in traditional motion capture systems. For example, the data collection system 3010 does not inherently require an extensive external camera setup that necessitates controlled lighting, which is a common requirement for purely vision-based motion capture systems that rely on optical markers. Because the primary positional data is collected through integrated sensors directly coupled to the operator wearing the mobile data collection apparatus 3200, there are generally no line-of-sight occlusion or “black-out” spots created by machines, furniture, or other structures present in the training environment. This can be a significant problem for external camera-based systems where occlusions may result in data loss or interpolation errors. In addition to avoiding such black-outs, the disclosed system is less expensive than highly complex, large-scale motion capture setups that require dedicated facilities and extensive calibration procedures. The data collection system 3010 is free of fixed external optical-marker tracking infrastructure, and the mobile data collection apparatus 3200 does not require ceiling-mounted camera arrays, dedicated capture volumes, or controlled illumination to produce the pilot movement data.

The data collection system 3010 includes onboard sensors integrated directly into the wearable structure, and thus generally does not require a quiet acoustic environment. Additionally, the apparatus 3200 is designed to be portable as it is worn by the operator, relatively lightweight in comparison to full exoskeletons, and quicker to manufacture due to simpler mechanics than a full force-feedback exoskeleton which may require complex actuator assemblies. Further, the data collection system 3010 minimizes the infrastructure footprint when compared to fixed base systems and can eliminate the need for a complicated walking base simulator, numerous external wires that may restrict movement, or extensive external tracking components such as ceiling-mounted camera arrays. As a result, a large quantity of pilot movement data can be collected at a relatively low cost per hour, and this data can be used for training the robot control models (e.g., machine learning, BAM models). The portability of the apparatus 3200 also enables data collection in diverse environments, including outdoor settings, industrial facilities, and confined spaces that would be impractical for fixed motion capture installations.

a. Computing Environment

As shown in FIG. 9, the portable data collection system 3010 includes a mobile data collection apparatus 3200, a computer 3110, a data storage database 2900, 3204, a clutch 3140, and the humanoid robot 1, which are in data communication with each other via a network 2999A-X. The mobile data collection apparatus 3200 is configured to be worn by an operator to collect and send sensor data to be received and processed by computer 3110. The processed control data is sent from the computer 3110 to the humanoid robot 1 via the network 2999A-X for execution by the robot's control systems. The mobile data collection apparatus 3200 can communicate with the computer 3110 via the network 2999A-X. In some embodiments, the mobile data collection apparatus 3200 can communicate directly with the humanoid robot 1 via the network 2999A-X, bypassing the computer 3110 for reduced latency applications. In this embodiment, the computer 3110 may be integrated into: (i) the mobile data collection apparatus 3200 and/or (ii) the humanoid robot 1.

The humanoid robot 1 includes a whole body controller (WBC) 1550 that is configured to receive and process control data derived from the mobile data collection apparatus 3200 through kinematic transformation and motion planning algorithms. The WBC 1550 also generates torque targets and current signals for selected actuators (J1-J7) for movement of the actuators (J1-J7). The WBC 1550 further collects robot data from the movement of the actuators (J1-J7) and communicates the robot data to the data storage database 3204 for later training use. The WBC 1550 of the humanoid robot 1 can communicate with the computer 3110 via the network 2999A-X to receive and process the control data that is derived from the sensor data that was obtained from the mobile data collection apparatus 3200. The WBC 1550 of the humanoid robot 1 can also communicate with the data storage database 3204 collected robot data for training a neural network model and/or running a data collection application to train a neural network.

i. Computer

The computer 3110 may comprise, for example, a server computer, a secondary computer, or any other system providing computing capability suitable for real-time data processing. Alternatively, the computer 3110 may comprise a plurality of computing devices that may be arranged, for example, in one or more server banks or computer banks or other arrangements. Such computing devices may be located in a single installation or may be distributed among many different geographical locations for redundancy and load balancing. The computer 3110 can include technology that trains a neural network model and/or run a data collection application to train a neural network. In some embodiments, the computer 3110 includes one or more processors, a memory coupled to the one or more processors, and instructions stored in the memory and configured to be executed on the one or more processors to perform the data-acquisition, retargeting, and training functions described herein.

The data collection system 3010 may also include a computer system 3110 that is designed to process the sensor data at rates of 100-1000 Hz in order to generate robot data that can be sent to the robot's whole body controller 1550 in order to allow for the mobile data collection apparatus 3200 to control the humanoid robot 1 or cause the humanoid robot 1 to mimic the movements of operator with latencies under 50 ms. In addition to performing this data generation function with computational throughputs of 1-10 GFLOPS, the computer system 3110 may perform additional functionalities associated with data collection and storage, some of which may include using filtering algorithms such as Butterworth or Chebyshev filters with cutoff frequencies of 10-100 Hz, compression algorithms achieving compression ratios of 10:1 to 100:1, or other data manipulation methods or algorithms including outlier detection and removal.

The computer system 3110 may comprise various computing architectures to perform its intended functions with appropriate performance characteristics. Examples of such architectures include a server computer with multi-core processors, a secondary computer with GPU acceleration, or any other system that provides suitable computing capability of 10-100 TFLOPS for real-time processing. In some implementations, the computer system 3110 may comprise a distributed computing environment, which incorporates a plurality of interconnected computing devices communicating through high-speed networks. These computing devices may be arranged in various configurations, such as in server banks with blade servers, computer banks with rack-mounted systems, or other suitable distributed architectures supporting horizontal scaling. The computing devices may be co-located in a single physical installation with dedicated cooling and power infrastructure, or they may be distributed across multiple geographical locations connected through wide-area networks. This architecture might be implemented as an edge compute node with processors such as NVIDIA Jetson or Intel NUC that is situated geographically close to the humanoid robot 1 and the operator in order to minimize network latency to under 5 ms. Alternatively, it could be integrated partially or wholly within the humanoid robot 1 itself using the robot's onboard computing resources or within the apparatus 3200 for latency-sensitive image transformation tasks, depending on the chosen processing architecture and power constraints. Sometimes, the computer system 3110 may be deployed on the edge, for instance, as part of the processor and computing architecture of the humanoid robot 1 with shared memory architectures. In yet other embodiments, one or more of the operations and/or processes that are performed by the computer system 3110 may be performed by processors and/or an edge computing architecture of the humanoid robot 1, thereby improving processing efficiency by 30-50% and the use of computational resources across the disclosed technology as a whole through load balancing and task distribution.

ii. Clutch

The data collection system 3010 may include an optional clutch 3140 that is designed to allow the operator to selectively pause the transmission of robot control data from the computer 3110 to the humanoid robot 1. This robot control data is derived from sensor data, which in turn was derived from the collected human data processed through the kinematic mapping algorithms. This feature may allow the operator to reposition their hands or body to a more ergonomic or natural position without causing unintended movements of the humanoid robot 1, preventing potential collisions or task errors, before they resume operation of the mobile data collection apparatus 3200. By implementing this pause functionality with software and hardware interlocks, the system 3010 may prevent the unintended hand motions of the operator, which can occur during such repositioning over periods of 1-10 seconds, from being translated into corresponding movements of the hands 56 or other parts of the humanoid robot 1.

The operator may activate the clutch 3140, for example, by using their hand to press a button with actuation forces of 2-10 N, to temporarily suspend the transmission of the robot control data that is related to certain degrees of freedom. In some configurations, the clutch 3140 may be configured to suspend transmission for all degrees of freedom simultaneously through a master enable/disable signal. In other configurations, it may be set to suspend transmission for only a predefined subset of degrees of freedom, such as only the arm movements (suspending joints J1-J7), while leaving the head tracking active to maintain the situational awareness of the operator through continuous visual feedback. Upon the release or deactivation of the clutch 3140, the mobile data collection apparatus 3200 and the computer 3110 may resume the process of generating and transmitting the robot control data with smooth trajectory blending. The resumption of this control data transmission may be immediate with latencies under 50 ms, or it may incorporate a brief ramping period of 0.5-2 seconds to ensure the smooth re-engagement of the motion of the humanoid robot 1 using velocity and acceleration limits.

The clutch 3140 may be implemented in various physical forms, such as a button with tactile feedback, a switch with definitive positions, a trigger mechanism with proportional control, or another type of operator-actuated device that is integrated directly into the mobile data collection apparatus 3200, for example, on a hand-held component with ergonomic placement or on the main body of the mobile data collection apparatus 3200 within easy reach. This integration may allow the operator to selectively engage and disengage the clutch 3140 with one or both hands as appropriate during the performance of a task. For instance, a pressure-sensitive grip on a handheld controller with force thresholds of 5-20 N could be configured to function as the clutch 3140, disengaging control whenever the operator relaxes their grip below the threshold. In further configurations, a single clutch 3140 may receive engagement signals from a plurality of physical input devices coupled to the mobile data collection apparatus 3200, such that the operator may engage and disengage the clutch 3140 through whichever input device is most accessible during a given task phase.

In alternative embodiments, the clutch 3140 may be implemented as a separate, discrete device with wireless or wired connectivity. For example, the clutch 3140 could take the form of a foot pedal with adjustable resistance that is coupled to the computer 3110 and positioned on the floor for foot activation by the operator, or it could be made accessible to another supervising operator through a control panel. A supervising operator might utilize such a separate clutch 3140 to intervene in the operation for safety with emergency stop capabilities or for training purposes during skill transfer sessions. Alternative methods for clutch activation could involve the use of voice commands that are recognized by the system 3010 with recognition accuracies above 95%, gesture recognition that is performed using the sensors 3208 on the apparatus 3200 with gesture libraries of 10-50 commands, or even a predictive clutch engagement system using machine learning models. For example, a specific spoken phrase like “Pause robot” processed through speech recognition could activate the clutch 3140, and the phrase “Resume robot” could deactivate it with voice activation latencies under 500 ms.

Predictive engagement of the clutch 3140 might function based on detecting movement patterns that are indicative of non-task-related actions through anomaly detection algorithms, for example, large, rapid repositioning movements of the operator that fall outside the typical workspace (exceeding 1 meter) or velocity profile (exceeding 2 m/s) of the task being performed. A software-based clutch interface, which could be presented on the display 3150 or on an auxiliary screen with touch or gaze interaction, could also allow for activation through gaze control with dwell times of 0.5-2 seconds or through interaction with a tracked controller that is associated with the VR headset. The display 3150 could present a virtual button with visual feedback that the operator selects either via gaze dwell time or by pointing at it with a controller tracked at 90-120 Hz.

The clutch 3140, whether it is implemented as a physical or a virtual device, may incorporate advanced haptic feedback technologies providing multi-modal sensory confirmation. This haptic feedback could provide the operator with a tactile confirmation, such as a click with forces of 2-5 N, a vibration at frequencies of 100-300 Hz, or a change in resistance from 10 N to 30 N, that indicates the successful engagement and disengagement of the clutch 3140. Such feedback enhances the confidence of the operator and improves the overall usability of the system 3010 with user satisfaction scores improving by 15-25%. Additionally, the system 3010 may implement an intelligent clutch behavior, which could be managed by a dedicated intelligent clutch module running at 100-500 Hz. This intelligent clutch module might use machine learning algorithms trained on datasets of 103 to 105 operator interactions to analyze the movements of the operator and the current task context, thereby learning to predict and automatically engage the clutch 3140 during natural pauses lasting 2-10 seconds or transitions in the operator's workflow. This would further enhance the ergonomics and usability of the mobile data collection apparatus 3200, reducing operator fatigue by 20-30%. For example, if the system 3010 detects that the operator is looking away from the primary task area for an extended period exceeding 3 seconds, the intelligent clutch module might infer that a pause is intended and automatically engage the clutch 3140 with predictive accuracies above 90%.

In accordance with one aspect, the clutch 3140 addresses the technical objective of allowing the operator to suspend, resume, and reconfigure the mapping of operator pose to humanoid robot 1 control input during a teleoperation session. The clutch 3140 comprises a control logic module configured to receive an engagement signal and to switch the mapping among a plurality of states comprising: a master-enabled state in which substantially all operator-side joint and pose signals drive corresponding humanoid robot 1 actuators; a master-disabled state in which the mapping is suspended; and a joint-subset-suspended state in which a subset of operator-side signals (for example, signals corresponding to operator arm joints J1 through J7) is suspended while another subset (for example, head-pose signals to the head twist actuator J8.1 and the head nod actuator J8.2) remains active. The control logic module of the clutch 3140 comprises a state machine implemented in instructions executed on a processor of the computer 3110 or the piloting control system 3202, where the state machine receives the engagement signal as a discrete input event, transitions the active mapping state, and emits a state-transition signal to a downstream trajectory blender. Upon a transition between states, the control logic module is configured to apply a smooth trajectory blending function that ramps humanoid robot 1 actuator commands between a pre-transition mapping and a post-transition mapping over a ramp duration in the range of 0.5 to 2 seconds.

The smooth trajectory blending function of the clutch 3140 causes humanoid robot 1 joints to move smoothly through the transition, by which configuration commanded torque and velocity remain within bounded values during the transition and the humanoid robot 1 end-effector executes the transition while maintaining contact stability with environment surfaces in current contact. The clutch 3140 thereby supports operator workflows that include adjustment of operator arm pose with concurrent retention of head-tracking continuity at the head twist actuator J8.1 and the head nod actuator J8.2. Unlike conventional approaches that apply a step transition between an enabled mapping and a disabled mapping, the clutch 3140 does not require a single-state on/off interaction, and the disclosed clutch 3140 is free of an instantaneous-step transition that would otherwise cause discontinuous actuator commands. In one embodiment, the smooth trajectory blending function applies a linear interpolation, a cosine-based ease-in/ease-out interpolation, or a quintic polynomial interpolation between the pre-transition and post-transition command vectors over the ramp duration.

The clutch 3140 is configured to receive the engagement signal from one or more engagement modalities selected from: a button input; a foot-pedal input; a voice-command input processed by a speech-recognition module configured to recognize a defined command vocabulary at a recognition accuracy of approximately 95% with a per-command latency below 500 ms [SUPPORT GAP: predictive performance parameters and detailed speech-recognition pipeline disclosure-confirm support against original specification]; a gesture input recognizing a vocabulary of 10 to 50 defined gestures; a gaze-direction input from an HMD-integrated eye tracker, with engagement triggered after a dwell duration in the range of 0.5 to 2 seconds; a predictive machine-learning engagement input from a model trained on between 103 and 105 prior teleoperation interactions and configured to produce engagement predictions at greater than 90% accuracy; and a supervisor-actuated input received from an operator other than a primary teleoperator. In some embodiments, the clutch 3140 receives engagement signals from two or more of the foregoing modalities concurrently, and an arbitration logic resolves concurrent engagement and disengagement requests according to a defined modality priority order. The arbitration logic of the clutch 3140 comprises a priority-resolution rule set executed on a processor of the computer 3110 or the piloting control system 3202, where the priority-resolution rule set assigns each modality a priority rank and resolves concurrent inputs by selecting the modality whose priority rank is highest, with disengagement commands taking precedence over engagement commands of equal priority. The plurality of supported modalities allows operation by operators with different ergonomic configurations and supports task contexts in which one modality is constrained by environmental conditions (for example, a foot-pedal input is supported when ambient noise constrains a voice-command input).

The clutch 3140 further comprises a haptic feedback element configured to indicate clutch state transitions to the operator. The haptic feedback element is configured to output one or more of: a vibration in a frequency range of 100 to 300 Hz; a click force in a range of 2 to 5 N applied along an actuation axis of a clutch-input device; and a resistance force in a range of 10 to 30 N applied along the actuation axis. The haptic feedback is timed to coincide with an engagement transition, such that the operator senses, by tactile signal at the operator's body, the moment at which the mapping changes state, and the operator maintains awareness of clutch state through the tactile channel concurrently with visual attention on the VR HMD 3152. The combination of the engagement modalities and the haptic feedback element produces a closed-loop clutch interaction in which an operator-issued engagement command (delivered by any of the modalities above) is acknowledged at the operator's body by a corresponding tactile signal, by which the operator confirms clutch state through the tactile channel. The clutch 3140 is devoid of a single-input-modality dependency, such that engagement remains operable when any one of the disclosed modalities is unavailable.

iii. Display

The portable data collection system 3010 may include a display 3150 that provides visual feedback to the operator from the humanoid robot 1 and/or from the operator's viewpoint with refresh rates of 60-144 Hz and resolutions from Full HD to 8K. To provide this visual feedback with minimal latency, the display 3150 can be incorporated into one or more types of devices, including but not limited to: standard computer monitors that use technologies like liquid crystal display (LCD) with response times of 1-5 ms, organic light-emitting diode (OLED) with infinite contrast ratios, microLED with brightness exceeding 1000 nits, or quantum dot displays with color gamuts covering 100% of DCI-P3; virtual reality (VR) or augmented reality (AR) headsets (e.g., Sony PlayStation VR with 120 Hz refresh rate, the HTC Vive with 2K per eye resolution, the Apple Vision Pro with micro-OLED displays, and the Meta Quest series with inside-out tracking), which may function as the headset device; and other head-mounted display (HMD) configurations, including those where a mobile device is positioned within a headset frame (e.g., Google Cardboard-style viewers supporting phones with 5-7 inch displays, Merge VR Goggles with adjustable lenses, Carl Zeiss VR One Plus with 100-degree field of view, Xiaomi Play2 with focus adjustment, and similar models, as well as projected displays with lumens ratings of 3000-10000). A headset device, referred to herein as the VR HMD 3152 when implemented as a virtual reality head-mounted display, may include a head position sensor, such as an internal IMU, configured to determine a position of a head of the operator and provide head positional data to the piloting control system.

Additionally, the display 3150 may be alternatively implemented using technologies such as transparent displays with 50-80% transparency, holographic projectors creating 3D images without glasses, electronic ink (e-ink) panels with power consumption under 10 mW, laser projection systems with 4K resolution, multi-panel display arrays creating wrap-around views, curved monitors with 1000R-1800R curvature, flexible displays that can be rolled or folded, retinal projection systems directly imaging onto the retina, and/or any other known display or display system technology that is suitable for presenting the visual feed of the humanoid robot 1. Projection mapping systems with 10,000+ lumens could serve as an alternative for the display 3150, projecting the view of the humanoid robot 1 or related information onto surfaces within the environment of the operator, an approach which offers a different form of immersion or situational awareness when compared to head-mounted displays.

In some embodiments, the display 3150 may further include advanced optical components with specific optical characteristics. Examples of such components include Fresnel lenses with focal lengths of 40-50 mm, pancake lenses reducing thickness by 50%, waveguide optics with efficiency above 85%, or diffractive optical elements with sub-wavelength features, which can be used, particularly in HMDs, to enhance visual clarity to 20/20 vision equivalent, widen the field of view to 110-200 degrees, and minimize optical distortion to less than 2% across the field in augmented and virtual reality environments. Additional implementations may integrate adaptive optics that are capable of adjusting their focal lengths in real-time from 0.5 to 3 meters, in order to accommodate the specific vision conditions of the operator or to simulate focus changes that correspond to the sensor focus of the humanoid robot 1. Tunable polarization filters with extinction ratios of 1000:1 might also be included to improve contrast and reduce glare under the varying environmental lighting conditions from 10 to 100,000 lux that are reported by the humanoid robot 1. Furthermore, high-refresh-rate displays, such as those operating at 120 Hz, 144 Hz, 240 Hz or higher, may be utilized in conjunction with motion prediction algorithms predicting 16-33 ms ahead to further reduce the perceived latency to under 20 ms and improve the real-time responsiveness of the visual feedback. Variable Refresh Rate (VRR) technologies supporting ranges of 48-144 Hz, adapted for VR use cases, could also help to smooth the visual performance by allowing the display 3150 refresh rate to synchronize with the rendering rate of the graphics pipeline, although fixed high refresh rates combined with latency compensation techniques like Asynchronous Timewarp (ATW) reducing latency by 20-40 ms and ASW maintaining smooth motion at 45 fps input are common strategies in VR. VRR can reduce screen tearing and stutter by 90%. These collective enhancements all contribute to creating a more immersive and accurate visual representation of the operational environment of the humanoid robot 1 for the operator with presence scores above 4.5 on a 5-point scale. The overall goal is to achieve a seamless and realistic operator experience with motion-to-photon latencies under 20 ms.

In order to transform visual data that is received from the humanoid robot 1, which may be captured in a vertical stereo vision format using vertically separated cameras with baselines of 50-200 mm, into a horizontally oriented stereo image that is suitable for human viewing (e.g., a VR headset with horizontal IPD of 58-72 mm), specialized software methods may be implemented achieving transformation latencies under 10 ms. These methods may include geometric rectification using homography transformations with 3×3 matrices, disparity re-projection techniques maintaining depth accuracy within 1%, convolutional neural networks (CNNs) with 106 to 108 parameters specifically trained for stereo image conversion tasks, and adaptive warping techniques with per-pixel displacement maps. Algorithms such as those that are based on epipolar geometry transformation can be applied to remap the vertically aligned depth or image data into a horizontal stereo pair while attempting to maintain accurate depth perception for the viewer with depth estimation errors under 5%. This category of methods broadly covers various view synthesis and image rectification techniques, such as Depth Image Based Rendering (DIBR) with depth map resolutions of 1080p, Neural Radiance Fields (NeRF) with 105 to 106 sample rays, 3D Gaussian Splatting (3DGS) with 104 to 106 Gaussians, Multi-Plane Images (MPI) with 32-128 depth planes, or direct learned transformations that are executed on the appropriate processing hardware capable of 1-10 TFLOPS, which could be located on the humanoid robot 1, on an edge computer 3110, or distributed between them with task allocation based on available compute.

In accordance with another aspect, the system addresses the technical objective of presenting, on a head-mounted display configured for horizontal stereoscopic viewing by a human operator, image data captured by a stereo camera pair arranged vertically on the head and neck assembly 10 of the humanoid robot 1. The system comprises an upper head camera 108.2.2 and a lower head camera 108.2.4 of the humanoid robot 1, each configured to capture an image; a vertical-to-horizontal stereo transformation module configured to receive an upper image from the upper head camera 108.2.2 and a lower image from the lower head camera 108.2.4 and to output a left-eye image and a right-eye image arranged for horizontal stereoscopic display; and a virtual reality (VR) head-mounted display (HMD) 3152 configured to display the left-eye image to a left eye of the operator and the right-eye image to a right eye of the operator. The vertical-to-horizontal stereo transformation module is configured to compute the left-eye image and the right-eye image by reprojecting the upper image and the lower image into a virtual horizontal stereo viewpoint pair, the viewpoints of the virtual horizontal stereo viewpoint pair being laterally separated such that disparity in the resulting left-eye image and right-eye image appears along a horizontal axis aligned with a human binocular fusion axis.

The vertical-to-horizontal stereo transformation module comprises instructions stored in a memory and executed on a processor of the computer 3110, of compute 1000 of the humanoid robot 1, or of a processor distributed between the computer 3110 and compute 1000, where the instructions implement at least one reprojection pipeline. The vertical-to-horizontal stereo transformation module is configured to perform the reprojecting by one or more of: (a) homography-based image rectification computed from intrinsic and extrinsic parameters of the upper head camera 108.2.2 and the lower head camera 108.2.4; (b) depth-image-based rendering (DIBR) using a depth map estimated from the upper image and the lower image; (c) neural radiance fields (NeRF) rendering with the upper image and the lower image supplied as conditioning views; (d) three-dimensional Gaussian splatting; (e) multi-plane image (MPI) representation; (f) light-field rendering; and (g) a learned warping function trained to map vertically arranged stereo input to horizontally arranged stereo output. In some embodiments, the vertical-to-horizontal stereo transformation module further incorporates a lens-distortion correction stage configured to undistort the upper image and the lower image prior to the reprojecting, where each of the upper image and the lower image is captured through a fisheye lens. The downward pitch of the upper head camera 108.2.2 and the lower head camera 108.2.4 (in the range of 0 to 9 degrees, and in one embodiment in the range of 6.7 to 8.2 degrees) is preserved through the reprojecting such that the operator's view, as displayed on the VR HMD 3152, depicts a manipulation workspace from a viewpoint pitched downward by the same angle, by which the operator perceives the workspace immediately in front of the humanoid robot 1 with binocular depth cues.

The horizontal-stereo output of the vertical-to-horizontal stereo transformation module places binocular disparity along a horizontal axis on the VR HMD 3152, such that the operator's binocular vision system, which fuses horizontally separated viewpoints, receives image content with disparity along the axis matching the geometry of human binocular fusion. As a result, the operator perceives depth in the displayed scene through the binocular fusion mechanism used in unaided vision, and the operator judges manipulation distance and contact-point geometry from the displayed image. The system thereby supports a humanoid head form factor in which the upper head camera 108.2.2 and the lower head camera 108.2.4 are arranged along a vertical axis of the head and neck assembly 10, while presenting the operator with depth-cued visual feedback compatible with horizontal binocular fusion. Unlike conventional approaches that present horizontally captured stereo images directly to a horizontal HMD, the disclosed system does not require horizontally arranged head-mounted cameras, and the head and neck assembly 10 of the humanoid robot 1 is free of a horizontal-baseline stereo camera pair on the disclosed humanoid head form factor. In one embodiment, a per-frame latency of the vertical-to-horizontal stereo transformation module from capture to display is bounded such that closed-loop responsiveness of operator-in-the-loop control of the humanoid robot 1 is maintained.

The display 3150 and/or the portable data collection system 3010 may also include capabilities for integrating additional sensor modalities to provide an enriched interaction experience for the operator with multi-modal feedback improving task performance by 15-30%. Multi-modal interaction serves to enhance the level of control precision and situational awareness. These modalities may include eye-tracking sensors with accuracies of 0.5-1 degree and sampling rates of 120-250 Hz, gesture recognition systems which may use cameras or other sensors detecting 20-50 distinct gestures, capacitive or resistive touch interfaces with response times under 10 ms which may be on associated controllers or on the display 3150 itself, voice control systems with vocabulary sizes of 1000-10000 words, or biometric sensors like heart rate monitors (30-250 BPM) or galvanic skin response sensors (0.01-100 μS) providing physiological feedback. These additional sensors provide alternative input channels for the operator with recognition accuracies above 95%.

Eye-tracking technology that is integrated into a VR headset is particularly relevant in this context with calibration times under 30 seconds. Eye-tracking has several applications in VR enhancing both performance and user experience. It enables gaze-contingent rendering, which involves rendering higher detail only in the area where the operator is currently looking (typically 20-30 degrees), and it also enables foveated encoding, which involves compressing the video stream more aggressively in the peripheral vision areas with compression ratios of 10:1. These techniques serve to optimize both rendering performance and bandwidth usage by 40-60%. Both of these techniques can significantly reduce the computational load and the network bandwidth requirements for rendering and transmitting the high-resolution video stream from the humanoid robot 1. The resulting efficiency gains are substantial, enabling higher resolution displays or reduced hardware requirements.

Furthermore, other sensor modalities, beyond those related to the interaction of the operator, may be incorporated to enhance the ability of the display 3150 to interpret and present the perception of the humanoid robot 1 of its surroundings with enhanced environmental awareness. These may include depth-sensing cameras that provide depth maps with 1-10 mm accuracy at 30-60 fps, infrared sensors for enhanced vision in low-light conditions down to 0.001 lux, electromagnetic motion tracking systems for providing precise positional awareness of tracked objects or controllers with sub-millimeter accuracy, environmental microphones that are integrated into the display 3150 device for spatial audio processing with 360-degree sound localization, thermal imaging sensors for detecting heat signatures, and/or any other sensors that are disclosed elsewhere herein as being part of the humanoid robot 1 or the system 3010.

Integrating spatial audio rendering with 7.1 or Atmos support, which is synchronized accurately with the visual feed presented on the display 3150 with audio-visual sync within 40 ms, can further enhance the immersion and situational awareness of the operator for teleoperation tasks improving task completion rates by 10-20%. Haptic feedback mechanisms that are integrated into the display 3150 device or its associated controllers, such as vibrating motors operating at 20-1000 Hz or force feedback elements providing up to 40N, could provide tactile cues that correspond to events in the environment of the humanoid robot 1 or provide feedback related to the actions of the humanoid robot 1, thereby complementing the visual and audio information with response times under 20 ms.

Separate and apart from the calibration procedures for the mobile data collection apparatus 3200, the display 3150 itself may also utilize its own calibration procedures using 2-5 minutes. These procedures, which may employ image processing techniques and corrective transformation matrices updated at 60-120 Hz, may be implemented to ensure color accuracy within ΔE<2, geometric fidelity with distortion under 1%, and depth perception consistency within 5% in the visuals that are presented to the operator. These display calibrations may include machine learning-based error correction algorithms with neural networks of 104 to 106 parameters that dynamically adjust for image distortions based on real-time feedback or the known hardware characteristics of the display 3150. This can help to compensate for issues like lens aberrations in HMDs (typically 1-5% distortion), motion blur effects with 1-10 ms persistence, and to adapt to the different environmental lighting conditions from 10 to 100,000 lux that are being experienced by the humanoid robot 1. The calibration processes might utilize standardized reference targets, such as color checker patterns with 24 color patches that are viewed by the cameras of the humanoid robot 1, structured light scans of known geometries with patterns projected at 30-120 Hz, or pre-computed depth maps with resolutions matching the display, in order to derive calibration equations or lookup tables that are able to mitigate distortion and ensure visual consistency across varying operational conditions with calibration accuracies better than 1%. Operator-specific calibration profiles for the operator could also be stored and applied, which would account for individual operator preferences or visual characteristics, such as their interpupillary distance (IPD) ranging from 52-78 mm. This Personalization improves both comfort reducing eye strain by 30-50% and accuracy for the operator improving depth perception accuracy by 10-20%.

Ensuring an accurate calibration between the cameras of the humanoid robot 1, including their intrinsic parameters like focal length (typically 3-50 mm) and distortion coefficients (k1, k2, p1, p2, k3), and their extrinsic parameters like their relative position (accurate to 1 mm) and orientation (accurate to 0.1 degrees), especially the vertical baseline separation if applicable (typically 50-200 mm), and then correctly mapping the resulting stereo view to the measured IPD of the operator in the VR headset is an integral process. This accurate mapping helps to provide a comfortable and accurate stereoscopic viewing experience with vergence-accommodation conflicts minimized, preventing eye strain for the operator during sessions lasting 2-8 hours and avoiding misperceptions of depth or scale in the presented view with depth accuracy maintained within 5%. Furthermore, advanced computational imaging techniques, such as multi-view stereo reconstruction using 2-8 camera views, photometric calibration to ensure consistent brightness and color response across 0.1-100,000 lux, and adaptive exposure correction algorithms with dynamic ranges of 120 dB, may be employed on the image data before it is displayed, in order to enhance the accuracy and reliability of the visual data being presented. Real-time optimization algorithms running at 60-120 Hz may also be implemented to compensate for minor discrepancies in the stereo vision alignment that might occur during operation, which ensures that the depth information remains reasonably accurate within 2-3% error and dynamically responsive to any environmental changes. Techniques for online camera calibration updating every 10-60 seconds or adaptive rectification with sub-pixel accuracy could also be employed for this purpose. These techniques could be configured to run periodically or continuously to maintain the alignment accuracy within 1-2 pixels, even if minor mechanical shifts occur in the camera rig of humanoid robot 1 over time due to factors such as vibration at 10-100 Hz or temperature changes of +20 °C.

Operationally, the display 3150 can be physically configured in multiple ways to accommodate different use cases and operator preferences. It might be designed to be worn by the operator with head strap tensions of 10-30N, as is the case with an HMD weighing 300-800 grams, it might be mounted directly on the mobile data collection apparatus 3200 at eye level, or it could be positioned in a stationary manner, like a desktop monitor at viewing distances of 50-100 cm, in front of the operator during the operation of the apparatus 3200. Additionally and/or alternatively, the display 3150 system or the broader portable data collection system 3010 may include the capability to process image data through real-time rendering engines achieving 60-120 fps and sensor fusion algorithms with latencies under 5 ms. These algorithms are designed to integrate inputs from various sensors, including inertial measurement units (IMUs) that are located within the display 3150 device itself with update rates of 500-1000 Hz, LiDAR sensors on the humanoid robot 1 with 300,000-2,000,000 points per second, infrared depth cameras on the humanoid robot 1 operating at 30-90 fps, electromagnetic motion tracking systems with update rates of 240-360 Hz, environmental microphones for spatial audio processing with 48-192 kHz sampling, and other vision-based tracking systems, such as SLAM running on the headset cameras achieving 6-DOF tracking. Specifically for a VR headset implementation of the display 3150, the rendering engine may use inputs from the headset's own IMU updating at 1000 Hz and its tracking system, which could be, for example, inside-out tracking using the headset's cameras with 4-6 cameras or outside-in tracking using external sensors with sub-millimeter precision.

Additionally or alternatively, the display 3150 may include capabilities to provide augmented reality (AR) overlays with registration accuracies of 1-5 mm. These overlays would utilize environmental mapping techniques, such as simultaneous localization and mapping (SLAM) algorithms processing 30-60 fps, which could run either on the humanoid robot 1 or on the AR display device itself with dedicated processors. This would enable the dynamic alignment of virtual information or graphics with the view of the operator of their physical surroundings with update rates of 60-90 Hz, as seen either directly or through the cameras of the humanoid robot 1. Further, machine learning-based predictive tracking algorithms with prediction horizons of 20-100 ms may be implemented to anticipate the head movements of the operator more accurately and preemptively begin rendering the corresponding visuals, which further contributes to the reduction of perceived latency by 30-50%.

Moreover, the display 3150 system may also include features like diagnostic modes showing system metrics updated at 10-30 Hz, which could show raw sensor data or system status, playback functionalities for reviewing recorded sessions at variable speeds from 0.25× to 4×, or immersive simulation modes for training or testing with physics simulations at 1000 Hz. In these modes, latency minimization may be achieved through techniques such as variable refresh rate (VRR) supporting 48-240 Hz and adaptive sync technologies with response times under 1 ms, which help to ensure that the effective frame update interval remains consistent even under rapid motion conditions exceeding 180 degrees/second, although techniques like ATW/ASW are generally considered for maintaining smooth visual perception during frame rate fluctuations in VR environments. Ensuring low latency under 20 ms and smooth visuals above 90 fps is a constant focus of the system design achieving user comfort ratings above 4/5. For instance, an alternative diagnostic mode may overlay the predicted trajectories or planned paths of the humanoid robot 1 onto the view of the operator with trajectory updates at 30 Hz, which would allow for an intuitive assessment of the intentions of the humanoid robot 1. The Playback functionalities may also incorporate the synchronized playback of multiple sensor data streams alongside the visual feed with synchronization accuracy within 1 ms, a feature which facilitates a detailed post-session analysis of the performance of both the humanoid robot 1 and the inputs of the operator with analysis tools supporting frame-by-frame review.

iv. Data Storage

The data storage database 3204 collects and stores robot data generated by the actuators (J1-J7) for subsequent training and analysis purposes. The robot data collected and stored by the data storage database 3204 can be filtered, labeled, refined, and/or modified to generate training data that can be used for training of networks that will run on one or more humanoid robots 1. The data storage database 3204 may be a server, a hard drive, a computer, or other device or devices suitable to collect and store data with sufficient capacity and throughput. Similar to the discussion regarding the location of the computer 3110, the data store 3204 may be local to the humanoid robot 1 with direct bus connections, the mobile data collection apparatus 3200 (e.g., integrated with piloting control system 3202), or the computer 3110 with high-speed interfaces. In other examples, the data store 3204 may not be local and instead may be remote relative to one or more of the humanoid robot 1, the mobile data collection apparatus 3200, or the computer 3110, connected through network links with appropriate bandwidth and reliability.

b. Robot Head-Mount Sensors and Robot Hardware Platform

In accordance with another aspect, the humanoid robot 1 addresses the technical objective of supporting on-board compute and energy storage for full-body teleoperation within an anthropomorphic envelope. The humanoid robot 1 comprises a torso 16 defining an internal volume in the range of 10 to 40 liters and an uninterrupted internal height in the range of 250 to 350 mm [RANGE FLAG: ranges 10-40 liters and 250-350 mm added-verify against original disclosure and figures]; a battery housed within the internal volume and configured to provide greater than 2.5 kWh of electrical energy [RANGE FLAG: battery capacity >2.5 kWh added—verify against original disclosure]; on-board compute housed within the internal volume; a left arm and a right arm each having seven degrees of freedom corresponding to joints J1 through J7; a left hand and a right hand each having six hand actuators, the hand actuators of the left and right hand totaling twelve hand actuators; a head and neck assembly 10 having two degrees of freedom corresponding to a head twist actuator J8.1 and a head nod actuator J8.2; and legs corresponding to joints J11 through J16, the joints J1 through J16 totaling 30 actuators excluding the hand actuators [RANGE FLAG: leg joint numbering J11-J16 and total actuator count of 30 added—verify against original disclosure and figures]. In one embodiment, the internal volume of the torso 16 is in the range of 20 to 30 liters [RANGE FLAG: 20-30 liters preferred range added—verify against original disclosure]. The combined internal volume, battery energy capacity, and on-board compute support a runtime in the range of 3.5 to 6 hours or more during full-body teleoperation [RANGE FLAG: runtime 3.5-6 hours added—verify against original disclosure]. In some embodiments, the joint architecture of the arm joints J1 through J7 is distributed across a shoulder portion (joints J1 through J3), an elbow portion (joints J4 and J5), and a wrist portion (joints J6 and J7).

The internal volume range of 10 to 40 liters of the torso 16 (and in one embodiment 20 to 30 liters) is selected to accommodate the >2.5 kWh battery and the on-board compute concurrently within an anthropomorphic envelope, such that the humanoid robot 1 retains anthropomorphic proportions while supporting the disclosed runtime of 3.5 to 6 hours or more. The uninterrupted internal height of 250 to 350 mm of the internal volume permits installation of a unitary battery cell stack at maximal volumetric energy density. The combined selection of the internal volume range, the internal height range, and the battery energy capacity supports a class of full-body teleoperation tasks (for example, manipulation, locomotion, and combined manipulation-while-walking) for the duration of an operator work shift on a single charge. In one embodiment, the on-board compute is housed adjacent the battery within the internal volume of the torso 16, with a thermal management subsystem configured to dissipate heat generated by the battery and the on-board compute through a torso surface. Unlike conventional humanoid robot platforms that distribute the energy source on an off-board tether or accessory pack, the disclosed humanoid robot 1 does not require an external power tether for the disclosed runtime, and the torso 16 is free of an obligatory off-board energy source for full-body teleoperation operation.

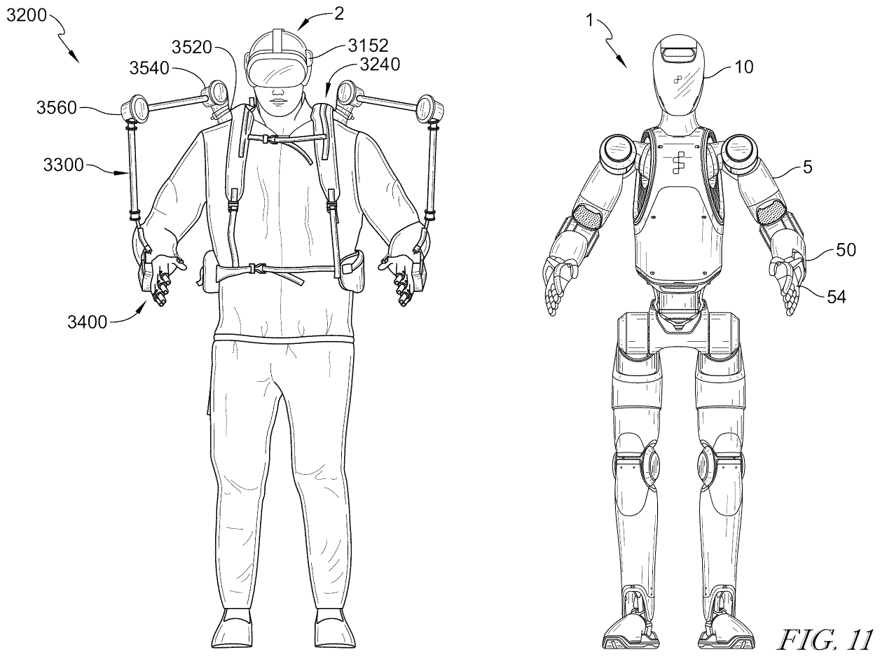

As best shown in FIGS. 10A-10B, the head and neck assembly 10 of the humanoid robot 1 may be designed to enhance anthropomorphic characteristics while providing functional capabilities that support interaction, perception, and communication. For example, the head 10 may house a range of components, such as high-resolution cameras, microphones, and displays, within an impact-resistant polymer shell designed to resemble a human head. Cameras embedded within the head 10 may include RGB, depth-sensing, or thermal imaging capabilities, enabling the humanoid robot 1 to perform tasks such as object recognition, environmental mapping, and facial expression analysis. For the specific purpose of generating a low-latency VR view, a pair of high-resolution, high-frame-rate RGB cameras with global shutters may be utilized. For example, the pair may be the vertically arranged upper head camera 108.2.2 and lower head camera 108.2.4 and/or the horizontally arranged external cameras 302A, 302N. Microphones may be arranged in an array to facilitate directional audio input and noise cancellation, enhancing the ability of the humanoid robot 1 to understand and respond to verbal commands. Displays integrated into the head 10 could serve as user interfaces, providing visual feedback or conveying expressions to improve communication and user engagement. Additionally, the head 10 may house other sensors such as gyroscopes, accelerometers, heat management systems, and communication equipment such as radios and antennas. This integrated design may enable seamless operation and robust functionality in dynamic and interactive environments. The head and neck assembly 10 may also incorporate materials and shock-absorbing structures to protect the electronic components housed within, potentially improving the overall durability and reliability of the humanoid robot 1.

The head and neck assembly 10 may include two primary actuators: a head twist actuator J8.1, responsible for enabling rotational movement of the head 10 about the vertical axis (yaw), and a head nod actuator J8.2, which adjusts the pitch of the head 10 about the horizontal axis. Together, these actuators J8.1, J8.2 may provide two degrees of freedom (2 DoF) for the head 10, allowing the head 10 to perform movements that emulate human head motions. The head twist actuator J8.1 may typically be located at the base of the neck, where the head twist actuator J8.1 interfaces with the torso 16, while the head nod actuator J8.2 may be positioned within the head assembly and enables forward and backward tilting of the head 10. This head twist actuator J8.1 and head nod actuator J8.2 may utilize a similar motor, gear reduction system, sensors, and/or encoders as the actuators discussed above in connection with the mobile data collection apparatus 3200. The head actuators J8.1 and J8.2 may work in coordination to position the head 10 accurately, enabling the humanoid robot 1 to track objects, focus on specific areas, or maintain eye contact during human-robot interactions. The actuators J8.1, J8.2 may be controlled by a motion planning system that processes input from visual and inertial sensors to execute smooth, human-like movements. For example, the head twist actuator J8.1 may rotate the head 10 to follow a moving object, while the head nod actuator J8.2 adjusts the pitch to maintain a useful viewing angle.

Variations of this design could include the addition of a third actuator to provide roll motion, further increasing the range of movement of the head 10 to 3 DoF, which could enable more expressive head gestures, such as tilting the head 10 sideways to convey curiosity or empathy. Alternatively, the actuators J8.1, J8.2 could be replaced with compact linear actuators or parallel-link mechanisms for specialized applications requiring higher precision or load capacity. Additionally, variations could include modular head designs that allow for quick customization or replacement of components. These modular designs may facilitate easy upgrades or modifications to the sensory and communication capabilities of the humanoid robot 1 without requiring extensive changes to the overall head and neck assembly 10. Furthermore, control algorithms could be implemented to enable more natural, biomimetic head movements, potentially incorporating machine learning techniques to adapt and refine the motion patterns of the head 10 based on interaction data and environmental feedback.

As shown in FIG. 10A, the head 10 includes an enclosure 102.2, a frontal shield 102.4 and a neck shell 102.8. The head 10 can also include an opening for a screen 108.4, and (ii) at least one sensor (e.g., upper head camera 108.2.2 and lower head camera 108.2.4), representing the vertically arranged onboard cameras central to the image transformation problem. The screen 108.4 may be rectangular with a curvature. The opening for the screen 108.4 formed in the enclosure 102.2 of the head 10 may be shaped with contours around said screen opening to receive the curved shape of the screen 108.4 without obstructing the view. The upper head camera 108.2.2 and the lower head camera 108.2.4 may be arranged in a vertical orientation and may be placed at the same angle relative to the horizontal plane or transverse plane. For example, the angle between the upper head camera 108.2.2 and the lower head camera 108.2.4 may be positioned at a slight downward angle of about 0 to about 9.0 degrees, or about 6.7 to about 8.2 degrees with respect to a horizontal plane or transverse plane. The specific vertical separation (baseline distance) and convergence angle of these cameras 108.2.2, 108.2.4 are key input parameters for the geometric transformation algorithms, requiring precise calibration.

The head and neck assembly 10 carries a stereo camera pair comprising the upper head camera 108.2.2 and the lower head camera 108.2.4 arranged vertically, such that an optical axis of the upper head camera 108.2.2 is disposed above an optical axis of the lower head camera 108.2.4 along a vertical direction defined relative to a gravity vector when the head and neck assembly 10 is in a neutral posture. A vertical baseline distance between an optical center of the upper head camera 108.2.2 and an optical center of the lower head camera 108.2.4 is in the range of 5 to 15 cm [RANGE FLAG: vertical baseline 5-15 cm added—verify against original disclosure and figures]. The optical axes of the upper head camera 108.2.2 and the lower head camera 108.2.4 are pitched downward by an angle in the range of 0 to 9 degrees with respect to a horizontal plane, and in one embodiment in the range of 6.7 to 8.2 degrees, the downward pitch being selected to bring a manipulation workspace immediately in front of the humanoid robot 1 within a field of view of each of the upper head camera 108.2.2 and the lower head camera 108.2.4. In some embodiments, each of the upper head camera 108.2.2 and the lower head camera 108.2.4 includes a fisheye lens, and the on-board compute is configured to apply lens-distortion correction to images captured by the upper head camera 108.2.2 and the lower head camera 108.2.4 prior to downstream stereo processing. Unlike conventional humanoid robot heads that rely on horizontally arranged stereo camera pairs, the head and neck assembly 10 of the humanoid robot 1 is free of a horizontal-baseline stereo camera pair on the disclosed humanoid head form factor and does not require horizontal lateral spacing between stereo cameras for stereo depth acquisition.

The lens of each of the upper head camera 108.2.2 and the lower head camera 108.2.4 can be received within respective upper and lower sensor openings of the housing of the head 10. The humanoid robot 1 has stereo vision along with the ability to identify and read bar codes. Due to the fisheye lenses that are installed with the upper head camera 108.2.2 and the lower head camera 108.2.4, the field of view of the humanoid robot 1 is increased over conventional lenses. However, the use of the fisheye lenses causes the image to be warped or distorted nearly the periphery of said image. Correcting fisheye distortion is a standard preprocessing step in the pipeline, but the extreme distortion can make accurate rectification or view synthesis more challenging, potentially requiring more complex warping functions or learned approaches compared to rectilinear lenses. This being said, the distortion of the image can be corrected or partially corrected by a custom-built algorithm to help increase data extraction in these regions. In other embodiments, the fisheye lenses currently shown and used to generate the image may be replaced with other lens types (e.g., standard or non-fisheye lens). Using rectilinear lenses might simplify the geometric transformation task but would reduce the field of view compared to fisheye lenses, presenting a design trade-off.

The upper head camera 108.2.2 and the lower head camera 108.2.4 are primarily for task-related visualization, providing a field of view in front of the humanoid robot 1. In other embodiments, a rear camera may be included primarily for situational awareness and localization of the humanoid robot 1, providing a field of view behind the humanoid robot 1. Similarly, a top camera may assist with localization of the humanoid robot 1. The cameras 108.2.2, 108.2.4 are not 360-degree cameras and have restricted fields of view. For example, the angles of the upper head camera 108.2.2 and the lower head camera 108.2.4 may be adjusted to provide a fuller field of view and minimize blind spots or dead space. Positioning the camera sensors 108.2.2, 108.2.4 on the head 10 of the humanoid robot 1 also allows for movement of the sensors 108.2.2, 108.2.4 for better viewing with less movement of the overall humanoid robot 1. By moving the head 10 up and down and rotating the head 10 left and right, the target image within the fields of view of the cameras 108.2.2, 108.2.4 is changed and provides a larger, derivative field of view from the sensor assembly 108.2.

The humanoid robot 1 may move its head 10 up and down by bending at the neck to adjust the orientation of the cameras 108.2.2, 108.2.4. For example, the neck is able to bend up and down about ±25 degrees, which allows the upper head camera 108.2.2 and the lower head camera 108.2.4 to view 200 mm in front of the feet 92 of the humanoid robot 1. About 20 degrees of forward torso lean allows the upper head camera 108.2.2 and the lower head camera 108.2.4 to view the feet 92. The positions of the cameras 108.2.2, 108.2.4 thus provide a closer or better view to the feet 92 of the humanoid robot 1 compared to cameras mounted to the torso 16 of the humanoid robot 1 because the fields of view of the upper head camera 108.2.2 and the lower head camera 108.2.4 are not entirely blocked by the legs 6 of the humanoid robot 1. Additionally, the humanoid robot 1 may turn its head 10 left and right to adjust the orientation of the cameras 108.2.2, 108.2.4. The images or video recorded by the cameras 108.2.2, 108.2.4 may be processed for stereoscopic transformation for VR display.

Although upper, lower top, and rear cameras 108.2.2, 108.2.4 are shown as illustrative examples, other sensors may be relied on and coupled to an internal mounting frame in a similar manner to ensure proper directional positioning for respective detection, sensing, or signal reception. Relevant sensor types for low-latency VR include color cameras (typically CMOS), cameras with global shutters (preferred over rolling shutter), high-speed cameras (higher frame rates reduce latency), 3D cameras (like ToF or structured light, if depth is directly used), light field cameras (for alternative view synthesis), or potentially event cameras (for ultra-low latency paths). Said camera may have a megapixel resolution of between 0.4 MP to 20 MP, may record video at frame rates suitable for VR (e.g., >60 FPS, ideally >=90 FPS), may have a CMOS sensor, pixel size may range from 2.4 μm to 6.9 μm, and preferably utilizes global shutter. Said sensors may include: (i) scan camera(s), (ii) monochrome camera(s), (iii) color camera(s), (iv) CMOS camera(s), (v) CCD sensor(s) or camera(s) that include CCD sensor(s), (vi) camera(s) or sensor(s) that have rolling shutter or global shutter, (vii) other types of 2D digital camera(s), (viii) other types of 3D digital camera(s), (ix) camera(s) or sensor(s) that are capable of stereo vision, structured light, and laser triangulation, (x) sonar camera(s) or ultrasonic camera(s), (xi) infrared sensor(s) and/or infrared camera(s), (xii) radar sensor(s), (xiii) LiDAR, (xiv) other structured light sensors, camera(s), or technologies, (xv) dot projecting camera(s) or sensor(s), (xvi) Time-of-Flight (ToF) cameras, (xvii) hyperspectral cameras, (xviii) multispectral cameras, (xix) thermal imaging cameras, (xx) high-speed cameras, (xxi) panoramic cameras, (xxii) omnidirectional cameras, (xxiii) polarization cameras, (xxiv) plenoptic (light field) cameras, (xxv) depth-sensing cameras, (xxvi) ultraviolet (UV) cameras, (xxvii) single-photon avalanche diode (SPAD) cameras, (xxviii) electron-multiplying CCD (EMCCD) cameras, (xxix) short-wave infrared (SWIR) cameras, (xxx) medium-wave infrared (MWIR) cameras, (xxxi) long-wave infrared (LWIR) cameras, (xxxii) quantum dot cameras, (xxxiii) microbolometer cameras, (xxxiv) holographic cameras, (xxxv) optical coherence tomography (OCT) cameras, (xxxvi) spectral imaging cameras, (xxxvii) phase contrast cameras, (xxxviii) interferometric cameras, (xxxix) fiber optic cameras, (xl) terahertz cameras, (xli) millimeter-wave cameras, (xlii) acoustic cameras, (xliii) biometric cameras (e.g., iris recognition cameras), (xliv) artificial compound eye cameras, (xlv) volumetric capture cameras, (xlvi) computational photography cameras, (xlvii) smartphone cameras with advanced sensors, (xlviii) augmented reality (AR) and virtual reality (VR) cameras, (xlix) streak cameras, (l) burst-mode cameras, (li) LiFi (Light Fidelity) cameras, or any combination of the above or any other known camera or sensor. For example, said camera may have a megapixel resolution of between 0.4 MP to 20 MP, may record video at 5.6 FPS to 286 FPS, may have a CMOS sensor, pixel size may range from 2.4 μm to 6.9 μm, may utilize a starves rolling shutter technology, can operate in 55 degree C ambient air temperatures, and may have any other properties, technologies, or features that are discussed within U.S. Pat. Nos. 11,402,726, 11,599,009, 11,333,954, or 11,600,010, all of which are incorporated herein by reference. It should be understood that the cameras are typically configured as video cameras but may have an alternative configuration, such as an image camera. The head 10 can also include one or more cameras, temperature sensors, pressure sensors, force sensors, inductive sensors, capacitive sensors, ultrasonic sensors, infrared sensors, proximity sensors, microphones, gas sensors, light sensors (photodiodes, phototransistors), UV sensors, time-of-flight sensors, LiDAR sensors, optical flow sensors, RFID readers, laser rangefinders, 3D depth cameras, or any combination of these sensors or other known sensors.

The information from each of the upper head camera 108.2.2 and the lower head camera 108.2.4, may be used alone or in combination with information from other cameras (e.g., top and rear cameras) and/or sensors included on the humanoid robot 1 to aid in the control of the humanoid robot 1. The information from said cameras may be used to help the humanoid robot 1 navigate or locomote on different terrain, localize to different environments and plan routes, and sense and avoid obstacles. When these cameras 108.2.2, 108.2.4 are used for both control/perception of the humanoid robot 1 and generating the VR feed, resource contention (compute, memory bandwidth, data bus) must be managed to avoid impacting the latency of the VR stream. Architectures separating the VR feed (e.g., using external cameras 302A-N and a direct dataflow) can mitigate the latency issues. The upper, lower top, and rear cameras may be utilized in similar ways or methods that are discussed within U.S. Patent Application Publication 2005/0267631 and U.S. Pat. Nos. 10,638,906, 10,437,251, 11,020,860, 10,580,208, 11,485,013, 11,759,075, or 10,614,588, all of which are incorporated herein by reference.

c. Wearable Data Collection Apparatus

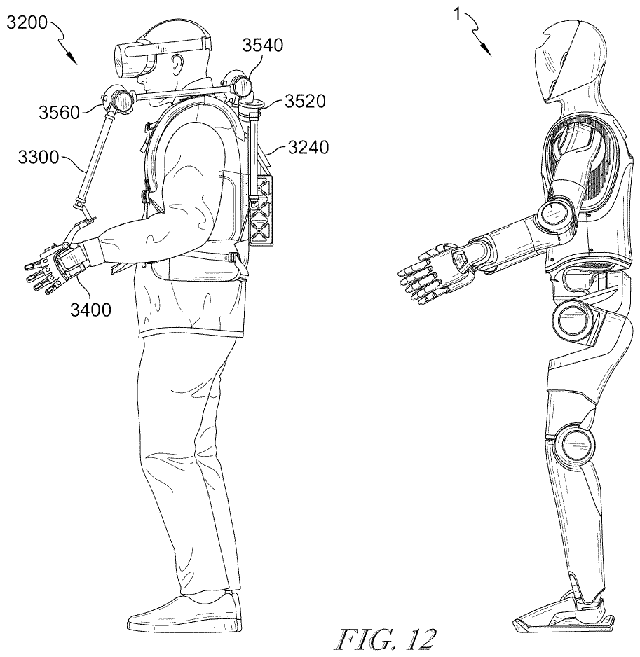

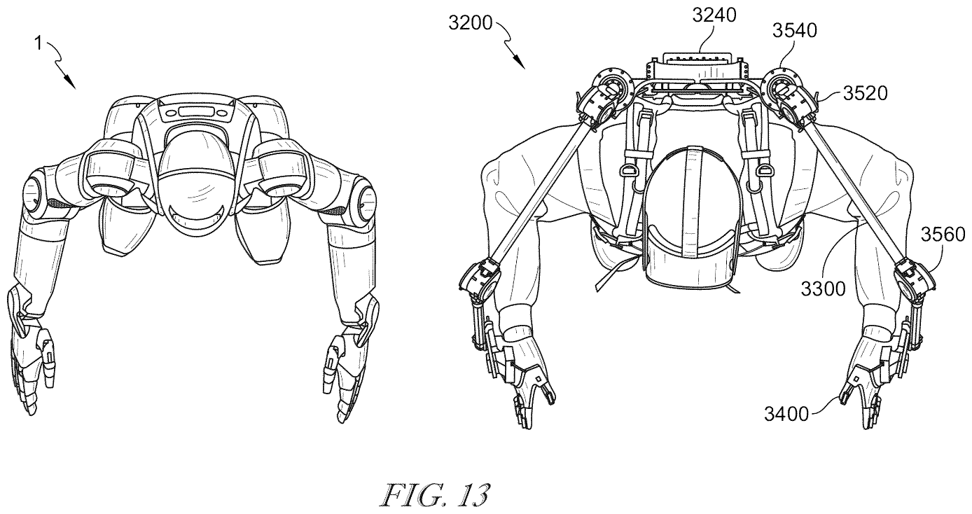

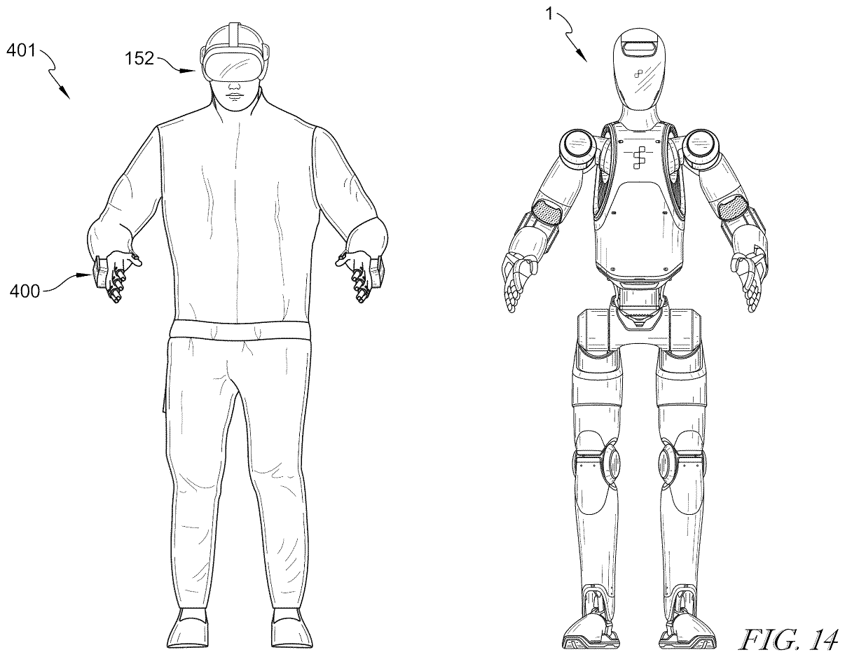

As best shown in FIGS. 11-13, the mobile data collection apparatus 3200 includes (i) a base mount 3240 (also referred to herein as the base frame 3240), (ii) left and right articulated arm linkages 3300 (also referred to herein as articulated arms 3300, actuated pilot arms 3300, or arm linkages 3300) pivotably attached to the base mount 3240, (iii) a wrist assembly 3370 coupled to each articulated arm linkage 3300, (iv) a glove 3400 coupled to the wrist assembly 3370 via a glove mount 3394, and (v) an apparatus electronics assembly 3201. The apparatus electronics assembly 3201 includes a piloting control system 3202, data storage 3204, a battery 3206 (also referred to herein as the onboard battery 3206), a plurality of sensors 3208, and other circuitry 3209. The mobile data collection apparatus 3200 is configured to be worn by an operator to perform data collection tasks. The operator wears the mobile data collection apparatus 3200 on the back and secures it in position using the adjustable harness 3270. The operator also wears the gloves 3400 on each hand to capture fine motor movements of the fingers and thumbs. The articulated arm linkages 3300 are configured to move with the arms of the operator wearing the mobile data collection apparatus 3200 as the operator performs data collection tasks, where a plurality of sensors 3208 capture the position, orientation, and/or pitch of the operator's wrists and hands.

The sensors 3208 coupled to the mobile data collection apparatus 3200 include joint encoders 3211, 3212, 3213, IMUs 3220 and 3224, and hand sensors 3410. The joint encoders 3211, 3212, 3213 are fixed to respective rigid frame links 3310, 3311, 3312 of the articulated arm linkage 3300 to measure the rotational and positional movement of each rigid frame link. A torso IMU 3224 may be coupled to the base mount 3240 and wrist IMUs 3220 may be coupled to the glove mount 3394, or optionally the glove 3400, to provide information regarding the pitch and orientation of the operator's wrist. The gloves 3400 provide additional positional information for the fingers and thumbs of the operator. The pilot movement data is collected by the piloting control system 3202 as the operator performs tasks. The collected pilot movement data is processed by the piloting control system 3202 and/or computer 3110 to provide robot control data to the humanoid robot 1 via the network 2999A-X to be processed by the WBC 1550 of the humanoid robot 1. The WBC 1550 utilizes the robot control data to control the actuators 1.2.4 of the humanoid robot 1 to replicate the operator's movements and sensor data from the humanoid robot 1 is collected as training data as the humanoid robot 1 performs the task.

In accordance with one aspect, the mobile data collection apparatus 3200 addresses the technical objective of capturing an operator pose during ambulation through unconstrained environments by providing an integrated wearable structure. The mobile data collection apparatus 3200 comprises a carrier configured to be worn on a back of the operator, the adjustable harness 3270 securing the carrier to the operator, the articulated arm linkage 3300 mechanically supported by the carrier, the torso IMU 3224 mounted to the carrier, the wrist IMU 3220 mounted to the articulated arm linkage 3300, the piloting control system 3202, and the onboard battery 3206. The articulated arm linkage 3300 includes a plurality of articulated joints, each joint instrumented with a joint encoder selected from the joint encoders 3211, 3212, 3213, the joint encoders being configured to output rotational angle measurements. The piloting control system 3202 is configured to receive the rotational angle measurements, the torso IMU output, and the wrist IMU output, and to compute the operator pose by combining the received signals into a kinematic chain referenced to the torso IMU 3224. The onboard battery 3206 supplies electrical power to the apparatus 3200 for portable operation supported solely by power carried on the operator. In some embodiments, the joint encoders 3211, 3212, 3213 comprise optical encoders.

The articulated arm linkage 3300 terminates at the glove mount 3394 disposed at a distal end of the linkage, to which the glove 3400 is mounted, the glove 3400 including a plurality of hand sensors 3410 configured to output finger-position data. The wrist IMU 3220 is positioned proximate the glove mount 3394, and the piloting control system 3202 is configured to reference each of the wrist IMU output and the hand sensor outputs into a coordinate frame defined by the torso IMU 3224, such that finger pose, wrist pose, and arm-segment pose are expressed in a common reference frame anchored at the operator's torso. The torso-anchored reference frame causes finger and wrist measurements to be expressed relative to a single proximal reference whose orientation is independently observed by the torso IMU 3224, by which configuration the kinematic chain from torso to fingertip resolves to a single coherent pose using the operator-borne sensors. In one embodiment, the hand sensor 3410 outputs are time-aligned with the joint encoder and wrist IMU outputs at the piloting control system 3202, and a sensor-fusion algorithm (for example, a Kalman filter or a complementary filter) produces a unified operator pose stream. The mobile data collection apparatus 3200 is free of an external optical motion-capture infrastructure and does not require ceiling-mounted cameras, line-of-sight markers on the operator, or a controlled capture volume, and the mobile data collection apparatus 3200 is devoid of an off-board tracking station for resolving the operator pose.

The mobile data collection apparatus 3200 and the humanoid robot 1 share corresponding sensor parts, such that the torso IMU 3224, the wrist IMU 3220, and one or more IMUs of the humanoid robot 1 comprise a common IMU part (for example, a Bosch BMI088 IMU or an InvenSense ICM-42688 IMU), and the joint encoders 3211, 3212, 3213 of the apparatus 3200 and one or more joint encoders of the humanoid robot 1 share a common encoder line count. The shared part selection causes operator-side and robot-side measurements to exhibit corresponding noise spectra, latency, sensitivity, and quantization, such that a sensor signal from the apparatus 3200 and a corresponding sensor signal from the humanoid robot 1 occupy a common statistical distribution. The matching arises because the two sets of measurements are sourced from the same underlying part processed by the same firmware, by which a learned or analytical mapping from operator pose to humanoid robot 1 control input is computed on input that is statistically aligned with the input that the same mapping receives during deployment on the humanoid robot 1. As a result, a control or learning model trained on data captured by the apparatus 3200 is applied on the humanoid robot 1 with input statistics matching those seen during training. The shared part selection operates jointly across the apparatus 3200 and the humanoid robot 1; the consistency arises from the deliberate selection of corresponding parts on both platforms.

In a further aspect, a method of collecting humanoid teleoperation training data comprises donning the mobile data collection apparatus 3200 on a back of an operator and securing the apparatus 3200 to the operator with the adjustable harness 3270; receiving, at the piloting control system 3202, rotational angle measurements from the joint encoders 3211, 3212, 3213, a torso IMU output from the torso IMU 3224, a wrist IMU output from the wrist IMU 3220, and finger-position data from the hand sensors 3410; expressing the wrist IMU output and the finger-position data in a coordinate frame defined by the torso IMU output to produce a unified operator pose stream; and storing the unified operator pose stream as a training sample. In some embodiments, the storing step is performed concurrently with locomotion of the operator through an unconstrained environment, with electrical power supplied to the apparatus 3200 from the onboard battery 3206 throughout. In one embodiment, the expressing step applies a complementary filter or a Kalman filter to fuse encoder, inertial, and finger-sensor data into a single pose vector per sample, sampled at a rate sufficient for downstream policy training.

i. Sensors of the Apparatus

The mobile data collection apparatus 3200 can include a plurality of sensors 3208 and other circuitry 3209 for signal conditioning and data processing. The plurality of sensors 3208 include joint encoders 3211, 3212, 3213 (e.g., actuator encoders), wrist inertial measurement units (IMUs) 3220 and a torso IMU 3224, and hand sensors 3410. The mobile data collection apparatus 3200 may also include additional sensors (e.g., IMU, GPS, etc.) to capture other sensor data while the operator is performing data collection tasks while wearing the apparatus 3200. The mobile data collection apparatus 3200 is designed to collect sensor data and communicate the position of one or more of the operator's wrists relative to their torso through the kinematic chain. The IMUs 3220, 3224 may include one or more accelerometers, gyroscopes, and one or more magnetometers to provide complete 9-axis motion sensing.

The apparatus 3200 may include a comprehensive array of sensors 3208 providing multi-modal data capture capabilities for robust tracking. In addition to the joint encoders 3211, 3212, 3213 (e.g., optical encoders with resolutions of 12-16 bits or magnetic encoders with absolute position capabilities) located at the joints of the articulated arm linkage 3300 and hand sensors 3410 in the gloves 3400, the apparatus 3200 may include accelerometers with ranges of ±2 g to ±16 g, gyroscopes with ranges of ±250 to ±2000 degrees/second, and inertial measurement units (IMUs) combining both sensor types with additional magnetometers.

The torso IMU 3224 may be located on base mount 3240 to measure the relative position of the operator's torso and may provide or establish a distance from the ground or a support surface using barometric pressure sensors with altitude resolutions of 10-50 cm. For example, the torso IMU 3224 may be coupled separately or included in electronics and other circuitry 3209 coupled with the piloting control system 3202 on the base mount 3240, maintaining thermal isolation from heat-generating components to prevent temperature-induced measurement drift. Additional wrist IMUs 3220 may be positioned at a distal portion of the articulated arm linkage 3300 (e.g., the glove mount 3394 and/or glove 3400) to measure the relative position of the operator's wrist with 6-DOF tracking capabilities. Further, the torso IMU 3224 may be used to determine the orientation of the operator's torso with accuracies better than 1 degree and establish a reference point for the wrist IMUs 3220 through coordinate transformation matrices. In some cases, the sensor data collected from wrist IMUs 3220 positioned at the wrist of the operator from the apparatus 3200 for wrist pose estimation might rely on the change in position and orientation as determined from the wrist IMUs 3220 and/or other sensors 3208 used for minimizing drift through zero-velocity updates and magnetic heading correction, which is then fused with the kinematic chain data derived from the joint encoders 3211, 3212, 3213 at the joints 3313, 3314, 3315 of the articulated arm linkage 3300 using extended Kalman filtering or complementary filtering approaches.

Advantageously, these sensors 3208 are an integral part of the structure of the apparatus 3200 and are not placed manually by the operator or other operators each time the device is used, ensuring consistent sensor placement within 1-2 mm across sessions. This fixed placement methodology eliminates the variability that can arise due to the misplacement of sensors 3208 by the operator and reduces substantial changes in relative sensor locations between different operators or different sessions, thereby aiding in the consistency and reliability of the collected data with repeatability better than 95%. The apparatus 3200 does not require manual operator-applied sensor placement at the start of a session, and the sensor placement is free of session-to-session repositioning by the operator.

Moreover, in some embodiments, the sensors 3208 utilized in the apparatus 3200 may employ the same or similar underlying sensor technology as the sensor technology used in the corresponding parts of the humanoid robot 1, maintaining measurement consistency across platforms for simplified data processing. This could include, for example, using specific types of optical encoders (e.g., joint encoders 3211, 3212, 3213) with identical line counts and interpolation factors or the exact same model of IMU chip such as the Bosch BMI088 or InvenSense ICM-42688 in both the apparatus 3200 and the humanoid robot 1. The use of such similar or identical sensor technology provides a technical advantage by reducing or eliminating the need to perform complex translation, manipulation, or alteration of the sensor data collected from the apparatus 3200, reducing computational overhead by 50-70%. As a result, this data can be more directly and meaningfully used to control the humanoid robot 1 or to serve as high-quality training data with minimal preprocessing requirements. Additionally, using the same or similar sensor technology can help to mitigate problems that are commonly associated with comparing data from sensors 3208 that exhibit different drift characteristics (typically 0.1-1 degree/hour for gyroscopes), noise profiles (with noise densities of 0.01-0.1 degrees/second/√Hz), or sensitivities to various environmental factors such as temperature coefficients of 0.01-0.05%/°C. In particular, when subjecting two significantly different sensor technologies (e.g., an IMU vs. an optical encoder, or two IMU models from different manufacturers with different Allan variance characteristics) to the same environmental noise sources (e.g., electromagnetic interference (EMI) noise commonly found on a factory floor with field strengths of 1-10 V/m, or mechanical vibrations at frequencies of 10-1000 Hz), the resulting drift or noise patterns associated with these different sensor technologies might be sufficiently different that combining or comparing their data becomes a significant challenge, potentially rendering the collected human data less usable for direct robot control or for imitation learning without extensive calibration and compensation. Thus, the disclosed apparatus 3200, by using the same sensor technology and sometimes even the exact same sensor components as the humanoid robot 1 for corresponding measurements (like joint angles), aims to overcome some of these long-standing challenges in cross-platform data consistency.

In addition to these specifically mentioned sensors 3208, the mobile data collection apparatus 3200 may incorporate a variety of additional sensors 3208, or it may obtain data from other external sensors (such as those found in a VR system), to enhance the quality of data collection and to improve the accuracy of training or control with sensor fusion improving overall system accuracy by 20-40%. For clarity, These additional sensors 3208 may be grouped by category:
Motion and Position: This category includes accelerometers with measurement ranges from ±2 g to ±200 g and bandwidths up to 5 kHz, gyroscopes with drift rates better than 10 degrees/hour, and magnetometers with resolutions of 1-10 nT (which are often combined within IMU packages 3220, 3224), flex sensors for measuring bending with resistance changes of 10-100% over their range, GPS modules for absolute outdoor positioning with accuracies of 1-10 meters, 3D cameras or depth sensors for tracking limb position relative to the body or the environment with depth resolutions of 1-10 mm, optical encoders (such as joint encoders 3211, 3212, 3213) with resolutions up to 20 bits, tilt sensors with accuracies of 0.01-0.1 degrees, inclinometers with measurement ranges of #180 degrees, absolute or relative position sensors with resolutions down to nanometers, velocity sensors measuring speeds from 0.01-100 m/s, displacement sensors with ranges from micrometers to meters, vibration sensors detecting frequencies from 0.1 Hz to 10 kHz, angular rate sensors, linear accelerometers, rotary encoders, potentiometers for measuring rotation angle with linearities better than 0.1%, vision-based tracking systems that use markers placed on the operator or apparatus 3200 viewed by external cameras achieving sub-millimeter tracking accuracy, or Ultra-Wideband (UWB) tags for achieving precise relative positioning with accuracies of 10-30 cm.
Biometric: This category includes Electromyography (EMG) sensors for measuring muscle electrical activity with signal amplitudes of 50 μV to 30 mV, which can be used for control input or for fatigue monitoring, and eye-tracking sensors with gaze accuracies of 0.5-1 degree, which may be integrated into the apparatus 3200. Other biometric sensors such as Electroencephalography (EEG) for brain activity monitoring with 8-256 channels, Galvanic Skin Response (GSR) for stress levels detecting conductance changes of 0.01-100 μS, or heart rate monitors measuring 30-250 BPM could also be integrated into or interfaced with the system. Skin temperature sensors with accuracies of 0.1-0.5 °C may also be included to monitor the physiological state of the operator.
Environmental: This category includes acoustic sensors such as microphones with frequency responses from 20 Hz to 20 kHz, which can be used for voice commands or for ambient noise awareness, proximity sensors for detecting nearby objects at ranges of 1 mm to 10 m, temperature sensors with ranges from −40 °C to ±125 °C, barometric pressure sensors with resolutions of 0.1 Pa, humidity sensors measuring 0-100% RH, and ambient light sensors detecting 0.01-100,000 lux.
Force and Pressure: This category includes force-sensitive resistors (FSRs) with force ranges of 0.1-100N, pressure sensors for measuring applied pressure over an area from 1-1000 kPa, piezoelectric sensors that generate voltages of 1-1000V under stress, piezoresistive sensors that change resistance by 1-10% under stress, strain gauges for measuring deformation with gauge factors of 2-200, load cells for measuring force, torque sensors (which include types like strain gauge-based with accuracies of 0.1-1%, piezoresistive with response times under 1 ms, magnetoelastic with non-contact measurement, capacitive with resolutions of 0.01%, fiber-optic with immunity to EMI, and rotary transformers for continuous rotation), tactile sensor arrays that provide distributed pressure information similar to artificial skin with spatial resolutions of 1-5 mm, shear force sensors measuring tangential forces of 0.01-100N, bending moment sensors, compression sensors, tension sensors, and impact sensors detecting accelerations up to 10,000 g.
Other: A wide variety of other sensor types might be included based on specific application needs. These can include photodiodes for light detection with spectral responses from UV to IR, Hall effect sensors for magnetic field detection with sensitivities of 1-100 mV/mT, capacitive sensors for proximity or touch detection with sensing distances of 0-50 mm, inductive sensors for metal detection or positioning with ranges of 0.5-80 mm, ultrasonic sensors for distance measurement with ranges of 2 cm to 10 m, thermal sensors for non-contact temperature measurement from −70 °C to ±380 °C, radar sensors operating at 24-77 GHz, or LiDAR sensors with range resolutions of 1-5 cm, though the latter are less common on a apparatus 3200 compared to their use on robots.

It should be understood that other similar sensors or sensor technologies, including emerging sensor types not listed here such as quantum sensors or neuromorphic sensors, may be utilized by the mobile data collection apparatus 3200. This includes sensor types or specific sensor technologies that might be disclosed in other sections of this application or are otherwise known in the art. Sensor fusion strategies that are specific to the apparatus 3200, employing algorithms such as complementary filters with time constants of 0.5-5 seconds, Kalman filters (including variants like the EKF with 15-30 state variables or UKF with sigma point selections), or machine learning-based approaches using neural networks with 103 to 106 parameters, may be implemented within the piloting control system 3202 or the computer 3110. The goal of these strategies is to combine data from multiple sensors 3208 in an effective manner, aiming to achieve more accurate and robust estimates of the pose, motion, and intent of the operator with position accuracies better than 5 mm and orientation accuracies better than 2 degrees.

In addition to the sensors already mentioned, the mobile data collection apparatus 3200 may incorporate additional sensors to enhance data collection and improve training accuracy. These may include:
Electromyography (EMG) Sensors (e.g., Delsys Trigno Wireless EMG System, Advancer Technologies MyoWare Muscle Sensor, Otto Bock MyoBock System)
Force-Sensitive Resistors (FSR) or Pressure Sensors (e.g., Interlink Electronics FSR 400 Series, Tekscan FlexiForce Sensors, Honeywell FSS-SMT Series Force Sensors)
Haptic Feedback Devices (e.g., Precision Microdrives Vibration Motors, Tactile Labs Haptics Actuators, Ultrahaptics (Ultraleap))
Flex Sensors (e.g., Spectra Symbol Flex Sensor, Adafruit Flex Sensor, Flexpoint Bend Sensors)
Acoustic Sensors (e.g., Knowles MEMS Microphones (e.g., SPH0645LM4H-B), Audio Analytic's ai3 Acoustic Sensor, MaxBotix MB 1000 LV-MaxSonar-EZ1)
Eye-Tracking Sensors (e.g., Tobii Eye Trackers, Pupil Labs Eye Tracking Headsets, SR Research EyeLink Systems)
Proximity Sensors (e.g., Sharp GP2Y0A21YKOF Infrared Proximity Sensor, STMicroelectronics VL53LOX ToF Sensor, Pepperl+Fuchs Ultrasonic Proximity Sensors)
GPS Modules (e.g., u-blox NEO-M8N GPS Module, Adafruit Ultimate GPS Breakout v3, SparkFun GPS Dead Reckoning Breakout (NEO-M8U))
Temperature Sensors (e.g., Maxim Integrated DS18B20, Texas Instruments LM35, Sensirion STS3x Series)
3D Cameras or Depth Sensors (e.g., Intel RealSense Depth Cameras (D435, D455), Microsoft Azure Kinect DK, Structure Sensor by Occipital)
   ii. Piloting Control System

The piloting control system 3202 is coupled to data storage 3204, a battery 3206, other circuitry 3209 including power management and signal conditioning, multiple sensors 3208 including joint encoders 3211, 3212, 3213, hand sensors 3410 detecting finger positions, and IMUs 3220, 3224 of the mobile data collection apparatus 3200. The piloting control system 3202 includes a processor, a memory, and instructions stored in the memory configured to be executed on the processor, where the instructions include applications to facilitate the collection of sensor data using the mobile data collection apparatus 3200 at sampling rates of 100-10,000 Hz. Additionally, the piloting control system 3202 may be in data communication with the humanoid robot 1, as well as the computer 3110, the data storage database 2900, the clutch 3140, and/or the optional display 3150 via a network 2999A-X supporting bandwidths of 1-1000 Mbps.

The piloting control system 3202 may be attached directly to the main support portion 3242 in a mounting region that is designed to receive electronics with appropriate thermal dissipation capabilities through heat sinks or thermally conductive mounting interfaces. In some embodiments, both the battery 3206 and the piloting control system 3202 are carried by the base mount 3240. In other embodiments, the piloting control system 3202 may be remotely located from the base mount 3240, and the base mount 3240 may be coupled to a power source that is also remotely located from the portable data collection apparatus. Said electronics may include sensors operating at various sampling rates from 10 Hz to 10 kHz, communication interfaces supporting protocols such as USB 3.0, Ethernet, Wi-Fi 6, and Bluetooth 5.0, processors including ARM Cortex-A series or Intel Atom processors, data storage devices using solid-state drives or eMMC storage, or any other electronic component that facilitates obtaining and transmitting sensor data from the mobile data collection apparatus 3200 to the computer 3110, the data storage 3204, and/or the humanoid robot 1 with end-to-end latencies under 20 ms. In some embodiments, the battery 3206 or power source for the piloting control system 3202 may reside with the piloting control system 3202 in a housing or be coupled separately to the main support portion 3242 and electrically connected to the piloting control system 3202 through power cables rated for 5-50 W. In some embodiments, the main support portion 3242 is configured to support at least the battery 3206 and/or piloting control system 3202 with vibration isolation providing 20-40 dB attenuation at frequencies that could affect sensor measurements.

The piloting control system 3202 may also be configured to integrate various software applications or functionalities (e.g., running on embedded Linux or real-time operating systems). These applications may include a sensor tracking application operating at 500-1000 Hz update rates, which may incorporate a drift correction algorithm to enhance tracking accuracy to sub-degree levels. For example, the sensor tracking application is tasked with the real-time acquisition of data from the array of sensors 3208 that are distributed across the apparatus 3200, managing data streams totaling 10-100 MB/s. The sensor tracking application communicates this collected sensor data to the computer 3110 for further processing through TCP/IP or UDP protocols, or it may process the data locally within the piloting control system 3202 using edge computing capabilities. The computer 3110 and/or the on-board processors that are located within the piloting control system 3202 then operate to refine the raw sensor data through filtering, calibration, and fusion algorithms. This refined sensor data can then be utilized, in connection with robot control data received from the humanoid robot 1, to dynamically adjust the data that is provided to generate the robot control data that is sent to the humanoid robot 1 with control loop frequencies of 100-1000 Hz.

Advanced algorithms, including various machine learning models such as recurrent neural networks with 104 to 106 parameters, can be employed to analyze the various data streams, such as the raw sensor data sampled at native rates, the refined sensor data after processing, and/or the received robot control data, in order to identify patterns with recognition accuracies above 95%, perform sensor fusion reducing uncertainty by 30-50%, correct for sensor drift maintaining errors below 1 degree/hour, and optimize control strategies improving task success rates by 20-40%. This comprehensive feedback loop, which incorporates data from the operator, the apparatus 3200, and the humanoid robot 1 with round-trip latencies under 50 ms, not only improves the performance of the apparatus 3200 in real-time but also contributes to the iterative development of more sophisticated control algorithms (or AI models) that can be tailored to operator-specific training regimens or particular task requirements through transfer learning and fine-tuning approaches. This overall system architecture facilitates an adaptive training or teleoperation environment where the mobile data collection apparatus 3200 can continuously adjust its behavior based on accumulated interaction data from the operator and feedback from the humanoid robot 1, thereby maximizing both task efficacy achieving success rates above 90% and the immersion of the operator with presence ratings above 4 on a 5-point scale.

iii. Alternative Wearable Training Apparatus

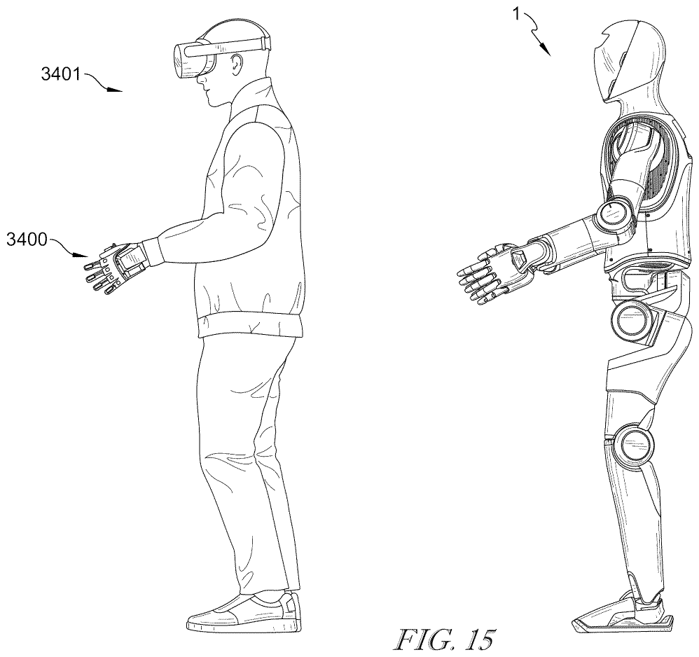

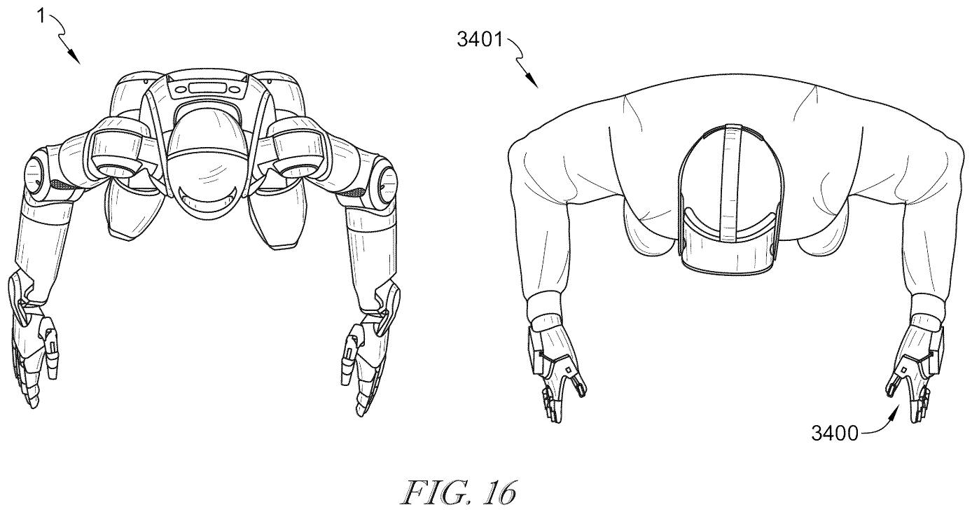

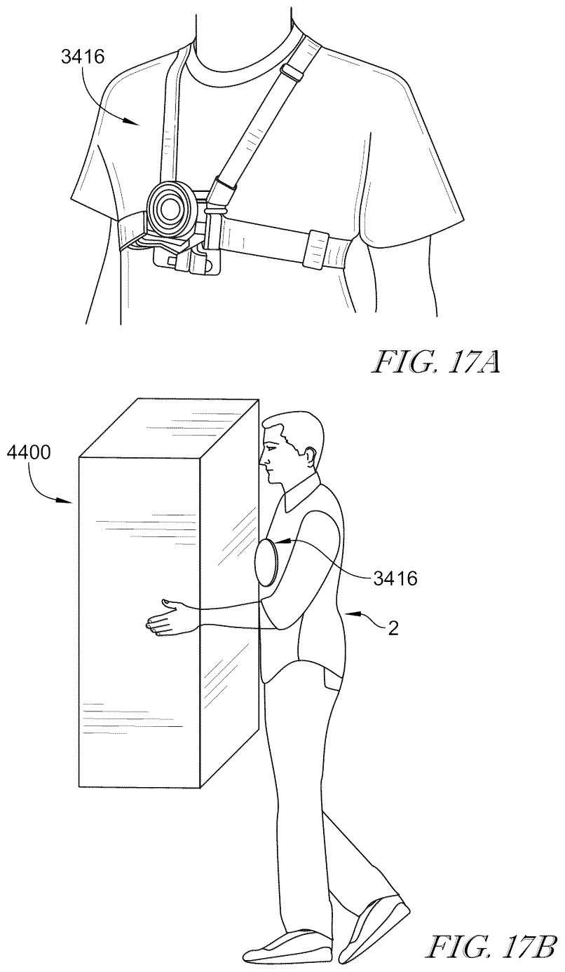

FIGS. 14-16, 17A, and 17B illustrate another example embodiment of an alternative wearable training apparatus 3401 used in conjunction with the humanoid robot 1 of FIG. 9. Referring to these figures conceptually, the alternative wearable training apparatus 3401 includes a wearable magnetic field-generating apparatus 3416, glove components 3400 (for hand/finger tracking) and a VR HMD 3152 (serving as the optional display 3150 and possibly head tracking source). This alternative wearable training apparatus 3401 configuration may not include the articulated arm framework (e.g., articulated arm linkage 3300) described in reference to the mobile data collection apparatus 3200. As a result, to track the pose (position and orientation) of the operator's hands or limbs in space relative to the torso, the alternative wearable training apparatus 3401 might rely on the wearable magnetic field-generating apparatus 3416. Alternatively or additionally, the alternative wearable training apparatus 3401 could include one or more IMU sensors (similar to wrist IMUs 3220) disposed directly on each limb (e.g., wrist, upper arm) of the operator, relying on sensor fusion with other data sources (like VIO from the VR HMD 3152 cameras) for position tracking.

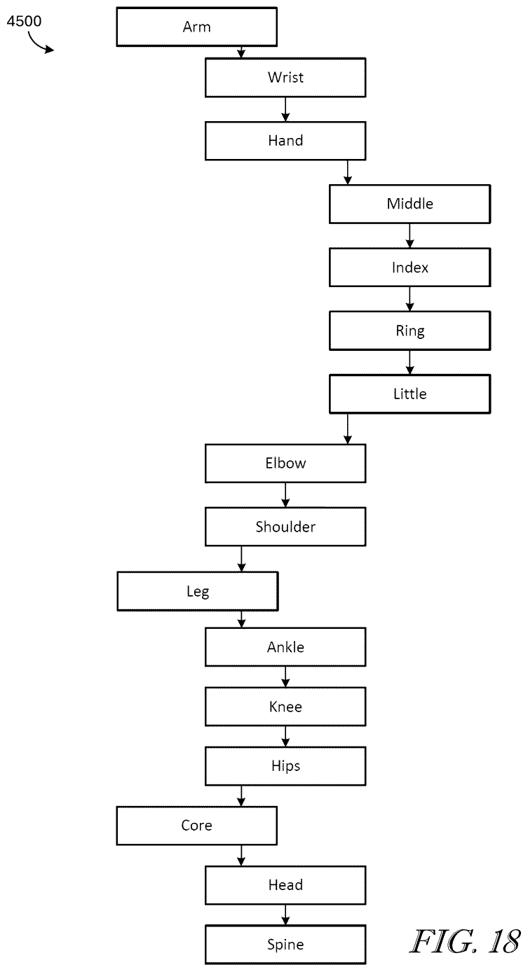

The wearable magnetic field-generating apparatus 3416, if used, is designed to be worn or otherwise attached to the operator, for instance, mounted on their chest or integrated into the VR HMD 3152. The wearable magnetic field-generating apparatus 3416 itself may include one or more cameras or other sensors (e.g., IMUs) in addition to its magnetic field components. The wearable magnetic field-generating apparatus 3416, possibly using its cameras or other integrated sensors, can be configured to contribute to tracking the motion of the operator. For example, cameras on the wearable magnetic field-generating apparatus 3416 might track the operator's hand movements or body posture in three-dimensional (3D) space to help generate the sensor data. The wearable magnetic field-generating apparatus 3416 may further include a magnetic field component, such as one or more electromagnetic field (EMF) source coils, designed to create a localized, time-varying magnetic field 4400 in the space around the operator. This magnetic field 4400 can then be used to track the movement of the operator, such as the 6-DOF pose (position and orientation) of the operator's wrists relative to the source on the wearable magnetic field-generating apparatus 3416. The generated magnetic field 4400 is conceptually depicted as a volume, perhaps a box, in FIG. 17B. As a merely illustrative example, the effective tracking volume of the magnetic field 4400 might be roughly a 6-foot box in front of the operator, although the actual range and shape depend heavily on the source design and sensor sensitivity.

The generated magnetic field 4400 can be detected or received by one or more magnetic sensors. These sensors might be integrated into the wearable magnetic field-generating apparatus 3416 itself, worn by the operator (e.g., integrated into the glove components 3400 or wristbands), and/or placed as stationary tracking devices in the surrounding environment near the wearable magnetic field-generating apparatus 3416. The signals from these magnetic sensors can be processed (e.g., by the computer 3110 or a processor within the wearable magnetic field-generating apparatus 3416) to calculate the position and rotation (pose) of the operator's tracked appendages (like wrists) relative to the known position and orientation of the EMF source on the wearable magnetic field-generating apparatus 3416 in real space. Advantageously, the disclosed wearable magnetic field-generating apparatus 3416 concept can be used to track various movements of the operator (e.g., aiming for 6 degrees of movement tracking for the operator's wrists, hands, neck, torso, back, arms, legs, and/or other body parts, depending on sensor placement and system complexity), thereby providing robust sensor data for mapping to robot control data. The sensor data collected and processed based on sensing the emitted magnetic field 4400 is highly accurate, particularly for orientation, and might resolve some problems of position drift and latency that can be inherent limitations of purely inertial-based (IMU-only) sensor data collection techniques for tracking limbs over extended periods without correction.

iv. Alternative Wearable Training Apparatus with Chest-Mounted Magnetic-Field Source

In accordance with another aspect, the alternative wearable training apparatus 3401 addresses the technical objective of capturing operator wrist and hand pose by means of body-worn magnetic-field localization. The alternative wearable training apparatus 3401 comprises a chest-mountable form of the wearable magnetic field-generating apparatus 3416 configured to be worn on a chest of the operator and to emit a localized magnetic field 4400 within a working volume that contains the operator's arms and hands; a plurality of magnetic-field sensors disposed on at least one of the operator's wrist and the operator's hand and configured to output magnetic-field measurements responsive to position and orientation of the magnetic-field sensors within the localized magnetic field 4400; one or more inertial measurement units (IMUs) co-located with the magnetic-field sensors; and a sensor-fusion module configured to combine the magnetic-field measurements and the IMU outputs to compute a pose of each magnetic-field sensor relative to the wearable magnetic field-generating apparatus 3416. The sensor-fusion module of the alternative wearable training apparatus 3401 comprises instructions stored in a memory and executed on a processor of the wearable magnetic field-generating apparatus 3416 or of the computer 3110, where the instructions implement an estimation filter that maintains a state vector representing position and orientation of each tracked sensor and updates the state vector at each measurement step.

The sensor-fusion module is configured to apply a quaternion-based orientation update and an inverse-cube-law-based position estimate from the magnetic-field measurements and to integrate IMU angular-rate and acceleration data over short timescales to produce a drift-corrected pose estimate. The wearable magnetic field-generating apparatus 3416 thereby serves as the proximal anchor of an operator-borne hand-tracking coordinate system, and the alternative wearable training apparatus 3401 reports finger and wrist pose relative to the operator's torso through the magnetic-field measurements and the co-located inertial data. In some embodiments, the wearable magnetic field-generating apparatus 3416 is integrated into a chest-worn vest, and the magnetic-field sensors are integrated into a glove worn on the operator's hand. The alternative wearable training apparatus 3401 is free of an external static-base magnetic-field source, and the alternative wearable training apparatus 3401 does not require an environment-fixed transmitter to anchor the tracking volume during ambulation by the operator.

In some embodiments, the mobile data collection apparatus 3200 and the alternative wearable training apparatus 3401 serve as interchangeable or concurrent input sources to a single retargeting and training pipeline, such that the operator pose used by downstream retargeting is acquired by the articulated-arm-encoder modality of the apparatus 3200, by the magnetic-field-plus-IMU modality of the apparatus 3401, or by both modalities concurrently. The piloting control system 3202 is configured to accept inputs from either modality and to express the operator pose in a common reference frame using either the torso IMU 3224 (when the apparatus 3200 is the source) or the wearable magnetic field-generating apparatus 3416 (when the apparatus 3401 is the source) as a torso-anchored origin. When both modalities are active concurrently, the piloting control system 3202 cross-references the modalities to detect drift in either modality and to correct one modality using the other, by which encoder-derived pose serves as a constraint on magnetic-derived pose during periods when the articulated arm linkage 3300 is in mechanical engagement with the operator, and magnetic-derived pose serves as a constraint on encoder-derived pose during periods when joint-encoder readings are subject to mechanical compliance or backlash. The same downstream retargeting components consume captures from either apparatus, and the training pipeline accepts samples from either source as members of a common training corpus.

In one embodiment, the magnetic-field sensors are co-located with the wrist IMU 3220 and with the hand sensors 3410, such that a single physical sensor housing on the operator's hand carries an inertial sensor and a magnetic-field sensor whose outputs are time-aligned at a sensor-side controller and reported to the piloting control system 3202 as a unified hand-pose packet. In another embodiment, the magnetic-field sensors are integrated into independent body-worn modules positioned at the operator's wrists, palms, and fingertips, and a wireless link reports the magnetic-field measurements and inertial data to the piloting control system 3202. In a further embodiment, the wearable magnetic field-generating apparatus 3416 is integrated into a harness-mounted enclosure on the adjustable harness 3270 rather than a chest-worn vest, providing an alternative source-placement for operators whose tasks favor a back-side source location [SUPPORT GAP: alternative source placement (harness-integrated)-confirm support against original specification].

The magnetic sensors used for detecting the magnetic field 4400 may include: (i) sensors directly measuring magnetic flux density or magnetic field strength vector components, (ii) one or more Hall effect sensors, (iii) IMUs that include magnetometers (using the generated magnetic field 4400 instead of or in addition to Earth's magnetic field), (iv) inductive pickup coils, (v) or any other suitable type of magnetic sensor or combination thereof capable of detecting the characteristics of the generated magnetic field 4400. For tracking dynamic movements, such sensors preferably operate at a sampling frequency significantly higher than the desired tracking update rate, for example, at a frequency of at least six times the target sample frequency, more preferably at least eight times, and most preferably at least 10 times, to capture the field variations accurately. Each sensor unit might include a magnetometer component (like a 3-axis magnetometer) that can detect the EMF signals originating from the transmission coils (EMF source) on the wearable magnetic field-generating apparatus 3416, but preferably comprises one or more sensor elements that can determine the amplitude and the direction of the EMF field components at the required speeds. A plurality of wires can optionally connect the magnetic sensors (e.g., on the wrists/glove components 3400) back to the wearable magnetic field-generating apparatus 3416 (for power and data transmission), and/or connect analog signals from the sensors to processing circuitry within the wearable magnetic field-generating apparatus 3416. The wearable magnetic field-generating apparatus 3416 can also include its own processor and memory for storing operating instructions, generating the driving signals for the source coils, and/or for analyzing the incoming signals received from the magnetic sensors. Alternatively, a wireless communication unit (e.g., Bluetooth, Wi-Fi) may provide a data communication channel from the sensors back to the wearable magnetic field-generating apparatus 3416 or directly to the computer 3110.

Using the wearable magnetic field-generating apparatus 3416, EMF signals (magnetic fields 4400) can be generated by the EMF source component and subsequently measured by the magnetic sensors. The EMF source can generate these signals at predetermined times (e.g., pulsed sequences from different coils) and/or continuously (e.g., AC fields at specific frequencies). The emitted EMF signals propagate through the space around the operator and are received by the magnetic sensors, through respective sensor coils or elements within the sensors. In some implementations, additional receiving magnetic sensors could be placed stationary throughout the immediate environment of the operator. These external sensors could also detect changes in the magnetic field 4400 pattern as the operator moves and performs actions, providing additional reference points to improve tracking accuracy or robustness, though this adds setup complexity.

The magnetic field tracking process might involve an initial step where the characteristics of the magnetic field 4400 generated by the EMF source on the wearable magnetic field-generating apparatus 3416 are mapped or calibrated within the expected working environment where the operator will be moving and performing actions. This mapping or calibration could include measuring the field strength and direction at various known distances and angles from the EMF source on the wearable magnetic field-generating apparatus 3416. Baseline characteristics of the emitted magnetic field 4400, such as its strength profile, spatial variation pattern, and/or decay rate with distance, can be identified and modeled. This model is necessary to provide accurate pose estimation information based on the sensor readings. For pose estimation, the position of the operator's tracked body part (e.g., wrist with a sensor) relative to the source can be triangulated or determined based on the measured intensity (and direction) of the magnetic field 4400 detected by one or more magnetic sensors whose position relative to the body part is known (e.g., sensors in glove components 3400 track the wrist). Signals generated by these magnetic sensors can advantageously be used to measure the intensity and orientation (vector components) of the magnetic field 4400 at the sensor's location. Differences in measured field strength or direction between multiple sensors, or comparison to the calibrated field map, can help determine the relative position and orientation of the tracked part (carrying the sensors) with respect to the field source (on the wearable magnetic field-generating apparatus 3416). Moreover, if the sensors can detect precisely when specific EMF signals are emitted (e.g., using timing information or coded signals), the time taken for the signal to propagate from the source to the sensors (though typically very short for magnetic fields) or phase differences in AC fields might be used by the processor (in the wearable magnetic field-generating apparatus 3416 or the computer 3110) to help calculate the distance and/or position of the operator or the operator's body parts relative to the source.

As the operator moves and performs actions, signals from the magnetic sensors are generated and processed continuously to track changes in the measured magnetic field 4400 strength and direction at each sensor location. One or more algorithms and/or machine learning models (trained on calibration data or during use) can be deployed, running at the edge (on the wearable magnetic field-generating apparatus 3416 or the computer 3110) or remotely, to determine the direction and speed of movement, as well as the current position and orientation, based on the observed changes in the detected magnetic field 4400 characteristics over time. Sometimes, this magnetic field tracking data can be effectively combined (fused) with signals from inertial sensors (IMUs also placed on the tracked body parts) to improve accuracy and robustness in movement tracking, with the magnetic system providing drift correction for the IMU position/heading and the IMU providing high-frequency motion details between magnetic updates. As the operator moves and performs actions, the positional and/or movement data representing the pose of the operator's tracked parts is continuously updated by this process.

The disclosed wearable magnetic field-generating apparatus 3416, combined with IMUs, can further be used specifically to identify the 6 degrees of freedom (position: x, y, z; orientation: yaw, pitch, roll) of different body parts of the operator, such as their wrists, relative to a reference frame (e.g., the operator's torso where the wearable magnetic field-generating apparatus 3416 might be mounted). The processing techniques described herein (field mapping, sensor reading, fusion, pose calculation) can be performed on edge computing resources (e.g., processor in the wearable magnetic field-generating apparatus 3416) or remotely, such as by the main computer 3110. When the EMF source on the wearable magnetic field-generating apparatus 3416 emits the magnetic field signals, both stationary magnetic sensors (if used) and magnetic sensors worn by the operator (e.g., on their wrists/hands/body, as part of the alternative wearable training apparatus 3401 components like glove components 3400) can generate sensor data, which is collected and further processed.

IMUs, for example, if included as part of the alternative wearable training apparatus 3401 system (e.g., in the glove components 3400 or on wristbands), can generate rotational data (angular velocity giving yaw, pitch, roll changes) and/or linear acceleration data. Meanwhile, the magnetic sensors (also worn, or stationary if used) provide information such as the position and orientation of the operator's body parts relative to the source of the magnetic field 4400. Using the sensor data from the magnetic sensors, the position component of the tracked body parts' pose can be determined based on the strength and direction measurements of the detected magnetic field 4400 relative to the calibrated field map or model. Any of the system's processing units (in the wearable magnetic field-generating apparatus 3416 or the computer 3110) can be used to triangulate or otherwise solve for the position by analyzing differences in the field strength/direction measured by multiple magnetic sensors, or the readings of one sensor against the field model. The sensor data from the IMUs (if present on the same body part) can be used primarily to calculate the orientation of the operator's body parts with high update rates. For example, angular velocity data (gyroscope readings) generated by the IMUs can be integrated over time to determine the angle of rotation about each axis (yaw, pitch, roll). Accelerometer data generated by the IMUs can be used to correct for potential drift in the orientation derived purely from angular velocity integration (especially pitch and roll relative to gravity) and can indicate the direction of gravity, assisting in establishing a stable reference frame.

One or more sensor fusion algorithms are typically implemented (e.g., variations of Kalman filtering or complementary filtering) to optimally combine the data streams from the multiple sensor types (magnetic sensors, IMUs, others like vision). Properly fusing or combining the data from these complementary sensors can result in more accurate and stable estimations of both position and orientation (full 6-DOF pose) than could be achieved using either sensor type alone. As an illustrative example of the algorithms that might be performed for orientation, the orientation of the operator's body parts can be determined using the angular velocity data from an IMU, often represented using mathematical constructs like quaternions to avoid gimbal lock issues. Gyroscope rates (angular velocity) from the IMU data can be converted to appropriate units (e.g., radians per second), then used to update the current orientation quaternion based on the measured angular velocity over the small time step (Δt) between measurements. The updated quaternion resulting from this integration typically needs to be normalized periodically to ensure it remains a valid unit quaternion representing rotation. An example equation for the quaternion itself (q) and a simple first-order integration update rule is conceptually shown below (note: actual implementations often use more sophisticated integration methods):

q=[q_{w},qₓ,q_{y},q_{z}]

$${q}_{new} = {q}_{old} + \frac{1}{2} {q}_{old} ⊗ ω Δ t$$

where q_{w} is the scalar part and qₓ, q_{y}, q_{z} are the vector parts of the quaternion, ⊗ denotes quaternion multiplication, w represents the angular velocity vector (represented as a pure quaternion [0, ωₓ, ω_{y}, qω_{z}]), and Δt represents the time interval between measurements.

As described above, the position component of the pose can be determined using the magnetic sensor data, employing triangulation or trilateration techniques relative to the source field 4400. For each magnetic sensor i, for example, the distance di might be estimated between the sensor and the source (or relative to known field lines) based on the measured strength Bi of the detected magnetic field 4400. An empirical model relating distance to field strength might be used, where k is a calibration constant that depends on the characteristics of the magnetic field source 4400 and the sensor, Bi is the measured field strength (e.g., magnitude), and di is the estimated distance from the sensor i to the source. (Note: Real field models are typically much more complex, involving field direction and inverse cube relationships or more complex patterns). Trilateration techniques (finding position based on distances to known points) or more general position estimation algorithms using the field vector and gradient might then be used to determine the position p=[pₓ, p_{y}, p_{z}] of the human operator 2's body part (where the sensor i is located) relative to the source. If multiple sensors or field measurements provide distance estimates di relative to known source locations si (or relative to a single source from multiple sensor locations), a system of equations might be derived conceptually, such as the following illustrative equation for trilateration with 3 sources/measurements:

∥p−sᵢ∥=dᵢ for i=1,2,3

where p is the unknown position and sᵢ are the known locations corresponding to the distance measurements dᵢ. Solving this system yields the estimated position p.

To represent the full 6 degrees of freedom (6-DOF) movement of the operator's body part, the estimated position vector p and the estimated orientation quaternion q can be combined, often within a state vector used in the estimation filter. The state (containing pose p, q and velocity, sensor biases, etc.) may be predicted forward in time using one or more models, such as a physics-based motion model (predicting how pose changes based on velocity) and/or using the high-frequency inertial measurements from the IMU data (integrating angular velocity and linear acceleration). Sometimes, this predicted state may also be corrected or otherwise updated based on new measurements collected by other sensors described herein, such as the magnetic sensors providing position or orientation information (which corrects for drift in the IMU-based prediction). One or more other tuning steps, calibration procedures, and/or filtering techniques may be employed to further ensure the accuracy, stability, and robustness of the final positional, directional (orientation), and/or overall 6-DOF pose determinations that are made using these disclosed magnetic-inertial tracking techniques.

### F. OPERATION OF THE DATA COLLECTION SYSTEM

A method for operating the humanoid robot data collection system 3010 to train the humanoid robot 1 and neural networks running on one or more humanoid robots 1 begins by linking the piloting control system 3202 of the mobile data collection apparatus 3200 to the humanoid robot 1 and/or the computer 3110 via the network 2999A-X. The operator then dons the mobile data collection apparatus 3200 on the back and secures it in position using the adjustable harness 3270. The operator may also wear the glove 3400 on each hand. The left and right portions of the articulated arm linkage 3300 may extend from the base mount 3240 to the glove 3400 and may be configured to move with the arms of the operator wearing the mobile data collection apparatus 3200 as the operator performs data collection tasks. In further embodiments, the linking step is performed over a wireless network connection between the piloting control system 3202 and the computer 3110 such that the operator may move freely within a working volume without tethering to a fixed network drop, and in still further embodiments, the linking step is performed over a wired network connection where reduced wireless interference is desired.

The combination of the data obtained from: (i) the actuator sensors (e.g., joint encoders 3211, 3212, 3213), (ii) the wrist inertial measurement units (IMUs) 3220, (iii) a torso IMU 3224, (iv) potentially additional body-worn IMUs (e.g., on upper arms, head), (v) physiological sensors integrated into the mobile data collection apparatus 3200 or display 3150 (e.g., eye-tracking for gaze/intent, EEG/EMG for cognitive state or refined motor commands), and (vi) any of the above sensors or other known sensors can be combined by the mobile data collection apparatus 3200 and considered sensor data. The actuator sensors are configured to measure the rotational and positional movement of each frame link, while left and right wrist IMUs 3220 are designed to provide information regarding the pitch and orientation of the wrist. Finally, the torso IMU 3224 is designed to provide ground truth for determining the position and orientation of said wrist. In some embodiments, the sensor data further includes per-finger flexion and abduction measurements obtained from the hand sensors 3410 of the glove 3400, such that the sensor data carries a unified representation of operator pose spanning torso, arms, wrists, and fingers within a single time-aligned data stream.

This sensor data is transmitted to the computer 3110 over the network 2999A-X. Upon receiving the data, the computer 3110 processes the sensor data and generates control data. The control data typically includes the six degrees of freedom (DOF) pose of each wrist of the operator relative to the operator's torso. Notably, the control data only includes the difference, or delta, between the last known location of each wrist and their current positions, rather than determining the absolute positions, though absolute poses might be simpler to manage robustly. However, in alternative embodiments, the humanoid robot data collection system 3010 may be designed to compute the absolute six DOF pose of the operator's wrists. Based on processing data from the sensors 3208, the computer 3110 generates control data at frequencies suitable for robotic control, typically between 10 Hz and 10 kHz. This control data is sent to the humanoid robot 1 via the network 2999A-X.

Specifically, the delta for the left wrist is determined using data from joint encoders 3211a, 3212a, 3213a, the wrist IMU 3220a, and the torso IMU 3224. Similarly, the delta for the right wrist is determined from joint encoders 3211b, 3212b, 3213b, the wrist IMU 3220b, and the torso IMU 3224. The IMUs 3220 and 3224 are primarily used to determine the orientation of the operator's wrists, not their positions. In cases where each IMU includes only a 3-axis gyroscope and a 3-axis accelerometer, the computer 3110 may implement a Mahony algorithm or a similar sensor fusion technique to combine these sensors into an orientation signal. The gyroscope signal is integrated to obtain wrist orientation, while the accelerometer provides a measurement of the gravity vector. The Mahony algorithm effectively removes any bias due to gyroscope signal integration along the pitch and roll axes. When the IMUs also include a magnetometer, an absolute heading signal is provided, and the computer 3110 uses a Madgwick algorithm or similar technique to determine an absolute orientation. The data from joint encoders 3211, 3212, 3213 is then fused with the absolute orientation and heading signals to correct drift in the IMU data, as the joint encoders 3211, 3212, 3213 are less susceptible to magnetic interference and exhibit less drift.

The operator wearing the mobile data collection apparatus 3200 can interact with the humanoid robot 1 by receiving primarily visual robot sensor data from the humanoid robot 1 in real-time and transmitting control data to the humanoid robot 1. Here, limited data is transmitted between the humanoid robot 1 and the piloting control system 3202 of the mobile data collection apparatus 3200, reducing the bandwidth and/or transmission speed required for real-time communication. In particular, complete and robust sensor data is sent from the mobile data collection apparatus 3200 to the computer 3110, and then complete and robust control data is sent to the humanoid robot 1, meanwhile a limited amount of robot data is sent from the humanoid robot 1 to the mobile data collection apparatus 3200 via the computer 3110. This limited data from the humanoid robot 1 may include: (i) video data from what the humanoid robot 1 is viewing, and/or (ii) data from the actuators (e.g., torque, current, position). This limited data can then be used by the mobile data collection apparatus 3200 and the display 3150 to: (i) display what the humanoid robot 1 is seeing, and (ii) provide a limited amount of information regarding what the humanoid robot 1 is feeling. For example, the limited amount of information regarding the feeling may be only transmitted once the torque or current of an actuator exceeds a threshold limit. This will inform the operator that is wearing the mobile data collection apparatus 3200 that the humanoid robot 1 has made contact with an object in the real world. In this situation, the operator can then use this information to proceed with caution while moving the humanoid robot 1

The humanoid robot data collection system 3010 may also operate in a closed loop mode. In this mode, the closed loop mode may be effective in a networked environment that is capable of high-speed data transmittal between the humanoid robot 1 and the piloting control system 3202 of the mobile data collection apparatus 3200. In particular, the mobile data collection apparatus 3200 controls the humanoid robot 1 using control data that is generated from the sensor data obtained from said mobile data collection apparatus 3200, and the humanoid robot 1 provides robot data to the mobile data collection apparatus 3200 to help control the actuators of said mobile data collection apparatus 3200, and provides video data to the display 3150. Unlike the open loop mode, the closed loop mode provides sufficient robot data for the mobile data collection apparatus 3200 to provide accurate feedback to the operator of the mobile data collection apparatus 3200 to inform said operator of the forces that the humanoid robot 1 is feeling. In other words, the data is transmitted from the mobile data collection apparatus 3200 to the humanoid robot 1 to control said humanoid robot 1, and then data is transmitted back to the mobile data collection apparatus 3200 to control the mobile data collection apparatus 3200. The operator can then push against the forces applied by the mobile data collection apparatus 3200 to cause the humanoid robot 1 to apply additional force to the object. This closed loop mode causes the operator to step in the shoes of the humanoid robot 1 and feel, see, touch, and interact with the world as if he/she is the humanoid robot 1.

### G. MAPPING HUMAN DATA TO ROBOT CONTROL DATA

The disclosure provides techniques for mapping human data to robot control data with accuracy and efficiency. Significant natural variation in bodies of humans, including segment lengths (e.g., femur, humerus, tibia), torso dimensions, and relative spatial locations of anatomical joint centers of rotation pose challenges in accurate mapping to robots. As an illustrative example, a first operator A's limb lengths and proportions may differ from the design specification of the humanoid robot 1, and a second operator B may differ from both operator A and the humanoid robot 1. To address this variation, the computer 3110 establishes fundamental physical baseline measurements. Furthermore, differences in mass distribution, segment inertias, and/or actuator capabilities (e.g., speed, strength) also exist between humans and humanoid robots 1 and pose challenges in mapping human data to robot control data.

Similarly, exoskeleton-based systems can introduce human-exoskeleton-robot kinematic and anthropometric mismatches. Regarding exoskeleton limitations, while some exoskeletons possess designs for adjustability, they often employ rigid links with fixed lengths between adjustable points. Achieving perfect alignment with a human user's joint axes and segment lengths is seldom possible across a diverse user population or even for a single user across all poses. Moreover, the mismatch between the operator and the exoskeleton (human-exo mismatch) adds another layer of complexity on top of the mismatch between the (potentially misaligned) exoskeleton measurement and the humanoid robot 1's kinematics (exo-robot mismatch). As an illustrative example, operator A's limb lengths may not perfectly match the adjusted exoskeleton segments nor the humanoid robot 1's segments, and operator B introduces further variation relative to operator A, the exoskeleton, and the humanoid robot 1. Interface constraints may also arise from the exoskeleton. The exoskeleton mechanism itself can pose additional constraints on human movement not present in free motion or in the humanoid robot 1's capabilities. For instance, the mechanical structure of an exoskeleton may restrict the range of motion of certain human joints or introduce friction or inertia not present in unencumbered human movement.

Failure to account for any of these discrepancies or mismatches between human data and robot control data can result in operational problems. Such problems include but are not limited to reachability and workspace discrepancies, degradation of postural accuracy and fidelity, risk of constraint violation, operator discomfort, and/or any combination thereof. With respect to reachability and workspace discrepancy, differences in kinematic chain structure (e.g., link lengths, joint placement, DoF, RoM) result in geometrically different reachable workspaces for the humanoid robot 1's end-effectors (e.g., hands, feet) compared to the operator. A pose easily attainable by the operator might place the desired end-effector target outside the humanoid robot 1's workspace, requiring significant postural deviation by the humanoid robot 1 or making the task impossible. Conversely, the humanoid robot 1 might possess capabilities to reach areas inaccessible to the operator, limiting intuitive control if the operator cannot feel or map to that space. Attempting to match a pose near the edge of the operator's workspace can force the humanoid robot 1 into or near a kinematic singularity (where it loses DoF) or push robot joints against their physical limits, potentially causing control failures or jerky movements. Alternative approaches may involve scaling the operator's workspace to fit within the humanoid robot 1's workspace, or providing feedback to the operator when a commanded pose is near or beyond the humanoid robot 1's capabilities.

With respect to the degradation of postural accuracy and fidelity, naive strategies like direct joint angle copying (θrobot=θhuman) fail because identical joint angles applied to different kinematic chains yield different end-effector positions and orientations (poses). This failure is due to the lever arm effect of differing segment lengths and variations in joint axis definitions. Achieving the same relative functional pose (e.g., a hand touching the contralateral shoulder) often necessitates different joint configurations (θ) for the humanoid robot 1 compared to the operator, especially with significant proportional differences. This difference impacts tasks requiring specific body language or whole-body coordination.

With respect to the risk of constraint violation and operator discomfort, mapping human motion without considering the humanoid robot 1's specific geometry and limits can command configurations that violate the humanoid robot 1's joint ROM limits or lead to self-collisions between the humanoid robot 1's links. Environmental collisions may also occur if the humanoid robot 1's body occupies space differently than the operator assumes based on their own body. Additionally, in exoskeleton systems, the kinematic mismatch between the operator and the humanoid robot 1 can generate unintended interaction forces or torques on the operator's joints and limbs. Such unintended forces or torques can cause discomfort, fatigue, restrict natural movement, and in severe cases, pose an injury risk if not managed or compensated. For dynamic motions, mapping operator movements without considering the humanoid robot 1's different inertial properties and actuator dynamics can lead to instability or oscillations in the humanoid robot 1's movement. For example, a rapid arm movement by an operator, if directly mapped, might cause a humanoid robot 1 with higher limb inertia to overshoot the target or exhibit unstable vibrations. Techniques such as dynamic scaling or motion filtering based on the humanoid robot 1's dynamic model may be employed to address these issues.

The techniques described herein provide motion retargeting methods, algorithms, models, and/or techniques that translate the operator's intended motion into feasible and effective commands for the humanoid robot 1, thereby compensating for the kinematic and anthropometric mismatches described above. The humanoid robot data collection system 3010 manages these actions to ensure accuracy. The mapping prioritization scheme 4500 and the retargeting framework described herein operate in concert such that the prioritization scheme 4500 establishes the order in which mismatches are resolved across body parts, while the retargeting framework supplies the methodology by which each prioritized mismatch is computed and applied to the humanoid robot 1's actuators.

a. Mapping Prioritization

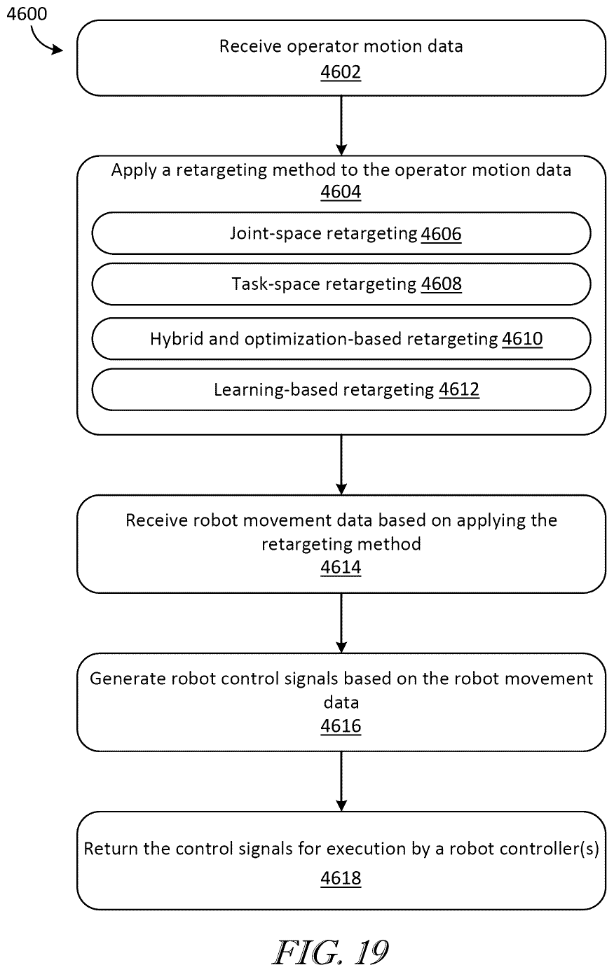

While a perfect mapping between the operator and the humanoid robot 1 may be possible based on the example mapping prioritization scheme 4500 (also referred to herein as the mapping scheme 4500), there remains a possibility that the mapping scheme 4500 may not achieve perfect alignment across multiple limbs and/or joints simultaneously. In cases where perfect alignment is lacking between limbs or joints, the specified order can control the order of priority resolution. The mapping scheme 4500 structures an order of operations. FIG. 18 illustrates an example mapping prioritization scheme 4500 to resolve potential mismatches between component targets according to the prioritization order in the mapping scheme 4500. For example, retargeting (e.g., remapping) movements of the arm(s) can possess higher priority over retargeting movements of the leg(s), which in turn can possess higher priority over retargeting movements of the core. Within the retargeting of the arm(s) movements, the wrist(s) movement can possess the highest priority, followed by the hand(s), the middle finger(s), the index finger(s), the ring finger(s), the little finger(s), then the elbow(s), and lastly the shoulder(s). Within the retargeting of the leg(s) movements, the ankle(s) can possess the highest priority, followed by the knee(s), and then lastly the hip(s). Within the retargeting of the core movement, the head can possess higher priority than the spine.

The description here provides mere illustrative examples of the mapping scheme 4500. One or more other prioritization mappings and/or schemas can be determined and used with the disclosed techniques. For instance, alternative prioritization schemes may prioritize core stability or foot placement over limb endpoint accuracy for locomotion tasks. The mapping scheme 4500 can also be adjusted based on a particular use case or task context. For example, a manipulation task might prioritize hand and finger movements, while a balancing task might prioritize core and ankle movements. Dynamic adjustment of priorities based on task phase or operator intent is also contemplated. For instance, if the humanoid robot data collection system 3010 detects the operator is attempting to grasp an object, the priority of hand and finger mapping may be dynamically increased.

In accordance with another aspect, the humanoid robot data collection system 3010 implements a body-part mapping prioritization scheme 4500 having a hierarchical structure that resolves competing retargeting objectives across body parts and within the operator's hand. The mapping scheme 4500 of this aspect comprises an inter-body-region order in which arm motion is resolved before leg motion and leg motion is resolved before core motion, an intra-arm order in which wrist motion is resolved before hand motion, hand motion is resolved before finger motion, and finger motion is resolved before elbow motion and shoulder motion, an intra-hand finger order in which the middle finger of the operator is resolved before the index finger of the operator, the index finger is resolved before the ring finger, and the ring finger is resolved before the little finger, an intra-leg order in which ankle motion is resolved before knee motion and knee motion is resolved before hip motion, and an intra-core order in which head motion is resolved before spine motion. The mapping scheme 4500 is encoded as a stored data structure that the computer 3110 reads at retargeting time, where the stored data structure comprises an ordered set of body-part identifiers and an associated weight for each body-part identifier, and where the weights determine the relative cost-function emphasis applied during retargeting at each level of the hierarchy.

The intra-hand finger order of the mapping scheme 4500 is encoded by per-finger weights applied to the task-space cost term Jtask such that the wmiddle weight associated with the middle finger exceeds the windex weight associated with the index finger, the windex weight exceeds the wring weight associated with the ring finger, and the wring weight exceeds the wlittle weight associated with the little finger. The within-hand finger ordering of middle>index>ring>little reflects an operating principle that the middle finger contributes the most to grasp stability and opposition reach during precision and power grasps, the index finger contributes next-most through its role in pointing and opposition with the thumb, the ring finger contributes thereafter through its role in grasp closure, and the little finger contributes least to grasp stability and reach in the contemplated manipulation tasks [SUPPORT GAP: technical justification for the specific within-hand finger ordering middle>index>ring>little—confirm sufficiency of original disclosure to support a claim element reciting this ordering on biomechanical or grasp-stability grounds]. The within-hand finger ordering is realized in the cost function Jtask of the optimization-based retargeting (process 4900) by inflating the wmiddle weight relative to wlittle by an integer-valued ratio, which biases the optimizer toward satisfying the middle-finger pose target before sacrificing accuracy on the little-finger pose target when the humanoid robot 1's hand kinematics admits no simultaneous solution.

In some embodiments, the mapping scheme 4500 further comprises a plurality of pre-defined sub-schemes, where each sub-scheme of the plurality of pre-defined sub-schemes embodies a different prioritization tailored to a specific operating context, and an operating-context detector configured to select an active sub-scheme of the plurality of sub-schemes from the plurality of sub-schemes based on a detected operating context. The plurality of sub-schemes comprises a manipulation-focused sub-scheme that elevates hand and finger priorities relative to leg and core priorities, a locomotion-focused sub-scheme that elevates ankle, knee, and hip priorities relative to hand and finger priorities, and a balancing-focused sub-scheme that elevates core and ankle priorities relative to hand and finger priorities. The operating-context detector of the mapping scheme 4500 comprises instructions stored in a memory and executed on a processor of the computer 3110, where the instructions implement a context-classification routine that consumes a set of context features comprising at least one of an operator gaze direction inferred from the VR HMD 3152 (when the VR HMD 3152 is being used as the display 3150), a contact state of feet of the humanoid robot 1 inferred from the actuators of the humanoid robot 1, a hand-near-object signal inferred from the upper head camera 108.2.2 and the lower head camera 108.2.4 of the humanoid robot 1, and a recent sensor data history from the sensors 3208 of the mobile data collection apparatus 3200. The context-classification routine outputs a discrete operating-context label that selects one of the pre-defined sub-schemes, and the selected sub-scheme thereafter governs the weights wi supplied to the cost function Jtask during retargeting.

The mapping scheme 4500, with its hierarchical body-part order and intra-hand finger order, does not require an unstructured cost-function aggregation across all body parts in which finger errors and torso errors compete on equal footing, and the mapping scheme 4500 is free of a single global weight assignment that conflates inter-body-region priority with intra-hand finger priority. Unlike conventional approaches to retargeting that resolve all body parts at the same priority level, the mapping scheme 4500 resolves body parts in tiers and resolves the operator's fingers within the hand tier in the order middle>index>ring>little, by which the humanoid robot data collection system 3010 preserves grasp stability when the humanoid robot 1's hand kinematics admits no simultaneous solution to all finger pose targets. The mapping scheme 4500 in alternative embodiments operates with a continuous-valued sub-scheme blending in lieu of discrete sub-scheme switching, where the operating-context detector outputs a soft assignment over the plurality of sub-schemes and the active weights are computed as a convex combination of the sub-scheme weights, providing smooth transitions when the operating context evolves continuously between manipulation and locomotion phases of a task.

In a further embodiment, the operator may override the operating-context detector through a manual selection input received at the piloting control system 3202, by which the operator may force a particular sub-scheme of the plurality of sub-schemes regardless of the detected context, and may further define a custom sub-scheme by supplying a vector of body-part weights through a configuration interface of the computer 3110. The custom sub-scheme is stored in the data store 3204 and is selectable as an additional sub-scheme of the plurality of sub-schemes thereafter. Furthermore, the mapping scheme 4500 in some embodiments incorporates per-limb confidence weighting, where the weight wi for a body part is reduced when the sensor data for that body part exhibits low signal quality, such that low-confidence tracking of a particular limb does not propagate erratic behavior to the humanoid robot 1.

b. Retargeting Techniques for Mapping Data

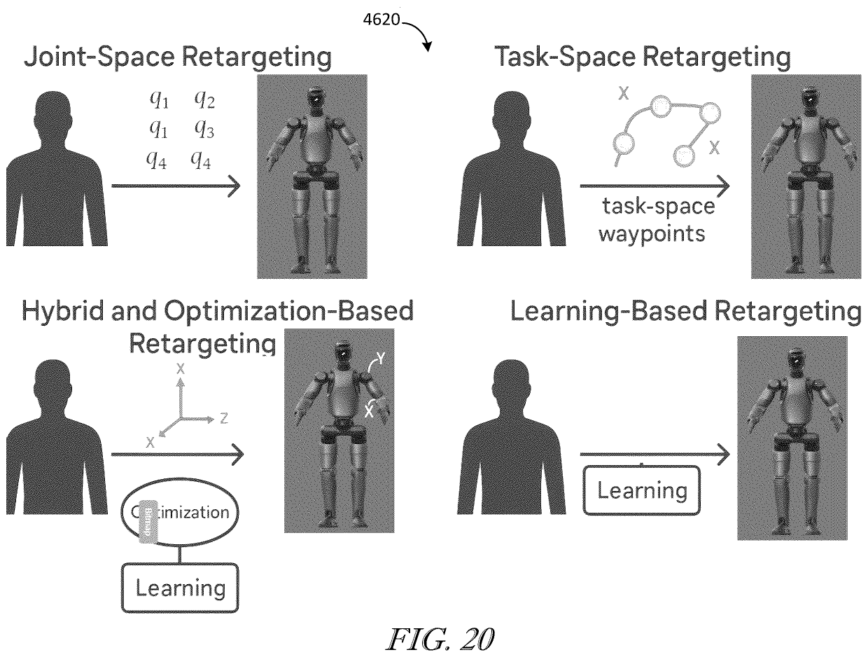

FIG. 19 is a flowchart of a process 4600 for mapping (e.g., transforming) human data to robot control data. The process 4600 can be performed by the computer 3110. In some implementations, the process 4600 can be performed by processors integral to the humanoid robot 1. For illustrative purposes, the process 4600 is described from the perspective of the computer 3110. The process 4600 operates in conjunction with the mapping prioritization scheme 4500 such that the prioritization scheme 4500 supplies the per-body-part weights to the retargeting computation, and the retargeting computation supplies the corresponding control data to the humanoid robot 1.

Referring to the process 4600 in FIG. 19, human data may be collected by the sensors in block 4602. Specifically, the human data can be collected by any of the sensors described herein, such as hand position sensors 3410, other sensors 3208, Inertial Measurement Units (IMUs) 3220, 3224, and/or any combination thereof. These sensors may be part of the mobile data collection apparatus 3200 or the alternative wearable training apparatus 3401, the wearable magnetic field-generating apparatus 3416, or otherwise worn on the operator's body. In alternative embodiments, human data 4602 may be acquired using different sensor modalities or combinations thereof. For example, optical motion capture systems comprising multiple cameras may track markers placed on the operator's body. Fusion techniques, potentially employing filtering algorithms like Kalman filters, may combine data from various sensor types (e.g., IMUs 3220, 3224, optical systems, EMG sensors) to yield more robust and accurate human data. Pressure sensors integrated into footwear or the glove 3400 could provide contact and force information.

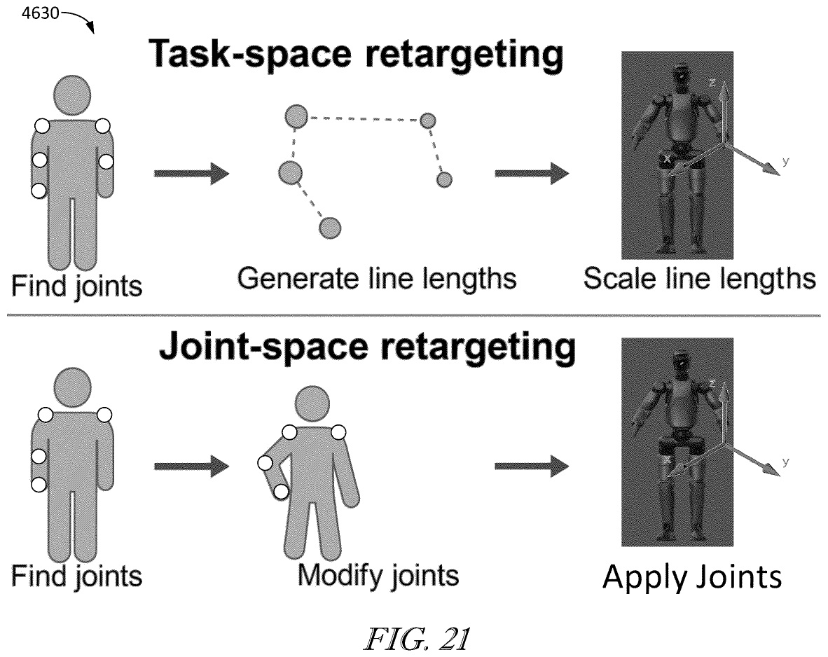

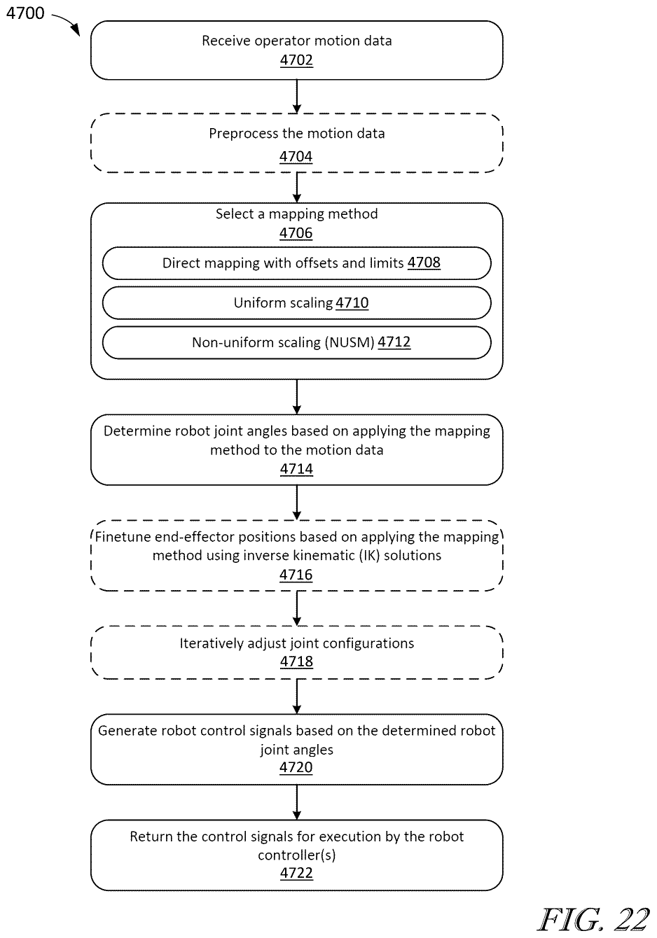

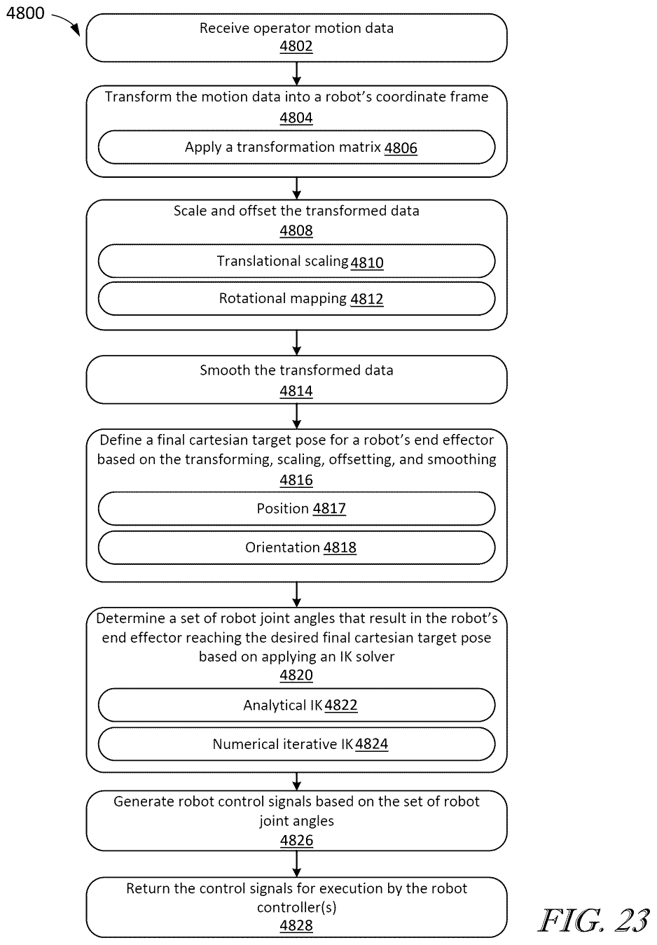

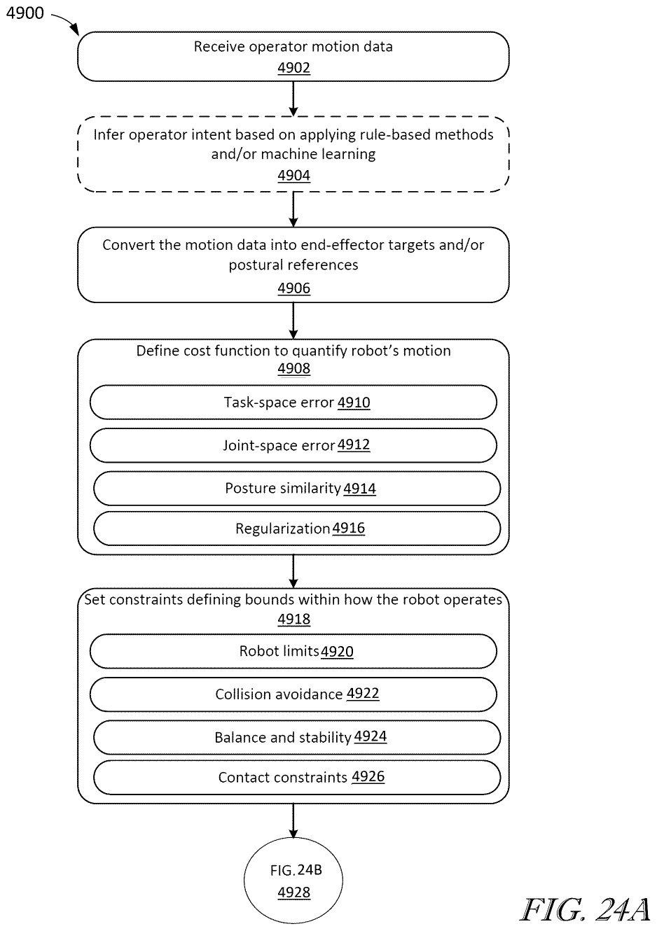

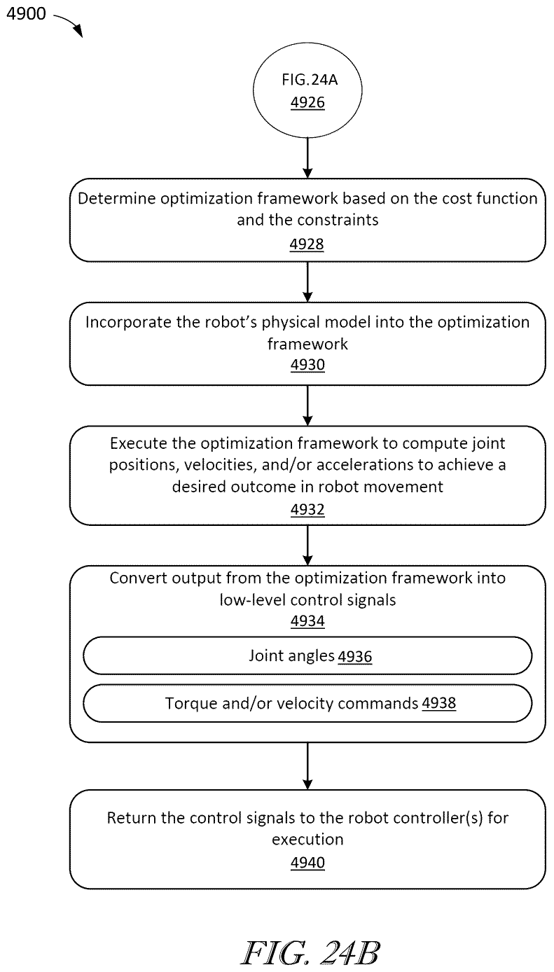

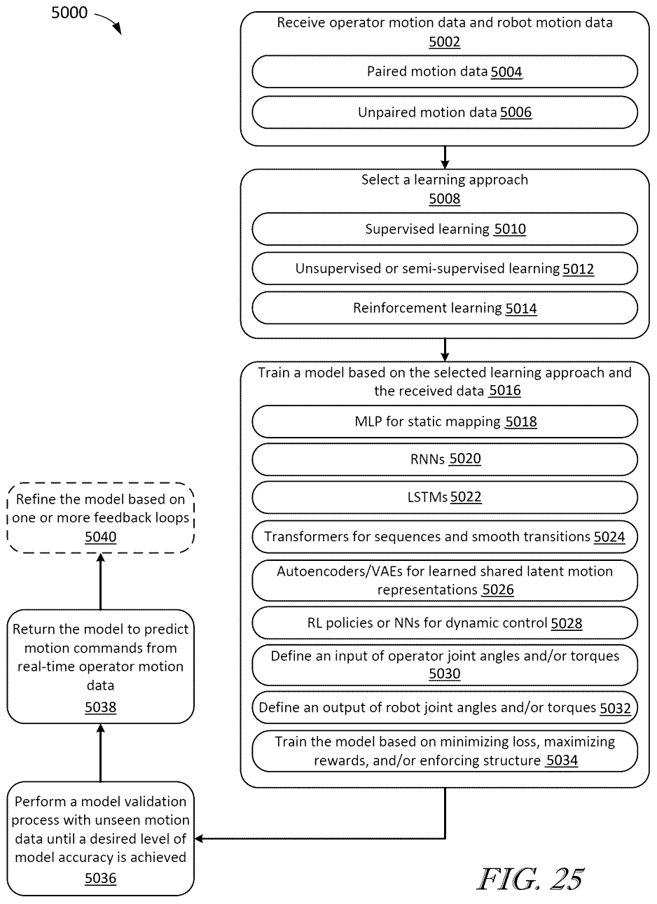

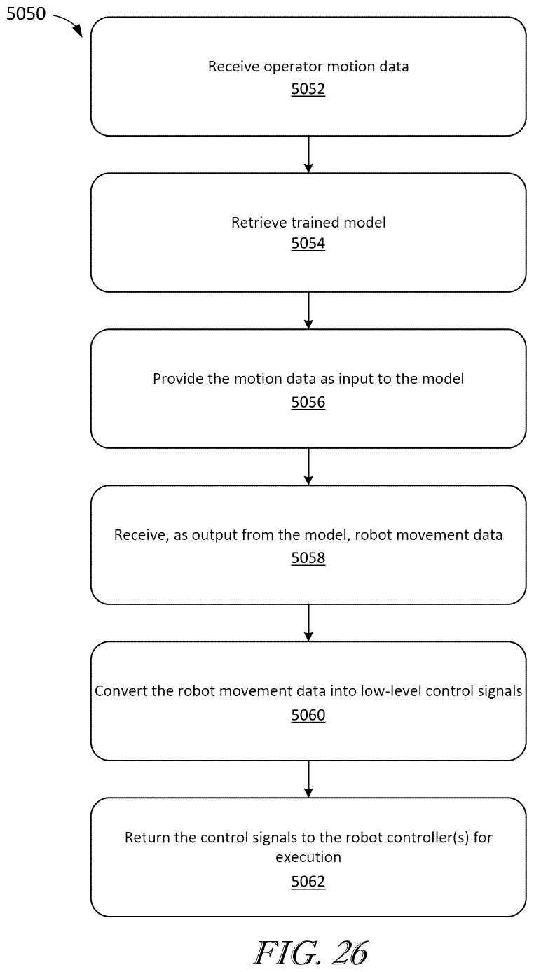

The computer 3110 can apply one or more retargeting methods to the sensor data in block 4604. For example, the computer 3110 can apply joint-space retargeting (block 4606), task-space retargeting (block 4608), hybrid and optimization-based retargeting (block 4610), learning-based retargeting (block 4612), and/or any combination thereof. Refer to FIGS. 20 and 21 for further discussion about the different retargeting methods described herein. Refer to FIG. 22 for further discussion about joint-space retargeting, FIG. 23 for further discussion about task-space retargeting, FIGS. 24A and 24B for further discussion about hybrid and optimization-based retargeting, and FIGS. 25 and 26 for further discussion about learning-based retargeting.

In block 4614, the computer 3110 can receive robot control data based on applying the chosen retargeting method in block 4604. For example, output generated from any of the retargeting methods in blocks 4606-4612 can include robot joint angles, target end-effector poses, joint velocities, joint torques, and/or other position, movement information, or signals.

Based on the robot control data, the computer 3110 can generate robot data (block 4616). For example, the computer 3110 can convert the robot control data (e.g., target robot joint angles or velocities) into low-level control signals that can be executed by robot actuators to control the humanoid robot 1 to move from its current state towards a target state (where the target state corresponds to the retargeted movements of the operator).

Accordingly, the computer 3110 can return the control signals for execution by one or more robot controllers in block 4618. Sometimes, the computer 3110 can automatically execute the control signals to cause the humanoid robot 1 to move similarly to the operator. Sometimes, robot control data and/or the control signals can be used by the computer 3110 for other operations and/or processes, such as generating model training data and/or training models that are used to control the humanoid robot 1.

FIG. 20 provides an illustrative example 4620 of different types of retargeting methods that can be used to map human data to robot control data in the process 4600 of FIG. 19. The retargeting methods, as described herein, include:
Joint-space retargeting generally maps human joint angles directly to the humanoid robot 1's joint angles. This approach possesses computational simplicity and directness, assuming a close similarity between the human and the robot kinematics.
Task-space retargeting maps the desired position and orientation (pose) of key points, often end-effectors (e.g., hands, wrists, feet), rather than directly mapping joint angles. This approach typically employs Inverse Kinematics (IK) solvers to determine robot joint configurations that achieve the desired end-effector pose.
Hybrid and optimization-based retargeting can combine joint-space and task-space techniques along with optimization methods to find a robot joint configuration deemed best according to defined criteria. This approach can consider and weigh multiple objectives, including but not limited to minimizing energy consumption, avoiding collisions, preserving motion intent, matching specific kinematic features, and/or any combination thereof.
Learning-based retargeting typically involves training and deploying machine learning models (e.g., neural networks, NNs). These models are often trained on human-robot control data to predict how robot joints should move based on observed human motion. This approach can adapt to complex kinematic mismatches and learn nuanced motion patterns or dynamics; or
Any combination thereof.

FIG. 21 presents an illustrative example 4630 contrasting task-space retargeting and joint-space retargeting, either of which may be used with the disclosed techniques to map human data to robot control data in the process 4600 of FIG. 19. As shown in the illustrative example 4630, task-space retargeting can involve identifying key points or frames on the operator, determining their pose, potentially scaling or transforming this pose, and using it as a target for the humanoid robot 1's corresponding key point or frame, often requiring IK. In the illustrative example 4630, joint-space retargeting can involve identifying the joint angles on the operator, potentially modifying these angles (e.g., via scaling or offsets), and applying these modified angles to the corresponding joints of the humanoid robot 1.

Task-space retargeting and joint-space retargeting approaches exhibit differences in their space of operation, typical sensor data that is derived from human data, transformation approach used, computational complexity, resulting accuracy and end-effector control, suitable applications, and flexibility in handling kinematic redundancy.

With respect to the space of operation, joint-space retargeting works directly with joint angles (θ) of both the operator and the humanoid robot 1. It focuses on transferring the operator's joint configurations (e.g., arm bend, wrist rotation, leg position) to corresponding robot joint configurations. This method aims to mimic the posture and style of the operator by mapping the joint angles. Task-space retargeting, conversely, works with the end-effector pose (position and orientation) of the operator and the humanoid robot 1 in Cartesian space. It focuses on transferring the desired end-effector pose (e.g., specifying where the humanoid robot 1's hand should be in 3D space) rather than manipulating the joint angles directly. It maps the operator's hand movement, for example, to the humanoid robot 1's end-effector position and orientation.

With respect to sensor data, joint-space retargeting typically receives sensor data derived from the operator's joint angles (e.g., how the operator bends their arm or moves their wrist). It involves translating these joint angles into corresponding robot joint angles, often requiring scaling and adjustments to fit the humanoid robot 1's specific kinematic structure and limits. Task-space retargeting, conversely, typically receives sensor data representing the operator's end-effector pose (e.g., the position and orientation of the hand or another key body part) in space. The operator's motion is represented in Cartesian space (3D position and orientation), and the task is to move the humanoid robot 1's end-effector to achieve a corresponding target pose.

With respect to the transformation approach, joint-space retargeting focuses on transforming joint configurations, potentially in a 1:1 or scaled manner, with possible offset adjustments to account for the different kinematics (e.g., link lengths, joint types, ROM) of the operator and the humanoid robot 1. Task-space retargeting typically involves calculating a target pose in Cartesian space (position and orientation) and then using IK to compute the necessary robot joint angles to achieve that pose. The IK solver finds the joint configurations that allow the humanoid robot 1 to reach the desired end-effector pose, considering the humanoid robot 1's specific kinematics.

With respect to computational complexity, joint-space retargeting is generally simpler to compute as it maps joint angles, potentially with scaling or offsets applied. However, it can sometimes lead to inaccuracies in end-effector placement if the humanoid robot 1's kinematics differ significantly from the operator's kinematics. Task-space retargeting is often more computationally involved because it requires solving the IK problem, which may lack closed-form solutions for complex robots. IK may need iterative numerical solvers or optimization methods to find suitable joint angles, especially for robots with many DoF or redundant kinematics. This approach may also include additional steps like coordinate frame alignment and pose trajectory smoothing to ensure accurate and fluid robot movement.

With respect to accuracy and end-effector control, joint-space retargeting focuses on replicating the operator's joint configurations. While it can mimic body posture, this approach may not guarantee precise control of the humanoid robot 1's end-effector position or orientation, which can lead to errors in tasks requiring accurate end-effector placement (e.g., grasping, manipulation, tool use). The task-space retargeting approach, conversely, aims to match the end-effector pose, ensuring that the humanoid robot 1's tool or hand reaches a specific target position and orientation in space. This approach tends to yield higher accuracy for tasks where the position and orientation of the end-effector are critical, such as in precision manipulation, assembly, or teleoperation involving tool interaction.

With respect to application suitability, joint-space retargeting may be better suited for tasks where replicating body posture or movement style is important (e.g., certain forms of telepresence where the robot mirrors the operator's general movements, gestural communication). This approach can be useful where the exact placement of the end-effector is less critical, or when the humanoid robot 1 is performing a movement style or gesture based on the operator's body posture. Task-space retargeting is often preferred for tasks where precise end-effector control is necessary (e.g., object manipulation or pick-and-place tasks). This approach is also well-suited for tasks requiring the humanoid robot 1 to perform actions based on spatial goals, like reaching specific locations in the environment or interacting with objects at defined positions.

With respect to flexibility in handling redundancy, joint-space retargeting can be less flexible when the humanoid robot 1 possesses redundant DoF (more joints than mathematically necessary to achieve a specific end-effector pose), as it focuses on direct joint mappings which might not utilize the redundancy effectively. Task-space retargeting, conversely, may offer more flexibility in handling redundant kinematics through the use of IK solvers. These solvers can often find multiple possible joint configurations that achieve the same end-effector pose, allowing for secondary objectives (like obstacle avoidance or joint limit avoidance) to be optimized using the redundant DoF.

In accordance with another aspect, the humanoid robot data collection system 3010 implements a retargeting framework that comprises a plurality of retargeting methodologies operating within a single architecture under the governance of the mapping prioritization scheme 4500. The plurality of retargeting methodologies comprises a joint-space retargeting block 4606 configured to map operator joint configurations (θhuman) directly to corresponding robot joint configurations (θrobot) of the humanoid robot 1, a task-space retargeting block 4608 configured to map operator end-effector poses (Thuman) to corresponding robot end-effector poses (Trobot) using one or more inverse-kinematics solvers, a hybrid optimization block 4928 configured to formulate the retargeting problem as a constrained optimization in which a cost function J quantifies competing objectives and a set of constraints define mandatory bounds within which the humanoid robot 1 operates, and a learning-based retargeting block 5018-5028 configured to apply one or more pre-trained machine learning models to predict robot control data from human data. Each methodology of the plurality of methodologies produces robot control data of a common output format comprising target joint angles, target joint velocities, target joint torques, target end-effector poses, or any combination thereof, such that the downstream control signal generation of process 4600 is independent of which methodology supplied the robot control data.

The retargeting framework further comprises a selector module configured to select an active methodology of the plurality of retargeting methodologies based at least in part on the mapping prioritization scheme 4500 and on a current operating context of the humanoid robot 1. The selector module of the retargeting framework comprises instructions stored in a memory and executed on a processor of the computer 3110, where the instructions implement a routing routine that consumes the active sub-scheme output by the operating-context detector of the mapping scheme 4500 and a set of methodology-suitability metrics, and outputs a methodology identifier and a set of methodology-specific parameters. The methodology-suitability metrics comprise a kinematic-similarity score between the operator and the humanoid robot 1, an availability flag for each pre-trained learning-based model, a per-cycle compute budget available at the computer 3110, and a current task-phase label inferred from the sensor data 3208. The routing routine outputs the joint-space block 4606 when the kinematic-similarity score exceeds a similarity threshold and the task-phase label indicates posture-mimicking content, outputs the task-space block 4608 when the task-phase label indicates end-effector-precision content, outputs the hybrid optimization block 4928 when the operating context demands simultaneous satisfaction of joint-space and task-space objectives under physical-feasibility constraints, and outputs the learning-based block 5018-5028 when an applicable pre-trained model is available and the per-cycle compute budget admits model inference.

The cost function J of the hybrid optimization block 4928 of the retargeting framework comprises a task-space error term Jtask, a joint-space error term Jjoint, a posture similarity term Jposture, and a regularization term Jregularize, combined as a weighted sum J=Σwi Ji in which the weights wi are sourced from the active sub-scheme of the mapping prioritization scheme 4500. The hybrid optimization block 4928 supports a quadratic programming (QP) solver for cases where the cost function is quadratic and the constraints are linear, a sequential quadratic programming (SQP) solver for cases where the constraints are nonlinear but the problem admits iterative QP approximations, a general nonlinear programming (NLP) solver for cases involving nonlinear cost functions, dynamics, or constraints, and a model predictive control (MPC) formulation in which the optimization is performed over a receding horizon and only the initial control input is applied at each control cycle. The hybrid optimization block 4928 thereby implements a configurable solver architecture in which the choice of solver is determined by the structure of the active retargeting problem and the per-cycle compute budget available at the computer 3110.

The learning-based block 5018-5028 of the retargeting framework supports a plurality of model architectures comprising a multi-layer perceptron (MLP) architecture (block 5018) for static-pose mappings, a recurrent neural network (RNN) architecture (block 5020) for temporally-extended mappings, a long short-term memory (LSTM) architecture (block 5022) for mappings that benefit from gated memory cells, a gated recurrent unit (GRU) architecture for mappings that benefit from a simpler gating structure than LSTM, a transformer architecture (block 5024) for mappings that benefit from self-attention across motion sequences, an autoencoder (ΔE) or variational autoencoder (VAE) architecture (block 5026) for mappings that operate through a shared latent space between the human domain and the humanoid robot 1 domain, a graph neural network (GNN) architecture for mappings that exploit the kinematic graph structure of the humanoid robot 1 and of the operator, and a reinforcement-learning policy network (block 5028) for mappings learned through reward-based interaction with a simulator of the humanoid robot 1. The learning-based block 5018-5028 selects the active model architecture from the plurality of model architectures based on a model-selection record stored at the data store 2900, where the model-selection record associates each task-phase label with a preferred model architecture and a corresponding pre-trained parameter set ¢.

A method aspect of the retargeting framework comprises retrieving an active sub-scheme from the mapping prioritization scheme 4500 stored at the data store 2900, retrieving the methodology-suitability metrics, executing the selector module to obtain a methodology identifier, executing the methodology of the plurality of retargeting methodologies identified by the methodology identifier on the sensor data sourced from the mobile data collection apparatus 3200 or the alternative wearable training apparatus 3401, and applying the resulting robot control data to the actuators of the humanoid robot 1. A training method aspect of the retargeting framework comprises collecting a corpus of paired sensor data and corresponding executed robot control data from operation of the humanoid robot 1 with the mobile data collection apparatus 3200 or with the alternative wearable training apparatus 3401, partitioning the corpus into a training partition and a validation partition, training the parameter set φ of one or more model architectures of the plurality of model architectures of the learning-based block 5018-5028 on the training partition by minimizing a loss function comprising a mean-squared-error term and a smoothness term, validating the parameter set φ on the validation partition by computing a tracking-error metric and a smoothness metric, and storing the validated parameter set φ at the data store 2900 indexed by the corresponding task-phase label.

The retargeting framework does not require selection of a single fixed retargeting methodology before the start of operation, and the retargeting framework is free of a static decomposition between joint-space mapping and task-space mapping that ignores the active operating context. Unlike conventional retargeting approaches that commit to one methodology a priori, the retargeting framework selects, at retargeting time, among the joint-space block 4606, the task-space block 4608, the hybrid optimization block 4928, and the learning-based block 5018-5028 by reference to the mapping prioritization scheme 4500 and the methodology-suitability metrics, by which the humanoid robot data collection system 3010 routes each retargeting cycle to the methodology best matched to the current operating context. The retargeting framework in alternative embodiments operates with two or more methodologies running concurrently, where outputs of the concurrent methodologies are blended through a weighted average in which the blending weights are supplied by the selector module, providing graceful transitions between methodologies and providing redundancy when one methodology produces an output that violates a physical-feasibility constraint.

i. Joint-Space Retargeting

FIG. 22 is a flowchart of a process 4700 for joint-space retargeting to map human data to robot control data. The process 4700 can be performed to translate the human data into feasible and effective commands for the humanoid robot 1, compensating for kinematic and/or anthropometric mismatches between the human data and the humanoid robot 1. More specifically, the process 4700 of joint-space retargeting can be used to map the joint configurations contained in the human data to the humanoid robot 1's corresponding joints. The process 4700 focuses on mimicking the operator's posture and/or movement style such that f(θₕᵤₘₐₙ)=θ_{robot}, where f represents the mapping function. Advantages of this approach include its computational simplicity and potential to preserve the liveliness or character of operator motions, making it suitable for gestural communication or certain types of obstacle avoidance using body posture. Sometimes, this approach may not guarantee accurate end-effector placement due to kinematic differences, potentially leading to task failure in applications requiring precise end-effector positioning.

The process 4700 can be performed by the computer 3110. In some implementations, the process 4700 can be performed by processors integral to the humanoid robot 1. For illustrative purposes, the process 4700 is described from the perspective of the computer 3110.

Referring to the process 4700 in FIG. 22, the computer 3110 receives sensor data in block 4702. This sensor data can be captured by sensors as described herein (e.g., IMUs 3220, 3224, hand position sensors 3410, optical markers 1065) from the human data. Operator and robot joint spaces can be defined based at least in part on the human data and known robot kinematics. For example, the operator joint configurations (θₕᵤₘₐₙ) can include specific joint angles and/or positions derived from the human data, representing the state of key body parts like arms, hands, and/or legs. The computer 3110 can then define the corresponding target joints of the humanoid robot 1 (θ_{robot}), which relate to the angles and positions of robotic limbs and actuators (e.g., robot arms, fingers). Establishing a correspondence mapping between operator joints and robot joints is often a prerequisite.

Optionally, the computer 3110 can preprocess the sensor data in block 4704. For example, the computer 3110 may clean and filter the sensor data to remove noise or artifacts. The computer 3110 can standardize or normalize the sensor data to ensure consistent interpretation of joint configurations across different capture sessions or operators. Preprocessing in some embodiments further includes coordinate-frame alignment between the operator's tracking frame (anchored at the torso IMU 3224 or at the wearable magnetic field-generating apparatus 3416, depending on which apparatus is the active source) and the humanoid robot 1's base frame, such that joint angles in the human data are expressed in a frame consistent with the humanoid robot 1's kinematic chain definition.

In block 4706, the computer 3110 can select a mapping method appropriate for the specific humanoid robot 1 and task. For example, the computer 3110 can select direct mapping with offsets and limits (block 4708), uniform scaling (block 4710), non-uniform scaling (NUSM) (block 4712), and/or any combination or variation thereof. Alternative joint-space mapping methods may also be selected. For instance, a function fitting approach could learn a polynomial or other function mapping operator joint angles to robot joint angles based on pre-collected calibration data. Another alternative involves pose-based mapping, where canonical operator poses are mapped to corresponding desired robot poses, and interpolation is used for intermediate poses. The mapping method can be selected based on the needs of a particular task being performed, the degree of kinematic similarity between the operator and the humanoid robot 1, and computational constraints. Direct mapping with offsets and limits (block 4708) provides a simple mapping that transfers operator joint angles to robot joints with adjustments for base offsets and enforcement of robot ROM limits. With this method, the computer 3110 may add constant offsets to account for differences in neutral poses and clamp the resulting angles to fit within the humanoid robot 1's permissible RoM. θ_{robot,i}=max(θ_{min,i},min(θ_{max,i}, θ_{human,i+offset}_{ᵢ})) represents this clamping.

The uniform scaling method (block 4710) applies a single scaling factor(S) to relevant operator joint displacements (e.g., Δθ_{robot}=S·Δθₕᵤₘₐₙ) or scales based on overall limb length ratios, assuming proportional similarity between the operator and the humanoid robot 1's body structures. This method can be used in illustrative scenarios such as scaling operator workspace movement ranges to fit within robot workspace ranges. The NUSM method (block 4712) applies multiple, potentially different, scaling factors or more complex transformations to different body parts, axes, or workspace regions. This allows different body parts or axes to possess different scales based on their specific functional needs or constraints. For instance, finger movements might be scaled differently than arm movements. Techniques like grid-based mapping with region-specific rules or the application of scaling matrices per joint or limb segment can implement NUSM. This approach offers more flexibility than the direct mapping or uniform scaling methods described in blocks 4708 and 4710.

The computer 3110 can determine target robot joint angles based on applying the selected mapping method to the human data in block 4714. For example, with the direct mapping approach (block 4708), the computer 3110 identifies the ROM for both the operator (potentially estimated) and the humanoid robot 1 (from specification). The computer 3110 then adjusts joint values using simple offsets and/or clamping as described previously. For example, the computer 3110 applies offsets to operator joint angles and ensures the resulting robot joint angles fall within the humanoid robot 1's allowed RoM. The computer 3110 uses clamping to restrict commanded robot joint angles if they exceed the humanoid robot 1's defined RoM. With the uniform scaling method (block 4710), the computer 3110 selects a scaling factor(S) based on relative proportions between the operator and the humanoid robot 1. This relative proportion calculation may use limb length ratios (e.g., operator arm length versus the humanoid robot 1 arm length). The relative proportions may alternatively be determined based on overall body dimensions, such as the operator's height versus the humanoid robot 1's height, or workspace dimensions. The computer 3110 then applies the scaling factor(S) to the operator's joint displacements relative to a reference pose. For each relevant operator joint angle displacement, Δθₕᵤₘₐₙ, the computer 3110 computes the corresponding robot joint angle displacement Δθ_{robot} using the scaling factor S. The computer 3110 may ensure the scaling factor is appropriate for the body parts or joints undergoing transformation.

With the NUSM approach (block 4712), the computer 3110 determines multiple scaling factors or transformation parameters for different joints or body regions (e.g., arms, torso, hands). The computer 3110 can implement grid-based mappings or region-specific rules to determine these different scaling factors. The computer 3110 can also apply scaling matrices or more complex transformations tailored to each region or joint group. Calibration may be performed for each region; for example, arms may possess a different scaling factor compared to the torso or legs. This calibration can include mapping the operator's functional workspace to the humanoid robot 1's workspace using workspace scaling techniques specific to joint-space control. Since robots and humans often possess different kinematic structures, direct joint mapping, even with scaling, may not lead to an accurate or desired end-effector position. Accordingly, the computer 3110 may optionally fine-tune the determined joint angles based on desired end-effector positions using IK solutions (block 4716) as a corrective step. This represents a hybrid approach blending joint-space and task-space concepts. Additionally or alternatively, the computer 3110 may optionally iteratively adjust joint configurations (block 4718), perhaps using small adjustments based on feedback or simple heuristics to improve the outcome.

Next, the computer 3110 generates robot control signals based on the determined (and potentially adjusted) robot joint angles (block 4720) and returns the control signals for execution by the robot controller(s) in block 4722. These signals could be target joint positions, velocities, or torques depending on the humanoid robot 1's control interface.

ii. Task-Space Retargeting

FIG. 23 is a flowchart of a process 4800 for task-space (e.g., Cartesian) retargeting to map human data to robot control data. The process 4800 can be performed to map the pose (position and orientation) of operator end-effectors, and potentially other key points, to corresponding robot 1 end-effector target poses. The process 4800 can be performed by the computer 3110. In some implementations, the process 4800 can be performed by processors integral to the humanoid robot 1. For illustrative purposes, the process 4800 is described from the perspective of the computer 3110. The process 4800 may operate as the active retargeting methodology selected by the selector module of the retargeting framework when the task-phase label inferred from the sensor data 3208 indicates end-effector-precision content, and may operate concurrently with the joint-space retargeting process 4700 in embodiments in which the selector module routes the cycle to a blended methodology output.

Referring to the process 4800, the computer 3110 receives sensor data in block 4802. Using this sensor data, the computer 3110 can define or estimate an operator end-effector pose (Tₕᵤₘₐₙ) and determine a corresponding target robot end-effector pose (T_{robot}). The operator end-effector pose can represent the position and orientation of the operator's hand, a held tool, or any other tracked body part (e.g., wrist, foot, head). It can be expressed mathematically, for example, as a homogeneous transformation matrix comprising position (pₕᵤₘₐₙ) and orientation (Rₕᵤₘₐₙ). The target robot end-effector pose refers to the desired corresponding position and orientation of the humanoid robot 1's end-effector within the humanoid robot 1's workspace (often relative to the humanoid robot 1's base frame). This pose serves as the target for the humanoid robot 1 to reach or mimic through its joint movements.

In block 4804, the computer 3110 transforms the sensor data (specifically, the relevant poses) into a coordinate frame suitable for the humanoid robot 1, such as the humanoid robot 1's base frame. For example, the computer 3110 can apply a transformation matrix, which may be static or dynamic, (T_{worldrobot_base}) to the operator pose data in block 4806. This matrix accounts for the relative position and orientation between the operator's tracking space (e.g., world frame of the motion capture system) and the humanoid robot 1's workspace (base mount 3240). This transformation ensures that the operator's pose is expressed in a frame that is meaningful for commanding the humanoid robot 1's movement. As an illustrative example, if the operator is holding a tool, the transformation matrix converts the measured pose of that tool into the coordinate system originating at the humanoid robot 1's base.

In block 4808, the computer 3110 can optionally scale and/or offset the transformed pose data. The computer 3110 can apply translational scaling (block 4810), rotational mapping or scaling (block 4812), and/or any combination thereof. The operator's effective workspace and the humanoid robot 1's workspace often possesses different sizes, shapes, and reachable volumes, making a direct 1:1 mapping potentially impractical or suboptimal. Translational scaling (block 4810) can include calculating the translational movement (Pₕᵤₘₐₙ) relative to a chosen reference point (e.g., the operator's torso center, a fixed starting position). One or more scaling factors (sₜᵣₐₙₛ) can be applied to match the humanoid robot 1's workspace dimensions or desired interaction scale, potentially represented by an equation like

p_{target}=T_{worldrobot_base}×(p_{human_origin}+sₜᵣₐₙₛ×(Pₕᵤₘₐₙ−P_{human_origin}))

where p_{target} is the target position in the robot frame and p_human_origin is the reference point in the operator frame. An offset term may also be added. This adjustment ensures the operator's translational movement fits appropriately within the humanoid robot 1's reachable workspace or maps to a desired scale, with an optional offset to align the pose better relative to the humanoid robot 1's base or task objects. With rotational mapping (block 4812), the operator's orientation (Rₕᵤₘₐₙ) is mapped to the humanoid robot 1's orientation (R_{target}). This may involve directly using the transformed operator orientation or applying further modifications. Sometimes, only specific axes of rotation may be mapped (e.g., mapping only wrist yaw and pitch but not roll, if a particular task does not require roll control or if the operator interface lacks roll sensing). Rotational scaling, although less common than translational scaling, may also be applied in specific contexts. The rotational mapping ensures that the operator's indicated orientation is adjusted for the humanoid robot 1's end-effector orientation capabilities and task requirements. The target orientation can be defined, for example, as R_{target}=R_{worldrobot_base}×Rₕᵤₘₐₙ, where R_{worldrobot_base} is the rotational part of the frame transformation.

The computer 3110 can also smooth the transformed, scaled, and offset target pose data in block 4814. Raw sensor data can include noise due to sensor inaccuracies or abrupt operator movements. Filters, such as Kalman filters, moving average filters, Butterworth filters, or spline interpolation techniques, can be applied to the stream of Cartesian target poses (T_{target}). These filters can help ensure that the final target robot pose trajectory is smooth, avoiding sudden, jerky, or high-frequency movements of the humanoid robot 1, which can improve performance and safety.

Accordingly, the computer 3110 defines a Cartesian target pose (T_{target}) for the humanoid robot 1's end-effector based on the transforming, scaling, offsetting, and smoothing operations (block 4816). This target pose typically includes both position (block 4817) and orientation (block 4818) components. The output of the transformation, scaling, offset, and smoothing steps is the final Cartesian target pose (T_{target}) for the humanoid robot 1's end-effector, intended as input for the next stage. The target position (P_{target}) specifies the desired location of the humanoid robot 1's end-effector, and the target orientation (R_{target}) specifies its desired alignment. This target pose (T_{target}) is expressed in the humanoid robot 1's base frame (e.g., as T_{target}∈SE(3), representing both position p_{target}∈SE(3) and orientation R_{target}∈SE(3)). The computer 3110 processes the matrices to confirm these properties.

Next, the computer 3110 determines a set of robot joint angles (θ_{robot}) that result in the humanoid robot 1's end-effector reaching the desired final Cartesian target pose (T_{target}) by applying an IK solver (block 4820). The selection of the IK solver can depend on factors including the humanoid robot 1's kinematic structure (e.g., degrees of freedom, presence of redundancy, joint types), required computational performance (e.g., real-time constraints), desired accuracy, robustness to singularities, and available computational resources.

In some implementations, the computer 3110 can apply an analytical IK solver (block 4822), if one exists for the specific robot kinematics. Analytical IK methods solve the forward kinematics equation FK(θ_{robot})=T_{target} using algebraic manipulations or geometric reasoning to derive closed-form mathematical solutions for the joint angles (θi). This approach is feasible for robots with simpler or specific kinematic structures (e.g., certain configurations of serial manipulators, manipulators with spherical wrists, planar arms). This approach offers advantages of high processing speed, providing exact solutions within numerical precision limits, and working well for many common non-redundant industrial robots. However, analytical solutions are not available for all robot designs. In many implementations, the computer 3110 applies a numerical iterative IK solver, often Jacobian-based (block 4824). These approaches use the robot Jacobian (J(θ)), a matrix relating joint velocities (\dot{q} or \dot{θ}) to end-effector linear and angular velocities (\dot{x}=[vₜ,ωₜ]^{T}), such that \dot{x}=J(\dot{θ})\dot{q}. The IK problem is solved iteratively by calculating updates to the joint angles aimed at reducing the error between the current end-effector pose and the target pose. The IK error (e) can be computed as the difference between the target pose (T_{target}) and the current end-effector pose resulting from the current joint angles (FK(θ_{current})). This error is often represented as a 6-dimensional vector (3 position errors, 3 orientation errors). The Jacobian matrix is used to relate this Cartesian error to the necessary change in joint angles (Δθ) required to minimize the error. A typical iterative process involves: starting with an initial guess for joint angles θ_{current} (often the current robot configuration); then, computing the forward kinematics FK(θ_{current}), calculating the error between T_{target} and FK(θ_{current}), computing the Jacobian J(θ_{current}), and updating the joint angles using a method involving the inverse or pseudo-inverse of the Jacobian to incrementally reduce the error. This loop repeats until the error is below a threshold or a maximum number of iterations is reached. Advantageously, numerical iterative approaches can be generalized to most robot kinematic structures and can handle redundant DoFs (where multiple joint configurations yield the same end-effector pose). One common method is the Jacobian transpose method, where Δθ=αJ^{T}(θ)e, where e is the Cartesian error vector and a is a step size. This method is computationally simple but may converge slowly.

Another common method is the Jacobian pseudo-inverse approach, where Δθ=J^{†}(θ)e, and J^{†}=J^{T} (JJ^{T})⁻¹ is the Moore-Penrose pseudo-inverse (particularly for non-square Jacobians typical of redundant robots). This pseudo-inverse method often provides a more direct path towards the target pose but requires matrix inversion, which can be computationally more expensive and numerically unstable near kinematic singularities (where the Jacobian loses rank). Damped Least Squares (DLS), also known as the Levenberg-Marquardt algorithm in this context, uses an update rule like Δθ=J^{T} (JJ^{T}+λ²I)⁻¹e. This approach introduces a damping factor/that improves numerical stability near singularities by preventing excessively large joint velocities or steps, potentially at the cost of slightly slower convergence or a small residual error when damping is active.

In some implementations, specialized libraries or software packages may be used to implement the IK solver, leveraging pre-existing, optimized code. Examples include IKFast, TRAC-IK, Kinematics and Dynamics Library (KDL), Pinocchio, and/or combinations thereof. IKFast is a tool that attempts to automatically generate C++ code for an analytical IK solver by analyzing the humanoid robot 1's kinematic equations. When successful, the generated solver is extremely fast. TRAC-IK offers a hybrid approach combining numerical IK (using KDL's solvers) with randomized restarts and a meta-solver strategy that runs different solvers (e.g., KDL's pseudo-inverse and an SQP optimization solver) in parallel, returning the first valid solution found. This approach aims for both speed and reliability, often outperforming standard numerical methods, especially near singularities or joint limits. KDL provides foundational classes and implementations for chain-based forward kinematics and numerical IK solvers (including Jacobian pseudo-inverse and DLS), serving as a basis for many robotics systems, particularly within the Robot Operating System (ROS) ecosystem. Pinocchio provides efficient computation of kinematics and dynamics quantities, including Jacobians and IK derivatives, often used in optimization-based control. Alternative IK approaches may involve optimization-based formulations directly minimizing the pose error subject to constraints (e.g., joint limits, collision avoidance), potentially using generic nonlinear optimizers. Sampling-based methods (e.g., Randomized Coordinate Descent) can also explore the configuration space to find IK solutions, sometimes useful for highly complex or constrained problems.

Still referring to blocks 4820-4824, the core computational task of the IK solver is to find the set of robot joint angles (θ_{robot}) that causes the robot 1's end-effector, via the forward kinematics function (FK), to reach the desired Cartesian target pose (T_{target}). Accordingly, the goal is to find joint angles θ_{robot}=[θ₁, θ₂, . . . , θₙ] (where n is the number of joints) such that FK(θ_{robot})≈T_{target}. Input to the IK solver typically includes the desired target pose (T_{target}) and the robot 1's kinematic model (defining the FK relationship). Output from the IK solver is typically a vector of joint angles θ_{robot} that achieves, or closely approximates, the desired end-effector pose. For redundant robots, a family of solutions might exist, and the solver might return one specific solution based on its algorithm or additional criteria (e.g., minimizing joint displacement from a rest pose).

The computer 3110 can then generate robot control signals based on the determined set of robot joint angles (block 4826) and return these control signals for execution by the robot controller(s), such as the humanoid robot 1's low-level joint controllers (block 4828). These signals might be target joint positions, velocities, or potentially feedforward torques calculated from the desired motion.

In some implementations, the task-space retargeting process 4800 can be performed using or augmented with geometric constraint-based retargeting. This alternative approach shifts focus from strictly mapping a single end-effector pose to maintaining a set of desired geometric relationships between different parts of the humanoid robot 1, the operator, or the environment. Instead of solely solving FK(θ_{robot})=T_{target}, the goal becomes finding robot that satisfies or minimizes the violation of multiple geometric constraints simultaneously. These constraints can include, but are not limited to: absolute poses (specific points or frames on the humanoid robot 1 should reach specific world coordinates, similar to standard IK); relative poses (the distance or relative orientation between two points or frames on the humanoid robot 1 should match a target value, e.g., keeping hands a certain distance apart or maintaining a specific tool orientation relative to the wrist); point-line/point-plane constraints (a point on the humanoid robot 1 should remain on a specific line or plane in the environment, e.g., keeping a foot flat on the floor or ensuring a hand slides along a tabletop); orientation constraints (a specific axis of a robot link should point towards a target object or align with a world axis); gaze constraints (directing the humanoid robot 1's head 10 or camera towards a point of interest); and center of mass (COM) constraints (positioning the humanoid robot 1's COM over its support base for balance).

This type of retargeting is often formulated as an optimization problem:

$$min {θ}_{robot} {\sum }_{i} {w}_{i} {C}_{i} ( {θ}_{robot} )$$

where Cᵢ (θ_{robot}) is a cost function measuring the violation of the i-th geometric constraint (e.g., squared distance error from a target position, squared orientation error), and wᵢ is a weight determining the relative importance of satisfying that constraint. Additional inequality or equality constraints (e.g., joint limits, collision avoidance) are typically included. Frameworks like Relationship Keypoint Constraints (ReKep) provide systematic ways to define various types of geometric constraints between keypoints on the humanoid robot 1, the operator, and the environment. They facilitate solving the resulting optimization problem, often using numerical optimization methods like Sequential Quadratic Programming (SQP) or gradient descent-based techniques. Advantageously, this constraint-based approach can produce more natural-looking or functionally relevant motions, especially for complex tasks involving multiple contact points (like humanoid locomotion) or intricate tool use, compared to single end-effector IK. This approach can also handle kinematic differences between the operator and the humanoid robot 1 more gracefully by focusing on achieving functional equivalence (maintaining key relationships) rather than exact pose replication. Moreover, this approach is particularly useful for controlling complex robots like humanoid robots 1 or dual-arm systems where coordinating multiple limbs and maintaining balance are crucial. That said, defining the appropriate set of constraints and tuning their relative weights (wt) can require significant task-specific knowledge and careful adjustment. The resulting optimization problem can be complex and computationally expensive to solve, potentially limiting real-time performance depending on the number of constraints and the chosen solver.
iii. Hybrid and Optimization-Based Space Retargeting

FIGS. 24A and 24B depict a flowchart of a process 4900 for hybrid and optimization-based space retargeting to map human data to robot control data. Hybrid and optimization-based motion retargeting strategies represent a sophisticated and potentially powerful paradigm for controlling robots via human operators or motion references. These approaches move beyond simpler direct mapping techniques by formulating the retargeting challenge as a constrained optimization problem. Under these approaches, robot control data or robot data (e.g., joint angles, velocities, or accelerations) is found that optimally balances multiple, often conflicting, objectives while adhering to the humanoid robot 1's physical limitations and environmental constraints. The need for such methods stems from the inherent complexity of mapping human motion onto potentially dissimilar robot kinematics and dynamics, especially for intricate tasks performed in potentially cluttered or dynamic environments. Key motivations for using these advanced methods include enhancing task success, improving naturalness and intuitiveness of control, and ensuring safety and physical feasibility. Task success involves ensuring the humanoid robot 1 achieves the primary goal implied by the operator's action (e.g., reaching a specific target location, manipulating an object correctly), which often requires precise control, frequently defined in task space (related to end-effectors or key body points). Naturalness and intuitiveness involve potentially mimicking the operator's posture and movement style to some degree (implying joint space similarity). This can lead to more predictable and natural-looking robot motions, potentially enhancing the operator's sense of embodiment or control fidelity. Safety and feasibility involve ensuring the humanoid robot 1 operates strictly within its physical capabilities (e.g., joint position limits, velocity limits, torque limits) and avoids collisions (self-collisions between links, collisions with the environment) while maintaining stability (e.g., balance for legged robots). This hybrid structure combines robust kinematics with dynamic compliance.

The process 4900 can be performed by the computer 3110. In some implementations, the process 4900 can be performed by processors integral to the humanoid robot 1. For illustrative purposes, the process 4900 is described from the perspective of the computer 3110. The process 4900 may be invoked by the selector module of the retargeting framework when the active sub-scheme of the mapping prioritization scheme 4500 indicates that the humanoid robot 1 is operating under simultaneous task-space and joint-space objectives subject to physical-feasibility constraints. The computational structure of process 4900 admits a configurable solver back-end that ranges from quadratic-programming for instantaneous control formulations to nonlinear-programming for trajectory-optimization formulations as further detailed in subsequent paragraphs.

Referring to the process 4900 in both FIGS. 24A and 24B, the computer 3110 receives sensor data in block 4902. The sensor data received at block 4902 may originate from any of the sensor modalities described herein, including the joint encoders 3211, 3212, 3213 of the articulated arm linkage 3300, the wrist IMU 3220, the torso IMU 3224, the hand sensors 3410 of the glove 3400, the magnetic-field sensors of the alternative wearable training apparatus 3401, or any combination thereof. The computer 3110 places the received sensor data into a buffered representation that maintains time alignment across modalities, and the buffered representation is consumed by subsequent blocks of process 4900 as the basis for cost-function evaluation and constraint evaluation.

Optionally, the computer 3110 may infer operator intent based on applying rule-based methods, statistical models, or machine learning techniques to the sensor data and potentially contextual information (block 4904). Leveraging human intent estimation within process 4900 allows the humanoid robot data collection system 3010 to move beyond raw pose mimicry towards goal-directed behavior. Probabilistic models or machine learning classifiers can predict the operator's high-level objective (e.g., reach, walk, grasp, gesture type) from observed motion patterns, gaze direction (if available), or task context. The cost function weights (wᵢ) or specific task targets within the optimization can be adaptively adjusted based on the inferred intent. For example, the weight associated with hand tracking accuracy might increase if a ‘reach-to-grasp’ intent is inferred. Sometimes, the computer 3110 can trigger pre-defined autonomous subroutines or behaviors (e.g., executing a learned autonomous grasp sequence) based on the inferred intent, potentially managed or constrained within the broader optimization framework described herein.

In block 4906, the computer 3110 processes the raw sensor data to extract relevant information, such as target end-effector poses (task-space references) and/or reference joint postures (joint-space references). This may involve kinematic calculations based on sensor readings. The kinematic calculations performed at block 4906 may comprise a forward-kinematics evaluation along the operator's arm chain using the joint encoders 3211, 3212, 3213 of the articulated arm linkage 3300 to recover wrist pose, a magnetic-inertial pose estimation along the operator's wrist using the magnetic-field sensors and the wrist IMU 3220 of the alternative wearable training apparatus 3401 when the alternative wearable training apparatus 3401 is the active source, and a per-finger pose extraction from the hand sensors 3410 of the glove 3400 to populate the per-finger task-space targets used by the cost function. Block 4906 produces a unified target representation comprising end-effector targets, per-finger targets, and reference joint angles, all expressed in the humanoid robot 1's base frame.

The computer 3110 also defines a cost function (or objective function) J designed to quantify the quality or desirability of a potential robot control data (block 4908). This cost function typically incorporates multiple terms representing different objectives, potentially including task-space error (block 4910), joint-space error (block 4912), posture similarity metrics (block 4914), regularization terms (block 4916), and/or any combination thereof. The computer 3110 defines the cost function J, which quantifies the desirability of the humanoid robot 1's state or motion based on these multiple objectives. It is typically structured as a weighted sum of several component cost terms: J=Σᵢ wᵢJᵢ, where each Jᵢ represents a specific objective and the weights wi determine the relative importance or trade-off between these objectives. Tuning these weights wᵢ is often application-specific or even dynamically adjusted based on context or intent, and the weights wi are sourced from the active sub-scheme of the mapping prioritization scheme 4500 such that the within-hand finger ordering middle>index>ring>little is reflected in the per-finger components of Jtask.

The task-space error term (Jtask) penalizes deviations of the robot 1's actual end-effector pose(s) from the desired target pose(s) derived from the operator motion. It commonly includes a position error component (often measured as ∥p_{robot} (θ_{robot})−p_{target}∥, the squared Euclidean distance) and/or an orientation error component (measured using rotation metrics like the angle extracted from an axis-angle representation or distances derived from quaternion representations, e.g., ∥log(R_{target} TR_{robot} (θ_{robot}))∥. Multiple end-effectors or key points may be included.

Another potential component is a joint-space error term (Jⱼₒᵢₙₜ), which encourages similarity between the humanoid robot 1's joint configuration and a reference configuration, possibly derived directly from the human pose (∥θ_{robot}−θ_{ref}∥²). This helps in mimicking posture when desired. The reference configuration θref used by Jjoint in some embodiments is the operator's joint configuration after kinematic retargeting through the process 4700, by which Jjoint couples the hybrid optimization to the joint-space methodology and provides a posture-mimicking pull on the optimizer's solution while the task-space term Jtask continues to enforce end-effector accuracy. The relative weighting between Jjoint and Jtask governs the trade-off between posture fidelity and end-effector precision and is selected by the active sub-scheme of the mapping prioritization scheme 4500.

Posture similarity terms (/posture) can employ more sophisticated metrics to preserve aspects of the operator's movement style beyond simple joint angle matching. Examples include feature matching (penalizing differences in relative body part positions or orientations), shape matching (comparing distributions of key points on the body, perhaps using techniques like Gaussian Mixture Models (GMMs)), or center of mass (COM) tracking (penalizing deviation between the humanoid robot 1's COM position and a reference COM derived from the operator, potentially scaled).

Regularization terms (Jregularize) are often included to encourage desirable properties for the resulting robot control data, independent of the operator's input. Examples include promoting smoothness (by penalizing high joint velocities ∥\dot{θ}_{robot}∥², accelerations ∥\ddot{θ}_{robot}∥², or jerk ∥\ddot{θ}_{robot}∥²), encouraging effort minimization (by penalizing high joint torques ∥τ_{robot}∥² or estimated power consumption), promoting minimal displacement (by penalizing deviations from a preferred resting or neutral posture ∥θ_{robot}−θᵣₑₛₜ∥²), or encouraging configurations far from joint limits or singularities.

In parallel with defining the cost function, the computer 3110 sets constraints that define the mandatory bounds within which the humanoid robot 1 must operate (block 4918). These represent hard limits that cannot be violated by the optimized solution. Examples include robot physical limits (block 4920), collision avoidance constraints (block 4922), balance and stability constraints (block 4924), contact constraints (block 4926), and/or any combination thereof. This method ensures compliance.

Robot limits typically include constraints on joint positions, velocities, accelerations, and/or torques/forces exerted by actuators. Mathematically, these are often expressed as box constraints: θₘᵢₙ≤θ_{robot}≤θₘₐₓ, \dot{θ}ₘᵢₙ≤\dot{θ}_{robot}≤\dot{θ}ₘₐₓ, \ddot{θ}ₘᵢₙ≤\ddot{θ}_{robot}≤\ddot{θ}ₘₐₓ, and τₘᵢₙ≤τ_{robot}≤τₘₐₓ. Collision avoidance constraints prevent collisions between different parts of the humanoid robot 1 (self-collision) and between the humanoid robot 1 and its environment. These are often formulated as inequality constraints requiring the distance between potentially colliding pairs of objects (represented by primitive shapes like spheres, capsules, or meshes) to be greater than a minimum safety margin: distance (linkᵢ, linkᵢ)≥safety_margin or distance (linkᵢ, obstacleₖ)≥safety_margin. Collision checking requires geometric models of the humanoid robot 1 and the environment.

Balance and stability constraints are crucial for legged robots (like humanoids) to prevent falling. Common approaches include Zero Moment Point (ZMP) constraints, which require the ZMP (a point on the ground where the net moment due to gravity and inertia is zero) to remain within the support polygon (the convex hull of the ground contact points). Other dynamic stability criteria involving the Center of Mass (COM) trajectory or the Capture Point may also be used. The ZMP constraint can be expressed mathematically as ZMP (θ, \dot{θ}, \ddot{θ})∈Support_Polygon. Calculating the ZMP requires knowledge of the humanoid robot 1's dynamics. Contact constraints model the humanoid robot 1's interaction with the environment, such as feet placed on the ground or hands manipulating objects. For fixed contacts (like feet during a stance phase), equality constraints (H_{contact} (θ_{robot})=0) can enforce a specific pose for the contact point or frame. Force constraints ensure that contact forces (Fc) are physically realistic, for example, remaining within the friction cone defined by the contact surface and coefficient of friction (∥F_{tangential}∥≤μFₙₒᵣₘₐₗ). They might also enforce specific force requirements for manipulation tasks.

Next, the computer 3110 can determine an optimization framework based on the cost function and the constraints in block 4928. The problem can be generally structured as finding the humanoid robot 1's joint configuration trajectory θ_{robot} (t) or instantaneous state (e.g., velocity \dot{θ}_{robot} or acceleration \ddot{θ}_{robot}) that minimizes a cost function J subject to equality constraints H and inequality constraints C:

θ_{robot} min J(θ_{robot})

Subject to: C(θ_{robot})≤0 (Inequality Constraints), and H(θ_{robot})=0 (Equality Constraints).

This optimization problem can be solved using various numerical optimization methods, depending on its specific mathematical structure. Common choices include: Quadratic Programming (QP) solvers if the cost function is quadratic and the constraints are linear (often used in instantaneous control formulations); Sequential Quadratic Programming (SQP) for problems with nonlinear constraints but where the problem can be iteratively approximated by QPs; general Nonlinear Programming (NLP) solvers for problems involving more complex nonlinear cost functions, dynamics, and/or constraints (often used in trajectory optimization); and sometimes specialized solvers derived from IK methods (like DLS or LM) if the problem primarily focuses on kinematic targets. Example QP solvers include OSQP, qpOASES, PROXQP, and others, often optimized for speed in real-time applications. Example NLP solvers or frameworks include CasADi (which facilitates symbolic definition and solution of optimization problems), Ceres Solver, SNOPT, IPOPT, and G20 (often used in SLAM and bundle adjustment but applicable here). Other solvers, including specialized IK solvers (DLS, LM, etc.) may be adapted or used within parts of the optimization framework. To meet real-time requirements, especially for high-DoF robots or complex problems, techniques like hardware acceleration (using GPUs or specialized processors), automatic code generation for the optimization problem, and the use of reduced-order models (simplifying robot dynamics or kinematics) may be employed.

Integration with machine learning can also enhance performance or capabilities. For instance, Inverse Reinforcement Learning (IRL) or imitation learning could potentially be used to learn suitable cost function weights (wᵢ) from demonstrations of desired operator-humanoid robot 1 interactions. Neural networks could be trained to approximate complex robot 1—environment dynamics or predict constraint activations, potentially speeding up parts of the optimization. Imitation learning techniques might provide good initial guesses (‘warm starts’) for the optimization solver, accelerating convergence, or even learn direct control policies that approximate the output of the optimization, although ensuring constraint satisfaction with pure learning policies can be challenging.

In block 4930, the computer 3110 often incorporates the humanoid robot 1's physical (dynamic) model into the optimization framework, especially when dealing with balance, forces, or fast motions. Incorporating the humanoid robot 1's equations of motion, often written as M(θ)\ddot{θ}+C(θ,\dot{θ})\dot{θ}+G(θ)=τ+J_{c}TF_{c}, where M is the mass matrix, C contains Coriolis and centrifugal terms, G is gravity, t are joint torques, J_{c} is the contact Jacobian, and Fc are contact forces, can be crucial for achieving physical realism and dynamic feasibility. Robot dynamics can appear in the cost function, for example, by minimizing joint torques (∥τ∥²) or contact impact forces. Robot dynamics often appear in the constraints, for example, by enforcing torque limits (τₘᵢₙ≤τ≤τₘₐₓ), ensuring dynamic balance (ZMP/COM constraints are inherently dynamic as they depend on θ\ddot{ }), or enforcing friction cone limits for calculated contact forces (Fc). Whole-Body Control (WBC) refers to control frameworks, often implemented using optimization (e.g., QP at the acceleration or torque level), that simultaneously solve for joint accelerations or torques considering kinematics, dynamics, and contacts across the entire robot body, typically in real-time. Process 4900 can be implemented as part of a WBC framework.

Then, the computer 3110 executes the chosen optimization framework to compute the optimal robot state or trajectory (e.g., joint positions, velocities, and/or accelerations) that minimizes the cost function while satisfying all constraints (block 4932). Depending on the application's real-time needs and complexity, the optimization framework can be solved at different timescales or levels. One timescale is instantaneous control (velocity or acceleration level). Here, the optimization solves for the optimal joint velocities (θ_{robot}) or accelerations (\ddot{θ}_{robot}) at each control cycle (e.g., every 1-10 milliseconds). This approach is highly reactive to changes in human operator 2/sensor input and environmental conditions. It is fast, often formulated as a QP for speed, and useful for tasks like disturbance rejection or tracking fast motions. However, without proper formulation or regularization, it may lead to less smooth motion or potentially drift into infeasible states over time.

Another approach is trajectory optimization (planning over a horizon). This involves planning an entire trajectory (e.g., θ(t), \dot{θ}(t), \ddot{θ}(t)) over a future time interval (7) that minimizes the integral of the cost function over that horizon. Advantageously, this approach can produce smoother, more globally optimal motions and is better suited for complex maneuvers requiring anticipation (e.g., navigating obstacles, complex locomotion patterns). Sometimes, this approach can be computationally expensive, making it less suitable for highly reactive scenarios, and requires predicting future states or references. This approach typically uses NLP techniques and often involves parameterizing the trajectory using basis functions like splines or polynomials.

A third approach, Model Predictive Control (MPC), acts as a hybrid. It optimizes a trajectory over a relatively short, receding future horizon at each time step, executes only the first part of the planned trajectory, observes the new state, and then re-plans from that new state for the next horizon. Advantageously, MPC aims to combine the benefits of trajectory planning (anticipation, smoothness) with real-time reactivity to disturbances and changes in the environment or reference signal. At each control step, MPC optimizes a trajectory over a defined prediction horizon, applies the initial control input(s) from that trajectory, and repeats the process based on the updated state information. It often involves solving an NLP or QP at each step.

The computer 3110 converts the output from the optimization framework (which might be target positions, velocities, accelerations, or torques) into low-level control signals suitable for the humanoid robot 1's actuators (block 4934). This might involve deriving target joint angles via integration if accelerations were computed (block 4936), calculating necessary feedforward torques based on dynamics (block 4938), or simply passing target velocities or positions to underlying joint controllers.

The computer 3110 then returns these low-level control signals to the robot controller(s) for execution (block 4940).

In some implementations dealing with frequent or complex contact, the computer 3110 can implement advanced contact handling strategies to manage contact transitions and forces robustly (optional block, related to 4926, 4930). This may involve detailed contact modeling, representing contacts not just as points but potentially as surfaces, using accurate friction cone models (possibly linearized for QP formulations), or employing soft contact models (e.g., using virtual springs and dampers) to improve numerical stability during contact establishment or breaking. Including contact forces (Fc) explicitly as decision variables in the optimization problem allows for direct reasoning about and control over force distribution, essential for tasks like stable locomotion or dexterous manipulation. For tasks involving planned sequences of contact changes (e.g., multi-contact locomotion like walking or climbing), techniques involving contact sequencing or mode scheduling may be used. This might involve planning the discrete sequence of making and breaking contacts (e.g., footstep planning for walking) separately or integrating this discrete logic within a hybrid optimization framework that combines continuous motion optimization with discrete mode switching.

In some implementations, the computer 3110 can incorporate methods to handle uncertainty in the process 4900, recognizing that real-world operation involves sensor noise, inaccuracies in robot 1 or environment models, and unpredictable external factors (optional block). For example, robust optimization techniques might be used to find solutions that remain feasible and perform well across a defined range of potential uncertainties in parameters or disturbances. Stochastic optimization could model uncertainties probabilistically and optimize expected performance. Feedback control loops (e.g., underlying PID controllers at the joint level, or higher-level feedback based on task errors) work alongside the optimizer to correct deviations from the planned motion. The optimizer often provides feedforward commands, while feedback control handles residual errors and unmodeled effects. Accurate state estimation is crucial. Using high-fidelity state estimation techniques (e.g., Extended Kalman Filters, Unscented Kalman Filters, particle filters that fuse data from multiple sensors like IMUs 3224, joint encoders 1067, vision systems 1068, contact sensors 1066) provides the optimizer with the most accurate possible information about the humanoid robot 1's current state, improving performance and robustness.

iv. Learning-Based Retargeting

### 1. Learning-Based Retargeting

FIG. 25 is a flowchart of a process 5000 for training a model to perform learning-based retargeting. This involves using machine learning techniques to learn the mapping from human data to robot control data. The process 5000 can be performed by the computer 3110. In some implementations, the process 5000 can be performed by processors integral to the humanoid robot 1, or offline on separate computing hardware. For illustrative purposes, the process 5000 is described from the perspective of the computer 3110.

Referring to the process 5000 in FIG. 25, the computer 3110 receives or acquires sensor data relevant for training in block 5002. This data typically represents human data (e.g., poses, joint angles, trajectories) and corresponding desired or actual robot control data (e.g., joint angles, end-effector poses, torques). The data may be paired sensor data (block 5004), where each human motion segment has a corresponding target robot control data segment, or unpaired sensor data (block 5006), consisting of separate collections of human motions and robot control data without direct correspondence, or a combination thereof. The data ideally represents a wide range of motions relevant to the intended application. Sometimes, the computer 3110 can preprocess or enhance the received data by performing time alignment between human and robot streams, applying noise filtering, segmenting the data, normalizing features, or simulating physical constraints relevant to the operator and/or the humanoid robot 1. This approach facilitates accurate capture routines.

A potential bottleneck in learning-based retargeting is acquiring large-scale, high-fidelity, accurately time-synchronized datasets of paired sensor and robot control data that effectively demonstrate the desired retargeting behavior, especially for complex robots or tasks. Challenges include: collecting expert demonstrations directly on the humanoid robot 1 can be time-consuming, expensive, and potentially hazardous; having humans attempt to generate motions perfectly suitable for a humanoid robot 1's different kinematics or dynamics can be unnatural and difficult; ensuring precise temporal alignment between human motion capture data and robot execution data can be non-trivial; and safety concerns may limit the types or speeds of motions recordable using physical hardware. To help address this data acquisition bottleneck, the computer 3110 can utilize simulations to generate synthetic paired data. Physics simulators allow for the generation of large datasets by simulating both the human (or a reference kinematic model) and the humanoid robot 1 within a virtual environment. This approach introduces a potential “sim-to-real” gap, where models trained purely on simulation may not perform identically on the physical humanoid robot 1 due to modeling inaccuracies.

To address the sim-to-real gap or improve physical realism, the computer 3110 can incorporate the humanoid robot 1's known kinematic structure (e.g., using forward kinematics layers) or differentiable physics models directly within the neural network architecture or training process. This can constrain the model's output space to be more physically plausible, potentially improve sample efficiency during training, and help guarantee kinematically or dynamically valid outputs to some extent. Sometimes, to address the need for paired data, the computer 3110 can employ reverse mapping techniques. It may be easier to learn the robot-to-human mapping (e.g., predicting human-like motion from robot control data, perhaps using simulation data where robot control is easier), and then use this learned mapping in conjunction with other techniques (like cycle consistency) to help learn the desired human-to-robot mapping. Domain adaptation and transfer learning techniques offer another approach to address the data bottleneck or sim-to-real gap. For example, the computer 3110 can pre-train a model extensively on abundant simulation data and then use techniques like fine-tuning, adversarial domain adaptation, or system identification to adapt the model to the real humanoid robot 1 using a smaller amount of real-world data. Sometimes, the computer 3110 can mitigate the bottleneck by structuring the learning problem around motion primitives or libraries. Instead of learning mappings for entire long, complex sequences, the humanoid robot data collection system 3010 learns mappings for shorter, reusable motion segments (primitives), which can then be sequenced or combined. This may require less diverse training data for each primitive.

In block 5008, the computer 3110 selects a preferred learning approach based on data availability, task requirements, and desired model capabilities. Example approaches include supervised learning (block 5010), unsupervised or semi-supervised learning (block 5012), reinforcement learning (RL) (block 5014), imitation learning (often a subset of supervised or reinforcement learning), and/or combinations thereof. Supervised learning involves training a model to directly predict the target robot control data (y, e.g., robot joint angles θ_{robot} or end-effector poses T_{robot}) given the input human motion (x, e.g., human joint angles θₕᵤₘₐₙ or keypoint poses Tₕᵤₘₐₙ) using a dataset of labeled, paired examples ((xᵢ,yᵢ)). The model, parameterized by φ, learns a function fφ:x↔y by minimizing a loss function (e.g., Mean Squared Error (MSE), Mean Absolute Error (MAE)) that measures the difference between the predicted robot control data fφ(xᵢ) and the ground-truth robot control data yi over the training dataset. Often, the most effective solutions combine elements from different approaches. For example, one might use supervised learning for an initial kinematic mapping, followed by reinforcement learning for dynamic refinement, contact handling, and constraint enforcement. One could incorporate kinematic layers or differentiable physics within supervised learning models. Alternatively, outputs from geometric or kinematic retargeting methods (like those in process 4700 or 4800) could be used as part of the state input or reward function for an RL policy. Other hybrid approaches are also possible, such as using RL to generate better training data for a supervised policy.

Supervised learning (block 5010) trains a model directly on paired (human data, corresponding robot control data) data. Its success depends heavily on the quality and coverage of the paired dataset. Unsupervised or semi-supervised learning (block 5012) aims to reduce the requirement for large amounts of perfectly paired data by leveraging potentially larger datasets of unpaired human motion and unpaired robot control data. These unpaired datasets might be easier to collect (e.g., from human motion capture databases and robot self-exploration data). Reinforcement learning (block 5014) leverages reward-based learning, often in simulation, to train a robot control policy to imitate human motion characteristics or achieve tasks specified by human motion, while respecting dynamics and constraints.

More particularly, unsupervised and semi-supervised learning approaches reduce the need for paired data. Cycle-consistency techniques can be used to learn two mapping functions simultaneously: GH→R (Human to Robot) and GR→H (Robot to Human). This approach utilizes unpaired data from both domains (human motion xhuman, robot control data xrobot) and enforces cycle-consistency losses: requiring that mapping a motion from one domain to the other and back again should result in the original motion, i.e., GR→H(GH→R(xₕᵤₘₐₙ))≈xₕᵤₘₐₙ and GH→R (GR→H(x_{robot}))≈x_{robot}. Adversarial losses are often used in conjunction to ensure that the generated motions in each domain are indistinguishable from real motions in that domain, encouraging realistic outputs. Another related technique is adversarial domain adaptation, where a generator (GH→R) is trained alongside a discriminator. The discriminator attempts to distinguish between real robot control data and robot control data generated by mapping human data. The generator is trained to “fool” the discriminator, thereby learning to produce robot control data that match the statistical distribution of real robot control data, even without direct paired examples. Sometimes, shared latent spaces can be learned. Models like Autoencoders (AEs) or Variational Autoencoders (VAEs) can be trained to learn encoder functions that map both human data and robot control data into a common, structured latent space z. The goal is that similar motions, regardless of the source morphology (human or humanoid robot 1), are mapped to nearby points in this shared latent space. Retargeting can then potentially be achieved by encoding an input human motion into the latent space (z=Encoderₕᵤₘₐₙ (xₕᵤₘₐₙ)) and then decoding it into the robot domain (y_{robot}=Decoder_{robot} (z)). Achieving proper alignment and structure in these shared latent spaces often requires some form of weak supervision, architectural constraints, or specific assumptions about motion correspondence.

With reinforcement learning approaches (block 5014), retargeting is often framed as a sequential decision-making or control problem. An RL agent learns a policy π(aₜ|sₜ) that selects robot actions at (e.g., target joint torque commands, target joint angles or velocities, or end-effector velocity commands) based on the current state sₜ. The state sₜ typically includes the humanoid robot 1's own state (e.g., joint positions/velocities θ_{robot}, \dot{θ}_{robot}) and potentially information about the reference human motion (e.g., current human pose θₕᵤₘₐₙ, recent human motion history). The policy x is optimized (e.g., by adjusting the parameters of a neural network representing the policy) to maximize a cumulative reward signal received over time, typically reflecting how well the humanoid robot 1 is achieving the desired retargeting goal. Common RL algorithms include Proximal Policy Optimization (PPO), Soft Actor-Critic (SAC), Deep Deterministic Policy Gradient (DDPG), and others. In comparison to supervised learning, RL focuses on learning behavior through trial-and-error interaction (often within a simulator) to optimize a defined objective (the reward function), rather than just mimicking input-output pairs from a fixed dataset. This inherent interaction with a (simulated) environment allows RL to naturally account for robot dynamics, contact forces, stability requirements, and environmental interactions when learning the control policy. The design of the reward function R(sₜ,aₜ) is crucial for the success and accuracy of RL-based retargeting.

The reward function typically includes multiple components, such as: an imitation reward (measuring how closely the humanoid robot 1's state—e.g., joint angles, end-effector pose, center of mass-matches corresponding features from the reference human motion, potentially after kinematic retargeting); a task reward (providing a bonus for achieving specific task-level goals like reaching a target, successfully grasping an object, or avoiding designated obstacles); physical plausibility penalties (assigning negative rewards for undesirable behaviors like self-collisions, exceeding joint limits, commanding excessive joint torques/velocities/accelerations, falling over (for legged robots), or producing overly jerky motion); energy/efficiency terms (penalizing high energy consumption, often approximated by squared joint torques or velocities); and potentially style rewards (encouraging specific desired motion characteristics like smoothness or resemblance to a particular style). Careful weighting of these components is necessary.

RL approaches often require a large number of interaction steps (millions or more) for the policy to converge, making training directly on physical robots typically impractical and potentially unsafe due to the exploratory nature of learning. Training is therefore typically performed in simulation. Bridging the resulting sim-to-real gap is a significant challenge. Common techniques to address this include: system identification (building more accurate simulation models of the humanoid robot 1 and environment); domain randomization (training the RL policy across a wide distribution of simulated physical parameters like masses, friction coefficients, actuator delays, sensor noise to make the learned policy robust to variations); and domain adaptation techniques (further adapting the simulation-trained policy using a limited amount of real-world data, potentially through fine-tuning or other methods). Sim-to-data pipelines represent a hybrid approach leveraging RL in simulation primarily for data generation or filtering. In one variant, an RL policy is trained in simulation with the objective of tracking reference human data as closely as possible while satisfying all physical constraints. This trained RL policy is then used to process a large data set of human data; only those human data that the simulated robot policy can successfully track (while remaining dynamically stable and respecting constraints) are retained. This process results in a high-quality, dynamically-feasible dataset of paired {human motion, successful corresponding robot control data} examples. This curated dataset can then be used to train a potentially simpler, faster, or more data-efficient supervised imitation learning policy (e.g., Behavior Cloning) suitable for deployment on the real humanoid robot 1. Advantageously, RL (or RL-assisted) approaches allow the humanoid robot data collection system 3010 to generate dynamically feasible and physically realistic motions, inherently handle constraints, and optimize directly for task objectives. They are particularly powerful for complex robots (e.g., humanoid robots 1, quadrupeds) and tasks involving significant environmental interaction or contact dynamics.

Based on the selected learning approach (supervised, unsupervised, RL, etc.) and using the prepared data, the computer 3110 trains a suitable machine learning model (block 5016). The choice of model architecture depends on the nature of the data (static poses vs. sequences) and the complexity of the mapping. Potential architectures include: Multi-Layer Perceptrons (MLPs) for static mapping (block 5018); Recurrent Neural Networks (RNNs) (block 5020) including Long Short-Term Memory (LSTM) units (block 5022) or Gated Recurrent Units (GRUs) for sequential data; Transformer networks for sequences, potentially capturing long-range dependencies (block 5024); Autoencoders (AEs) or Variational Autoencoders (VAEs) for learning shared latent motion representations (block 5026); specialized network architectures incorporating kinematic or physics priors; or neural networks representing policies or value functions in RL settings (block 5028). Graph Neural Networks (GNNs) may also be applicable, representing the humanoid robot 1/human structure as a graph. MLPs can learn static mappings, for instance, mapping a single human pose vector to a single robot pose vector. They are often used frame-by-frame but lack inherent memory of past states. RNNs, LSTMs, and GRUs are designed for sequential data like motion trajectories. These models process motion sequences frame-by-frame while maintaining an internal hidden state that summarizes past information, allowing them to capture temporal dependencies and generate smoother, more context-aware output sequences. Input to such recurrent models is typically a sequence of human poses or joint angles over time, and the output is a corresponding sequence of robot joint angles, velocities, or commands. Sometimes, Convolutional Neural Networks (CNNs), particularly temporal CNNs (TCNs), may be applied, especially if motion is represented in a grid-like structure (e.g., spatially across joints over time, or temporally over a fixed window). They excel at capturing local spatio-temporal features. Transformer models, originally developed for natural language processing, have also shown promise for sequence modeling tasks like motion generation due to their self-attention mechanism. This mechanism allows them to directly model relationships and dependencies between distant frames in a sequence without the potential vanishing gradient issues of simple RNNs. Transformers can potentially model complex relationships across long motion capture sequences effectively. AEs and VAEs, while often used for dimensionality reduction, representation learning, or generative tasks, can be adapted for retargeting, particularly in unsupervised or semi-supervised settings aiming to learn shared latent spaces (as discussed in block 5012). An ΔE learns an encoder to map motion to a compressed latent representation and a decoder to reconstruct motion from the latent representation. By training encoders for both human and robot control data into a shared latent space and corresponding decoders, retargeting might be achieved via encoding and cross-domain decoding. VAEs add a probabilistic structure to the latent space, modeling it as a distribution (typically Gaussian). This allows for sampling from the latent space to generate variations of motions and can enforce better structure.

To train the selected model, the computer 3110 defines the input features (e.g., operator joint angles, velocities, keypoint positions, potentially torques or EMG signals) (block 5030), defines the target output features (e.g., robot joint angles, velocities, torques, end-effector poses) (block 5032), and executes the training process based on the chosen learning paradigm. This involves iteratively adjusting the model parameters (weights ø) by minimizing a loss function (for supervised learning), maximizing a reward signal (for reinforcement learning), enforcing structural constraints like cycle-consistency (for unsupervised learning), or employing combinations thereof. Minimizing loss typically involves backpropagation and gradient descent (or variants like Adam optimizer) using losses like MSE or MAE for supervised regression tasks. Maximizing rewards in RL involves algorithms that estimate value functions or policy gradients to update the policy network. Enforcing structure in unsupervised learning might involve complex loss functions combining reconstruction losses, adversarial losses, and consistency losses.

After initial training, the computer 3110 performs a model validation process using unseen human data (a separate validation dataset) to evaluate the model's generalization performance (block 5036). During validation and subsequent testing, the computer 3110 measures and assesses performance using relevant metrics, which might include: accuracy (e.g., root mean squared error (RMSE) between predicted and ground truth robot control data for supervised learning), smoothness of generated motion (e.g., measuring jerk), task success rate (if applicable), physical feasibility (e.g., checking for joint limit violations, self-collisions, stability in simulation or on the real humanoid robot 1), computational inference time, and qualitative assessment of motion naturalness. The desired level of model accuracy and performance is determined based on the specific application requirements and use case. The model can be further refined through techniques like hyperparameter tuning, adjusting the architecture, collecting more or better data, or iterative training based on the results observed during the validation process. This continues until a desired level of performance is achieved.

Once the desired level of model accuracy and performance is achieved according to the validation metrics, the computer 3110 can save and return the trained model parameters φ for deployment, enabling it to predict robot control data commands from real-time human data (block 5038). The process 5000 can then conclude. The trained model is now ready for runtime use (as in process 5050) to generate outputs such as target joint commands, target end-effector poses (which might then be fed into an IK solver), desired joint angles, or direct velocity or torque commands for low-level robot control.

Optionally, the computer 3110 can also incorporate mechanisms to further refine the model based on feedback loops during or after deployment (block 5040). For example, during real-time execution, safety checks using sensors (e.g., proximity sensors 1069, force sensors 1070) can monitor the execution and potentially intervene or modify the model's output to prevent unsafe behavior. Simple feedback controllers (e.g., PID controllers operating on the error between commanded and actual state) or filters might run in parallel with the learned model to further refine the predicted motion or compensate for small errors. Likewise, the computer 3110 could potentially use real-world execution data gathered during deployment to periodically fine-tune or adapt the model (e.g., using transfer learning or online learning techniques) to improve its performance over time or adapt to changing conditions.

### 2. Runtime Use of a Model for Learning-Based Retargeting

FIG. 26 is a flowchart of a process 5050 for utilizing a pre-trained model for learning-based retargeting to map human data to robot control data during runtime operation. This process employs the model trained according to a process similar to process 5000 in FIG. 25. The process 5050 can be performed by the computer 3110, potentially including embedded processors on the humanoid robot 1. For illustrative purposes, the process 5050 is described from the perspective of the computer 3110 performing real-time control. The runtime process 5050 may be invoked by the selector module of the retargeting framework whenever the active sub-scheme of the mapping prioritization scheme 4500 indicates that a learning-based methodology is preferred for the current task-phase label and a corresponding pre-trained parameter set ø is available at the data store 2900. The runtime process 5050 produces robot control data of the same output format as processes 4700, 4800, and 4900, by which the downstream control signal generation in process 4600 is independent of which methodology supplied the robot control data.

Referring to the process 5050 in FIG. 26, the computer 3110 receives sensor data in block 5052, typically in real-time from the active sensor system (e.g., IMUs 3224, motion capture 1063). The computer 3110 retrieves the pre-trained retargeting model (e.g., the learned function fφ) from a data store or local memory in block 5054.

In block 5056, the computer 3110 preprocesses the incoming sensor data (if necessary, e.g., filtering, feature extraction) to match the expected input format of the model, and then provides this processed data as input to the loaded model fφ.

The computer 3110 then receives, as output from the model, the predicted robot control data (block 5058). This output could be, for example, target robot joint angles θ_{robot}, joint velocities \dot{θ}_{robot}, joint torques τ_{robot}, or target end-effector poses Trobot, depending on how the model was trained. The computer 3110 converts the robot control data received from the model into low-level control signals suitable for the humanoid robot 1's actuators in block 5060. This step might be trivial if the model directly outputs low-level commands (like torques), or it might involve integration (if accelerations are output), inverse kinematics (if end-effector poses are output), or formatting commands for specific joint controllers (if joint positions or velocities are output). Optional post-processing, filtering, or safety checks may also occur here. Accordingly, the computer 3110 returns the generated low-level control signals to the appropriate robot controller(s) for execution by the humanoid robot 1's actuators in block 5062, thereby causing the humanoid robot 1 to move in a way derived from the operator's motion via the learned mapping. This loop (blocks 5052-5062) typically repeats at the control frequency of the system.

### H. ALTERNATIVE EMBODIMENTS

Alternative prioritization schemes in the mapping prioritization scheme 4500 may include context-aware switching between different pre-defined schemas. For instance, the humanoid robot data collection system 3010 may automatically switch from a manipulation-focused prioritization to a locomotion-focused prioritization based on environmental cues or inferred task phases. The patent application notes that alternative prioritization schemes may prioritize core stability or foot placement over limb endpoint accuracy for locomotion tasks. The mapping scheme 4500 can also be adjusted based on a particular use case or task context. For example, a manipulation task might prioritize hand and finger movements, while a balancing task might prioritize core and ankle movements. User-configurable prioritization profiles may also be provided, allowing an operator to define custom mapping priorities based on their preference or specific task requirements. Dynamic adjustment of priorities based on task phase or operator intent is also contemplated.

Regarding joint-space retargeting methods, an alternative to direct mapping or scaling may involve using musculoskeletal models of the operator. By estimating muscle activations or joint torques from human motion, a more biomechanically relevant mapping to robot actuator commands may be achieved, potentially preserving more subtle aspects of human movement style. The patent application notes that joint-space retargeting focuses on mimicking the human operator 2's posture and/or movement style such that f(θₕᵤₘₐₙ)=θ_{robot}. While computationally simple, this approach may not guarantee accurate end-effector placement due to kinematic differences. Alternative joint-space mapping methods could involve a function fitting approach to learn a polynomial or other function mapping operator joint angles to robot joint angles based on pre-collected calibration data, or pose-based mapping where canonical operator poses are mapped to corresponding desired robot poses, with interpolation for intermediate poses.

For task-space retargeting, alternative Inverse Kinematics (IK) solvers may include those based on neural networks trained to approximate the IK solution, which could offer speed advantages for complex robots. The document discusses various IK solvers, including analytical IK solvers, numerical iterative IK solvers (often Jacobian-based), and specialized libraries like IKFast, TRAC-IK, Kinematics and Dynamics Library (KDL), and Pinocchio. Furthermore, instead of mapping only end-effector poses, task-space retargeting may be extended to map the motion of multiple key points on the operator's body to corresponding points on the humanoid robot 1, allowing for more holistic posture matching in task space. This aligns with geometric constraint-based retargeting, which can maintain a set of desired geometric relationships between different parts of the humanoid robot 1, the operator, or the environment, and frameworks like Relationship Keypoint Constraints (ReKep).

In hybrid and optimization-based retargeting, alternative cost function terms may include penalties for deviations from known human motion synergies or biomechanical comfort models, aiming to produce humanoid robot 1 motions that are not only feasible but also perceived as natural or ergonomic by a human observer or operator. The cost function J can incorporate terms for posture similarity metrics, such as feature matching or center of mass (COM) tracking. The optimization framework may also incorporate predictive control strategies that anticipate future operator movements to enable smoother and more proactive humanoid robot 1 responses. This can be achieved through trajectory optimization (planning over a horizon) or Model Predictive Control (MPC). The framework can also incorporate the robot 1's dynamic model M(θ)\ddot{θ}+C(θ,\dot{θ})\dot{θ}+G(θ)=τ+J_{c}TF_{c} and handle advanced contact strategies.

For learning-based retargeting, alternative model architectures may explore generative adversarial networks (GANs) not just for cycle-consistency (as in CycleGAN), but also for generating diverse and realistic humanoid robot 1 motion styles from a given human input. Meta-learning or few-shot learning approaches could be used to quickly adapt a pre-trained retargeting model to new users or new humanoid robot 1 morphologies with minimal additional data. Furthermore, the integration of explainable AI (XAI) techniques could provide insights into how the learned model makes its mapping decisions, which can be valuable for debugging, refinement, and building trust in the humanoid robot data collection system 3010. The patent application details several learning approaches including supervised learning, unsupervised or semi-supervised learning (e.g., using cycle-consistency or shared latent spaces with Autoencoders (AEs) or Variational Autoencoders (VAEs)), and reinforcement learning (RL). Model architectures can include Multi-Layer Perceptrons (MLPs), Recurrent Neural Networks (RNNs) like LSTMs or GRUs, and Transformer networks.

The robot control data may alternatively be represented as a sequence of actions in a learned policy space, where the policy itself (e.g., π(aₜ|sₜ) in RL) is trained to achieve desired outcomes. This can be particularly relevant for tasks requiring complex decision-making beyond direct kinematic mapping. The robot data generated could also include predictive information about the humanoid robot 1's future states (e.g., via trajectory optimization or MPC), which can be used by other systems for planning or safety monitoring. The output from retargeting methods can include robot joint angles, target end-effector poses, joint velocities, or joint torques.

Further modifications may involve the use of different materials for the mobile data collection apparatus 3200 or the alternative wearable training apparatus 3401, such as stretchable electronics or smart fabrics, to enhance operator comfort and reduce encumbrance. The wearable magnetic field-generating apparatus 3416, which creates a localized, time-varying magnetic field 4400 for tracking, could be replaced or supplemented by other non-contact motion capture technologies, such as radar-based systems or advanced computer vision techniques (e.g., optical motion capture systems), to reduce the need for worn sensors. The document mentions that the mobile data collection apparatus 3200 primarily captures sensor data from human data and transfers it, and can be designed to be portable and relatively lightweight.

Improvements to the humanoid robot data collection system 3010 could include adaptive filtering of sensor data where filter parameters are adjusted dynamically based on the characteristics of the motion or the level of noise detected. For instance, a more aggressive filter might be applied during static or slow movements, while a less aggressive filter is used during rapid movements to preserve responsiveness. The document mentions preprocessing sensor data to remove noise or artifacts and smoothing transformed, scaled, and offset target pose data using filters like Kalman filters, moving average filters, Butterworth filters, or spline interpolation techniques. Sensor fusion strategies specific to the mobile data collection apparatus 3200, employing algorithms like complementary filters or Kalman filters, may be implemented to combine data from multiple sensors 3208 effectively.

The concept of mapping prioritization, as described in the mapping prioritization scheme 4500, could be extended to include dynamic weighting of different body parts based on confidence scores from the human motion capture system. If the tracking quality of a particular limb (e.g., from IMUs 3220, 3224 or optical systems) is momentarily low, its influence on the humanoid robot 1's motion could be automatically reduced to prevent erratic behavior. The patent application discusses adjusting the mapping scheme 4500 based on use case or task context and contemplates dynamic adjustment of priorities based on task phase or operator intent. The weights wᵢ in optimization-based retargeting determine the relative importance of objectives and can be dynamically adjusted.

In all retargeting methods, feedback to the operator can be a useful addition. The humanoid robot data collection system 3010 manages this feedback. This feedback could be visual (e.g., displaying the humanoid robot 1's resulting pose overlaid on the operator's view via the optional display 3150 or VR HMD 3152), haptic (e.g., providing force feedback through an exoskeleton or actuators 3520, 3540, 3560 if the humanoid robot 1 encounters constraints or contacts), or auditory (e.g., via speakers in head 10). Such feedback can help the operator understand the mapping and adapt their movements for better control. The actuator control application in the mobile data collection apparatus 3200 is designed to modulate torque output for haptic feedback based on simulated data or direct data from the humanoid robot 1. The humanoid robot data collection system 3010 may also incorporate haptic feedback in the clutch 3140.

### I. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.” It should be understood that any parameter that disclosed a range herein may be set to any value within that range, and/or may set a smaller range within the larger disclosed range. For example, disclosing a range between 10 million and 2 trillion parameters discloses a range from 1 billion to 50 billion parameters. Further, disclosing a range between 100 mHz to 50 Hz discloses a range from 1 Hz to 50 Hz.

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a Delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), wheeled robots with torsos and arms, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A humanoid robot teleoperation system, comprising:
a wearable apparatus configured to be worn by a human operator, the wearable apparatus including at least one operator-side inertial sensor and at least one operator-side rotational position sensor;
a humanoid robot comprising a plurality of actuators, at least one robot-side inertial sensor, and at least one robot-side rotational position sensor; and
one or more processors in data communication with the wearable apparatus and the humanoid robot, the one or more processors configured to derive, from signals received from the wearable apparatus during a teleoperation session, control information for one or more of the plurality of actuators of the humanoid robot, and to store paired data records associating contemporaneous operator-side and robot-side sensor measurements obtained during the teleoperation session,
wherein the at least one operator-side inertial sensor and the at least one robot-side inertial sensor are selected such that signals output thereby exhibit corresponding noise and quantization characteristics, and the at least one operator-side rotational position sensor and the at least one robot-side rotational position sensor are selected such that signals output thereby exhibit corresponding noise and quantization characteristics, whereby the operator-side measurements and the robot-side measurements within the paired data records are drawn from corresponding statistical distributions and are usable as interchangeable training examples for a machine-learning control policy of the humanoid robot.

2. The humanoid robot teleoperation system of claim 1, wherein the at least one operator-side inertial sensor and the at least one robot-side inertial sensor comprise inertial measurement units of the same make and model, and the at least one operator-side rotational position sensor and the at least one robot-side rotational position sensor comprise rotational position sensors of the same make and model.

3. The humanoid robot teleoperation system of claim 1, wherein signals output by the at least one operator-side inertial sensor and the at least one robot-side inertial sensor are sampled at a common sampling rate, and signals output by the at least one operator-side rotational position sensor and the at least one robot-side rotational position sensor are sampled at a common sampling rate.

4. The humanoid robot teleoperation system of claim 1, wherein the wearable apparatus includes a kinematic linkage defining a plurality of operator joints arranged to correspond to a plurality of actuated joints of the humanoid robot, and the at least one operator-side rotational position sensor comprises a respective rotational position sensor disposed at each of the plurality of operator joints.

5. The humanoid robot teleoperation system of claim 1, further comprising at least one operator-side force or torque sensor and at least one robot-side force or torque sensor selected such that signals output thereby exhibit corresponding noise and quantization characteristics, and wherein the paired data records further include force or torque measurements drawn from corresponding statistical distributions.

6. The humanoid robot teleoperation system of claim 1, wherein the wearable apparatus comprises a glove configured to be worn on a hand of the operator and including a plurality of operator-side finger position sensors, and the humanoid robot comprises a robotic hand including a plurality of robot-side finger position sensors selected such that signals output by the operator-side finger position sensors and the robot-side finger position sensors exhibit corresponding noise and quantization characteristics.

7. The humanoid robot teleoperation system of claim 1, wherein the paired data records are stored in a data format configured for use as training examples for a machine-learning policy, the operator-side measurements and the robot-side measurements being interchangeable inputs to the policy by virtue of being drawn from corresponding statistical distributions.

8. The humanoid robot teleoperation system of claim 7, further comprising a machine-learning training subsystem configured to train a control policy for the humanoid robot using both the operator-side measurements and the robot-side measurements as training examples.

9. A humanoid robot teleoperation system, comprising:
a humanoid robot configured to be controlled by a human operator during a teleoperation session, the humanoid robot having a head structure and carrying a stereo camera pair mounted in the head structure, the stereo camera pair comprising a first camera and a second camera;
a stereoscopic display system configured to be viewed by the operator during the teleoperation session and comprising a first display element and a second display element laterally separated to present a horizontally-oriented binocular view to the operator along a display disparity axis; and
image processing circuitry communicatively coupled between the stereo camera pair and the stereoscopic display system and configured to derive, from a first image captured by the first camera and a second image captured by the second camera, a first display image and a second display image arranged for stereoscopic display along the display disparity axis, and to output the first display image and the second display image to the first display element and the second display element so as to provide visual feedback to the operator while the operator controls the humanoid robot,
wherein a capture baseline extending between the first camera and the second camera is non-parallel to the display disparity axis.

10. The humanoid robot teleoperation system of claim 9, wherein a width of the head structure in a lateral direction is less than a separation, along the display disparity axis, between the first display element and the second display element.

11. The humanoid robot teleoperation system of claim 9, wherein, when the humanoid robot is in a reference posture, the capture baseline is oriented vertically relative to a gravity vector and the display disparity axis is oriented horizontally relative to the gravity vector.

12. The humanoid robot teleoperation system of claim 9, wherein the image processing circuitry is configured to perform a coordinate transform that maps disparity along the capture baseline to disparity along the display disparity axis.

13. The humanoid robot teleoperation system of claim 9, wherein the image processing circuitry is configured to compute a depth map from the first image and the second image based on the capture baseline and to synthesize the first display image and the second display image as virtual views having a synthetic baseline aligned with the display disparity axis.

14. The humanoid robot teleoperation system of claim 9, wherein the capture baseline is physically fixed, and all stereo adjustments giving rise to disparity along the display disparity axis are performed digitally by the image processing circuitry.

15. The humanoid robot teleoperation system of claim 9, wherein the image processing circuitry is configured to adjust a synthetic baseline aligned with the display disparity axis used to derive the first display image and the second display image based on an interpupillary distance associated with the operator.

16. The humanoid robot teleoperation system of claim 9, wherein the image processing circuitry is configured to inpaint regions of the first display image and the second display image corresponding to disocclusions introduced by reprojecting from the capture baseline to the display disparity axis.

17. The humanoid robot teleoperation system of claim 9, wherein the humanoid robot comprises a robotic neck supporting the stereo camera pair and an inertial measurement unit configured to detect a pitch angle of a robot head, and the image processing circuitry is configured to compensate for the pitch angle when deriving the first display image and the second display image so as to maintain alignment with a gravity vector.

18. A method of teleoperating a humanoid robot, the method comprising:
obtaining, during a teleoperation session in which a human operator controls a humanoid robot, a first image and a second image captured by a stereo camera pair mounted in a head structure of the humanoid robot, the stereo camera pair comprising a first camera and a second camera, a capture baseline extending between the first camera and the second camera being non-parallel to a horizontally-oriented disparity axis of a stereoscopic display viewable by the operator;
deriving, by one or more processors, from the first image and the second image, a first display image and a second display image arranged for stereoscopic display along the horizontally-oriented disparity axis;
presenting the first display image to one eye of the operator and the second display image to the other eye of the operator on the stereoscopic display so as to provide visual feedback to the operator while the operator controls the humanoid robot during the teleoperation session; and
recording the first display image and the second display image, together with one or more contemporaneous command inputs from the operator, in a data store as training data for a humanoid robot control policy.

19. The method of claim 18, wherein the first image and the second image are obtained while the stereo camera pair is positioned within an aperture having a lateral width less than would accommodate a horizontally-baselined stereo camera pair of equivalent baseline magnitude.

20. The method of claim 18, wherein, when the humanoid robot is in a reference posture, the capture baseline is oriented vertically relative to a gravity vector and the horizontally-oriented disparity axis is oriented horizontally relative to the gravity vector.

21. The method of claim 18, wherein deriving the first display image and the second display image comprises performing a coordinate transform that maps disparity along the capture baseline to disparity along the horizontally-oriented disparity axis.

22. The method of claim 18, wherein deriving the first display image and the second display image comprises computing a depth map from the first image and the second image based on the capture baseline and synthesizing the first display image and the second display image as virtual views having a synthetic baseline aligned with the horizontally-oriented disparity axis.

23. The method of claim 18, further comprising determining a pitch attitude of a head of the humanoid robot relative to a gravity vector, and rotating a reprojection plane used during the deriving step to compensate for the pitch attitude.

24. The method of claim 18, further comprising inpainting regions of at least one of the first display image and the second display image corresponding to disocclusions arising from a difference between the capture baseline and the horizontally-oriented disparity axis.

25. The method of claim 18, further comprising adjusting a synthetic baseline aligned with the horizontally-oriented disparity axis based on an interpupillary distance associated with the operator.
